(19) United States
(12) Patent Application Publication
(10) Pub. No.: US 2025/0121348 A1
(43) Pub. Date: Apr. 17, 2025

(54) MODULAR REGENERATIVE HYDROTHERMAL REACTOR AND METHODS FOR MINERALIZATION OF RECALCITRANT ORGANIC COMPOUNDS AT HYDROTHERMAL OPERATING CONDITIONS

(71) Applicant: Cristina Piekarz, Vallejo, CA (US)

(72) Inventor: Cristina Piekarz, Vallejo, CA (US)

(21) Appl. No.: 18/913,984

(22) Filed: Oct. 11, 2024

Related U.S. Application Data
(60) Provisional application No. 63/589,949, filed on Oct. 12, 2023.

(51) Int. Cl. B01J 19/24

(52) U.S. Cl. CPC B01J 19/2415; B01J 2219/1943; B01J 2219/2418

(57) ABSTRACT

A modular regenerative hydrothermal reactor, method, and system for carrying out chemical reactions under aggressive conditions are disclosed. The reactor comprises a modular tubular shell with an array of injection/bleed ring devices that carry out chemical reactions and permit the formation of a protective fluid barrier to isolate the chemical reaction from the reactor. The reactor system and injection/bleed ring devices are configured for the radial injection of reactants, the tangential injection, bleeding, and regeneration of a protective fluid barrier, and the controlled response and/or transitioning of the chemical reaction from an array of devices operating in fluid communication. Methods for a protective fluid barrier comprising initiator, inhibitor, and/or insulator chemical species are disclosed. Reactor and method embodiments are disclosed for subcritical and supercritical water reactions, for applications such as the mineralization of recalcitrant organic compounds such as PFAS in the presence of inorganic compounds (e.g., using supercritical water oxidation SCWO). This disclosure permits advantages such as 1) simple modular design to improve safety, operational flexibility, and scalability, 2) reduction in corrosion, solid/salt accumulation, and thermal stress from radial reactant injection in combination with chemical species blend injection and bleed, and 3) reactor wall isolation using a chemical species blend to improve system safety, reaction efficacy, and controlled response to maintain the reactor wall integrity (e.g., at a low temperature to meet ASME Section VIII, Div 1 and/or ASME B31.1) permitting the use of more readily available, cost-effective alloys.

### CROSS-REFERENCE TO RELATED APPLICATIONS

The present application claims priority to U.S. Provisional Patent Application No. 63/589,949, filed on Oct. 12, 2023, which is incorporated by reference herein in its entirety.

### FIELD OF THE INVENTION

The present invention relates to modular regenerative hydrothermal reactor systems and methods for carrying out chemical reactions at aggressive operating conditions, including but not limited to subcritical and supercritical water reactions. The invention specifically addresses reactor designs that include injection and bleed ring devices for controlled fluid injection and recovery, along with methods to protect reactor components from aggressive reaction environments by forming protective fluid barriers. These systems are applicable to a variety of applications such as the treatment of hazardous organic and inorganic waste or wastewater, energy recovery, and other chemical processes.

### BACKGROUND OF THE INVENTION

The invention disclosed herein relates to reactors and methods for carrying out chemical reactions at aggressive operating conditions.

Many chemical reactions and reactor configurations are proposed for carrying out aggressive conditions. Some common elements for various reactions include, but are not limited to, the presence of constituents that can increase the potential for corrosion such as chlorides and sulfides/sulfates, the presence of scaling constituents and the corresponding exceedance of equilibrium solubility limits, enhanced acidity or basicity at operating conditions, high temperature conditions, high pressure conditions, autocatalytic reactions, oxidating or reducing conditions, reactions that could lead to thermal runaway, reactant and/or reaction byproduct constituents that are considered toxic/hazardous/carcinogenic/etc. and/or other conditions that would be known to those skilled in the art.

Although it is not the intention of the present invention to be limited to a particular chemical reaction and/or operating condition, for convenience this disclosure will focus on supercritical water oxidation (SCWO), as this reaction typically comprises many of these elements described. It is to be appreciated that in different embodiments, the methods and apparatus of the present invention may be used with other reactions.

Above a critical point (374 deg C., 22.1 MPa), the state of water is neither a liquid nor gas and it becomes stateless. The thermophysical properties of water drastically change, and a unique environment can be used to catalyze reactions. As the critical point is approached and exceeded, the dielectric constant decreases, reversing the solubility of organic and inorganic compounds, and the reaction kinetics are enhanced as the mass transfer becomes unrestricted. The presence of oxidizing reagents to supercritical water (i.e., water having at least 374 deg C., and 22.1 MPa) (SCW) enables the complete mineralization (i.e., complete organic compound conversion to carbon dioxide, water, and/or salt(s)) of even the most recalcitrant organic compounds such as Per- and Polyfluoroalkyl Substances (PFAS).

While it is not the intent of this disclosure to limit the application of the invention, PFAS have garnered industry attention due to the promulgation of regulations, inherent treatment challenges, and potential liabilities. The EPA's finalized maximum contaminant levels down to low ppt levels for various compounds, in addition to the designated classification under CERCLA, have made it incredibly difficult for water purveyors with limited resources to sustain compliance, and imposes liability associated with the handling of the compounds due to the allowance for the pursuit of accountability to cover treatment costs. The extent of promulgated regulations impacts many industries, and while it is challenging for many treatment processes to meet these contaminant levels, SCWO has been proven to mineralize the entire class of compounds with appropriate reaction conditions (i.e., typically >600-650 deg C., >22.1 MPa).

In addition to SCW's ability to enhance destruction of organic contaminants, it also enables the ability to recover energy for improving process efficiency and/or producing power, and/or enables the recovery of high value reaction products, all while producing no NOx, SOx, or other air emissions at ideal conditions. Other benefits of the use of SCW for reactions (i.e., gasification, or others) would be known to those skilled in the art.

Over the past few decades, there have been a plurality of applications for SCW/SCWO and various reactor configurations have been proposed such as plug flow reactors (PFRs)/tubular reactors, tank reactors, transpiring wall reactors, and other more complex designs as will be discussed from prior art.

In U.S. Pat. No. 5,252,224 (Modell, 1993), a PFR/tubular reactor is disclosed for the oxidation of aqueous mixtures of organics at conditions exceeding 21.8 MPa and 374 deg C. To attempt to reduce/mitigate salt/solid plugging, the disclosure discusses increasing the velocity of the mixture to prevent settling and mechanically brushing/cleaning the tubular reactor.

PFRs/tubular reactors such as Modell and others provide a common reactor configuration used to carry out reactions due to their high conversion rates and relative simplicity in design, but they are susceptible to risks associated with 1) lack of mechanisms to control fouling (leading to reduced reaction efficacy from heat transfer reduction, plugging, and/or corrosion), 2) lack of control over maintaining stable reaction conditions (leading to incomplete reaction byproducts), and 3) uncontrolled releases of heat from exothermic conditions (potentially leading to depressurization events).

As the temperature of an aqueous organic/inorganic waste solution is increased in a PFR, the equilibrium solubility limits change, potentially resulting in the precipitation of a plurality of constituents that may be present in the waste (e.g., silica, carbonates, phosphates, metal oxides, etc.) that can impede heat transfer, plug the reactor, and potentially lead to depressurization events. In the presence of corrosive species (e.g., such as chlorides, sulfates, etc.), the walls of a tubular reactor may be susceptible to flow-accelerated corrosion (FAC) and/or solid deposition potentially resulting in hideout and/or under-deposit corrosion (i.e., an increase in the concentration of corrosive species to potentially thousands of times higher than present in the feed within the pores of the deposit) leading to stress corrosion cracking (SCC) and/or reactor damage.

Similarly, if there is a fluctuation in organic species concentration and a lack of control over the oxidant dosage, it can lead to rapid releases of a large amount of heat, potentially leading to depressurization events, without sufficient warning signals leading to the occurrence. For example, the high organic concentrations in secondary treatment wastewater sludge and/or biosolids can pose challenges associated with controlling the heat release from the reaction. In 2014, after an Orlando wastewater treatment plant installed a tubular SCWO reactor to treat sludge, the system experienced a depressurization event, which damaged the system and building, but no personnel were injured (Modell et al, 2008 and Orlando Sentinel, 2014). It is therefore imperative that care and caution be exercised while designing, manufacturing, and operating SCWO reactors as personnel, plant, and community safety is paramount.

While it is not the intention to review every tubular reactor related to SCWO, several techniques have been disclosed (summarized in Marrone et al, 2004) such as flushing techniques to cool and/or reverse solubility of inorganics, use of additives to provide a means for particles to adhere, a eutectic blend to influence solubility, density separation, mechanical scraping devices, and other methods that could be used in combination with tubular reactors.

Common methods disclosed that attempt to mitigate challenges associated with heat release and/or corrosion have involved the use of nickel-base alloys to provide more flexibility with aggressive conditions. But, it should be known to those skilled in the art, that at subcritical conditions some constituent species such as chlorides are more corrosive than at supercritical conditions for certain nickel-base alloys, posing an inherent problem during reactor waste pre-heating to operating conditions. This, in combination with the potential for deposits, can easily lead to reactor plugging and/or SCC. In addition, the use of certain nickel-base alloys may limit a tubular reactor's ability to mineralize various recalcitrant organic compounds that require temperatures higher than the nickel-base alloy material limits.

For example, with some sulfonated species of PFAS that are more recalcitrant, such as PFOS or others, temperatures in excess of >600-650 deg C. may be required to effectively mineralize the compound, which may be above certain nickel-base alloy's material limit at temperature and pressure operating conditions (i.e., plug flow reactors comprised of these nickel-base alloy materials may not be able to safely achieve mineralization of certain compounds to meet compliance levels). Many water treatment systems that specialize in the mineralization of recalcitrant organic species such as PFASor other compounds employ pipe/tubular reactors at high temperatures (>212 deg F.) and pressures (>2,400 lb/in2). These reactors are not only prone to corrosion and scale/deposits but are also prone to thermal shock, especially in oxidating conditions. This makes it especially challenging to adequately mineralize organic contaminants safely in complex matrices such as industrial wastewater, landfill leachate, AFFF, municipal wastewater, foam fractionates, biosolids, membrane concentrates, or aqueous-based solid slurries contaminated with organics such as activated carbon, ion-exchange resin, soils, and precipitated solids resulting from chemical reactions.

In U.S. Pat. No. 6,054,057 (Hazlebeck et al) a downflow hydrothermal reactor is disclosed that has a vertical orientation, the injection of the reactants at the top of the reactor, and the use of a quenching section at the bottom to redissolve salts to reduce plugging. The use of a mechanical scraper to remove salts/solids, a corrosion resistant liner (such as titanium liner), insulating material within the annular gap between the pressure bearing wall and liner, and a purge fluid within the annular gap to “keep contaminants from flowing into the gap” is also disclosed.

In addition to Hazelbeck et al, there have been various disclosures over the years of reactors such as U.S. Pat. No. 5,591,415 (Dassel, et al), US Pat. Publ. No. 2023/0398514 (Igor, et al), WO2021/204609 (SCFI), and others with elements such as downflow configuration, the injection of the reactants at the top of the reactor, sacrificial liners, and the use of a subcritical quenching section to redissolve salts. Although these disclosures progress teachings related to reducing plugging and/or corrosion, there are problems with these designs: 1) the placement of injector nozzles at the top of the reactor increases the propensity for injector thermal shock/erosion resulting from the rapid changes in temperature/heat flux, inorganic/salt solubility limits, and buoyancy of the reaction zone, and can potentially pose a safety concern if organics/inorganics accumulate on the injector nozzle(s), 2) the use of a liner exposed to the reaction will accumulate inorganics within the system (and also potentially organic products/reactants) causing constituents to slough-off later at very high concentrations, potentially impacting downstream valves and other equipment increasing system downtime/maintenance, and decreasing reaction efficacy 3) the liner may be exposed to corrosive conditions, wearing it out, and potentially exposing the pressure vessel to the corrosive fluid, 4) the brine in the subcritical section is highly corrosive and can wear out downstream valves and other appurtenances, and 5) there are limited provisions for control associated with rapid changes in temperature of the reactors, which presents a safety concern. Strategies that focus on the use of thermocouples for reactor control are not sufficient to monitor rapid changes in temperature within the reactor as it only monitors temperature at one discrete point in the system, making it very improbable (if not impossible) to sufficiently have enough of a warning signal to detect rapid temperature changes, and by the time a thermocouple monitoring the reactor pressure vessel temperature indicates a sudden increase, it may be too late for course correction and mitigation.

Over the past few decades, Blue Grass Chemical Agent Destruction Pilot Plant (BGCAPP) went through the demonstration testing, technical bid evaluation, detailed design, and installation of downflow hydrothermal reactors to destroy VX, GB, and H hydrolysates with SCWO, and although the reactors were effective at destroying the organics, there were many problems with reactor operation reliability. After 100-hour tests with simulants of VX, GB, and H hydrolysates (sulfate, phosphate, fluoride, and other salts as byproducts), the results indicated 1) excessive corrosion of the titanium liner and/or thermowell (0.4-1.3 mils per hour), 2) a hydrided liner after one of the simulant tests, 3) and accumulated salt in the reactor after each of the tests (approximately 140-70 lbs after each 100 hour test). In addition, during engineering scale tests, feed nozzles were an “open issue . . . where significant degradation was observed” (US Army Chemical Materials Agency, FY03 Technical Evaluation for Chemical Demilitarization, 2003). The various mitigation measures proposed from the team comprised increasing the frequency of liner and/or thermowell replacement, producing a eutectic mixture of NaCl/Na2SO4 within the reactor to reduce plugging (i.e., addition of salts to attempt to reduce salt accumulation and/or corrosion), and dilution of the agent hydrolysate with energetics hydrolysate (i.e. to reduce phosphate concentrations) (Interim Design Assessment for the BGCAPP, 2005). After system construction was completed, and it was transitioned to equipment functionality testing, corrosion of the reactor thermowells and liner (on the order of 1 mil per hour, with the upper portion of the reactor experiencing the more aggressive corrosion) continued in addition to many other concerns (National Academies of Sciences, Engineering, and Medicine, 2019).

In U.S. Pat. No. 5,723,045 (Daman) and U.S. Pat. No. 5,558,783 (McGuinness), a reactor configuration called a transpiring wall reactor is disclosed as a means to counter corrosion and plugging. Both patents disclose variations upon a tubular reactor with the introduction of a “transpiring wall” such that supercritical water or subcritical water flows through a liner to push off salts/solids to reduce the potential for plugging and/or corrosion. McGuinness uses a porous liner, while Daman uses a platelet design of “a plurality of stacked, thin plates having a large number of precisely engineering passages to allow water to pass through the wall from the outside”. Both of these designs consider the use of supercritical water within the annulus region that flows through a liner or platelets, but neither address the corrosive nature of demineralized supercritical water. While both disclosures claim the reduction of salt/corrosion, further review of the detailed testing data and results conducted from Sandia National Laboratory (Haroldsen et al, 1996) and/or BGCAPP (US Army Chemical Materials Agency, FY03 Technical Evaluation for Chemical Demilitarization), 2003) for the transpiring wall reactors, indicated observations of injector erosion, salt accumulation within the reactor, liner corrosion and/or cracking, and/or challenges with maintaining oxidative stability (i.e., CO/HC spiking during testing, potentially impacting permitting abilities).

Other more complex reactor designs include U.S. Pat. No. 8,017,089 (Titmas) and U.S. Pat. No. 10,851,006 (Cai). Titmas discloses a method for reducing the potential for contact between salts/solids and the containment vessel with supercritical water (as demineralized water) as a film between the vessel and reactants but does not directly address removing accumulated salts/solids recirculating within the reactor. In addition, the use of supercritical water indicates that the salts will remain insoluble, which indicates that they will likely adhere to the reactor walls contributing to corrosion. Also, although the patent acknowledges the erosive/corrosive nature of demineralized water, its attempt to counter this corrosivity is with a sacrificial liner, which indirectly implies additional maintenance for a custom, complex reactor design. In Cai, a tubular reactor is disclosed that has two tubular outlets in a common reaction chamber, each outlet having a vertical height that corresponds with operating conditions at either supercritical conditions or subcritical temperature. Although this disclosure acknowledges the reversal of solubility limit with a subcritical zone, salts will likely settle on the supercritical outlet causing plugging during the discharge of the treated effluent. In addition, because the waste and oxidant inlet placement are at the bottom of the reaction chamber (in the brine), this will potentially impede mass and heat transfer resulting in unoxidized reaction byproducts. In addition to the specifics noted, designs of this nature require custom built reactors, each tailored towards a specific feed source, and are complex in their designs which may inherently introduce risk associated with resource availability, material procurement, manufacturing, product/project development/delivery, and/or long-term sustainable operation and maintenance.

Unfortunately, there is still a need for reactor designs that address the aggressive conditions of SCWO as none of these prior art references reduce/mitigate the many challenges that are known to those skilled in the art. This has resulted in hindered development and commercialization despite all its advantages as being one of the select few treatment approaches to destroy recalcitrant organic contaminants.

### SUMMARY OF THE INVENTION

A modular regenerative hydrothermal reactor and methods are disclosed herein as a solution for carrying out chemical reactions comprising aggressive operating conditions. Reactors and methods are disclosed that feature a modular shell with an array of injection/bleed ring devices configured for radial injection of reactants, tangential injection, bleeding, and regeneration of a fluid barrier scheme comprising initiator, inhibitor, and/or insulator chemical species to isolate the chemical reaction from the reactor, and the controlled response and/or transitioning of the chemical reaction resulting from the array of devices operating in fluid communication, and the corresponding changes in reactor operating conditions.

Embodiment are disclosed for a reactor and methods for SCWO and subcritical applications for the mineralization of recalcitrant organic compounds such as PFAS in the presence of inorganic compounds. These embodiments provide potential advantages over existing systems art such as:
1) reduced sensitivity to waste feed characteristics,
2) reduction/elimination of both thermal shock/erosion of the reactant injectors and the reaction heat loss through a radial injection design in combination with a protective fluid barrier layer comprising an initiator and/or insulator chemical species,
3) improved control over the reaction and neutralization with an array of injection/bleed ring devices and multiple layers of redundancy in the event of a potential failure,
4) reduction of corrosion and/or thermal damage of liners and/or pressure vessel with a fluid blend comprising an initiator, inhibitor, and/or insulator chemical species combination,
5) improved control during unexpected increases in reaction zone temperature due to an autogenous response from a combination of the chemical and thermophysical properties of the fluid barrier,
6) reduction of wear on valves and other appurtenances downstream from accumulated inorganic compounds using a continuous bleed and/or regeneration of fluid barriers,
7) reduction of the consumption of the initiator, inhibitor, and/or insulator raw chemical species due to the regeneration and/or recirculation of the fluid barrier,
8) a simple modular design to improve:
   a) the range of reactor capacity/turndown capabilities,
   b) scalability of production and/or product/project delivery to respond quickly to increases in demand,
   c) product quality via manufacturing consistency,
   d) operating maintenance with ease of access,
   e) ability to acquire spare parts in a timely manner, and/or
   f) safety as any potential failure is easier to contain with modular design,
9) design considers the inherent requirements to support end-users for decades in an evolving market landscape such that it does not require a custom/complex design and is agnostic towards specialized material providers, technology providers, and/or manufacturers as this introduces long-term risk due to the flux of resource availability,
10) segregation of pressure vessel walls from high heat flux reaction zone using initiation, inhibition, and insulation chemical species combination permitting:
   a) higher reaction temperatures to increase efficacy,
   b) decrease in residence time,
   c) an increase in flow through capacity,
   d) rapid controlled response to maintain pressure vessel at a low temperature to meet ASME Section VIII, Div 1 and/or ASME Power Piping Code B31.1, and/or
   e) use of commercially available alloys such as stainless steel instead of typical cost/lead time intensive nickel-based alloys.

Embodiments of the invention are described in more detail below that include modular regenerative hydrothermal reactor devices, methods of protection for aggressive reaction conditions, and systems for a subcritical and SCWO application using both a reactor device and methods.

Some embodiments provide a modular regenerative hydrothermal reactor and methods for SCWO and the mineralization of recalcitrant organic compounds, such as PFAS, in the presence of inorganic compounds. These reactors and methods offer several advantages over prior art, including reduced sensitivity to variations in waste feed characteristics and the elimination of thermal shock, erosion of reactant injectors, and reaction heat loss through the use of a radial injection design combined with a protective fluid barrier layer comprising initiator and/or insulator chemical species. The reactors in these embodiments further provide improved control over the reaction and neutralization through an array of injection/bleed ring devices. Some embodiments include multiple layers of redundancy to ensure reliability in the event of a failure. Corrosion and thermal damage to the liners and pressure vessel are reduced in these embodiments by a fluid blend containing initiator, inhibitor, and/or insulator chemical species. Additionally, these systems offer enhanced control during unexpected increases in reaction zone temperature through an autogenous response facilitated by the chemical and thermophysical properties of the fluid barrier.

In embodiments of the invention, wear on downstream valves and other components due to accumulated inorganic compounds is minimized through continuous bleeding and regeneration of fluid barriers, and the consumption of raw chemical species is reduced by regenerating and recirculating the fluid barrier. The simple modular design of embodiments of the reactors improves reactor capacity and turndown capabilities, scalability, product quality, operating maintenance, and spare parts availability while enhancing safety by containing potential failures. Moreover, these designs support long-term user needs by avoiding reliance on specialized material or technology providers, reducing risks associated with resource availability fluctuations. Embodiments of the reactor segregate the pressure vessel walls from the high-heat reaction zone using a combination of initiation, inhibition, and insulation chemical species, allowing for higher reaction temperatures, decreased residence time, increased flow capacity, and rapid, controlled responses to maintain the pressure vessel at low temperatures, meeting ASME Section VIII, Div 1 and ASME Power Piping Code B31.1 standards. Importantly, embodiments of the present invention permit the use of commercially available alloys, such as stainless steel, instead of more expensive and time-intensive nickel-based alloys.

### Some Exemplary Embodiments of the Invention

Embodiments of the present invention provide modular hydrothermal reactors, sometimes referred to as “falling film” reactors (FFRs) wherein the reactor orientation is vertical and at least one fluid barrier layer comprises a downflow configuration, and related methods. The FFRs of the present invention include designs that provide for the formation of multiple layers of film (protective fluid) resulting from the controlled injection of reagents into the reactor. The designs of the reactors of the present invention protect the pressure vessel from salt/deposit accumulation while providing a thermal and corrosion barrier. The protective fluid and/or falling film functions to reduce/flush salts/deposits, protect from thermal gradients, allow for the use of more common metals, improve the flexibility of the reactors with a modular design, increase the destruction and removal efficiency (DRE) of organic contaminants, among other things.

In some embodiments, the hydrothermal reactor configuration may be vertically orientated; but may also be horizontal. Multiple reactors may be operated in parallel or in series, depending on feed and operating characteristics. One or more reactors can be operated both continuously and as a batch process. In other embodiments, multiple reactors may be configured in parallel and may include multiple smaller reactors to allow for a wider range of turndown capabilities while providing system redundancy.

A number of operating conditions or specific parameters may affect the manner in which the modular regenerative hydrothermal reactors of the present invention operate to carry out chemical reactions effectively and safely. These parameters may include, but are not limited to, temperature, pressure, flow rates, residence time, the concentration, and type of reactants and reagents used. Operating conditions may also encompass the physical state of the fluids (e.g., subcritical or supercritical water conditions), the use of supplemental heating methods (such as co-fuels or external heaters), and the configuration of the reactor modules (e.g., vertical or horizontal orientation, single or multiple reactors in series or parallel). The selection of operating conditions is dependent on factors such as feed characteristics, desired reaction goals, reactant/reagent selection, and reactor design including the materials from which the liners and containment vessels are made. For example, an embodiment of a reactor may function under supercritical water oxidation conditions with temperatures exceeding 374° C. and pressures above 22.1 MPa to mineralize recalcitrant organic compounds, while another embodiment may operate at subcritical conditions for similar and/or different treatment objectives. Additionally, different modules within the reactor system may be maintained at distinct operating conditions (e.g. transitioning from carrying out an oxidation and/or reduction followed by neutralization) to optimize performance, accommodate varying feed characteristics, and enhance overall efficiency and safety.

Some embodiments of the hydrothermal reactors of the present invention may operate above or below the supercritical point of water. In other embodiments, the reactor may operate at supercritical water oxidation conditions (e.g., temperature>374° C., >22.1 MPa), but other operating conditions can be considered such as low pressure/low temperature, low pressure/high temperature, high pressure compressed water, steam, wet air oxidation (WAO) conditions, hydrothermal oxidation conditions, or others similar conditions. In some embodiments, the hydrothermal reactor system holistically may operate at multiple operating conditions (e.g., at a plurality of locations within the hydrothermal reactor system). The reactor heating may be accomplished from either a supplemental fuel/co-fuel (such as IPA, etc.) or external electrical heaters. For example, in application for a wastewater feed with a recalcitrant organic contaminant, the operating conditions are dependent on the wastewater characteristics, reagent selection, and treatment goals.

Some embodiments utilize various reagents and/or reactants within the reactor system for optimizing the performance and ensuring the effective treatment of wastewater. These reagents and reactants serve multiple functions, including facilitating the removal of recalcitrant organic compounds, inhibiting corrosion, and controlling unwanted deposits, among other things. The selection of appropriate reagents depends on the specific operating conditions of the reactor, as well as the characteristics of the wastewater being treated. Accordingly, the flexibility in reagent selection allows for a more adaptable and efficient system, capable of handling diverse wastewater streams.

In some implementations, one or more of the following reagents/reactants can be used upstream, downstream, and/or within the reactor system to facilitate and/or catalyze the removal/mineralization of recalcitrant organic compounds, inhibit corrosion, provide cooling, reduce deposits, control reactions, inhibit byproducts, treat emissions, strategically create deposits, provide heat, and/or other functions. Recipes for reagents/reactants can include one or more of the following, but are not limited to: oxidants (compressed air, oxygen, hydrogen peroxide, ozone, etc.), pH adjustment reagents (acetic acid, sodium hydroxide, etc.), alcohols (ethanol, methanol, etc.), subcritical or supercritical water, other supercritical fluids, steam, co-fuels (common fuels, IPA, hydrogen, biogas, biodiesel, etc.), helium, hydrogen, nitrogen, ammonia, urea, surfactants (amphoteric, anionic, cationic, nonionic), morpholine, cyclohexylamine, diethylaminoethanol, ethanolamines, monoethanolamine, methylamines, ethylamines, 3-Methoxypropylamine, 2-aminoethyoxyethanol, glycol, glycolic acid, diethylhydroxylamine (hydroxylamines), oleyl propylenediamine, orthophosphates, polyphosphates, potassium pyrophosphate, sodium tripolyphosphate, sodium hexametaphosphate, superoxide, phosphoric acid, Non-NFPs, peracetic acid, zinc based compounds, triazole based compounds, dihydrogen phosphate or trisodium phosphates, dichloromethane, permanganate, potassium ferrate, hydrazine, carbohydrazide, phosphonates, aminotris-methylenephosphonic acid, 1-hydroxyethylidene-1,1,-diphosphnoic acid, phosphonobutane-1,2,4-tricarboxylic acid, polyamino polyether methylene phosphonate, acrylic acid and allyl-hydroxy-propyl sulfonate ether, polyepoxysuccinic acid, ammonium peroxydisulfate, terpolymer of acrylic acid, 2-acrylamido-2-methylpropylsulfonic acid, t-butylacrylamide, ammonium acetate, fluorous biphasic solvents, molybdenum based compounds, ferric based compounds, oxygen scavenger compounds, common clean-in-place (CIP) reagents, or other compounds that would facilitate oxidative reactions for organic compound DRE, passivation protection reactions, extractants, reactions to inhibit byproduct formation, reactants generated by electrochemical means, or other reactions. It is to be appreciated that the specific recipe for reagents is dependent on the chemical reaction and reactor/system operating conditions. Examples of methods and of a hydrothermal reactor device for an application to mineralize recalcitrant organic compounds in the presence of inorganic compounds are disclosed in Section 3 using SCWO and Section 4 using subcritical conditions.

A general process flow schematic for some embodiments of the invention is provided in FIGS. 12A, 12B, and 12C for supercritical and subcritical conditions. In these embodiments, the waste feed (e.g., organic contaminated wastewater), reactants/reagents, and co-fuel (if needed) are preheated and pressurized to reactor operating conditions prior to injection, injected into the reactor, maintained for an appropriate residence time and operating condition for carrying out the reaction. The reactor effluent brine and/or solids are treated (if present), and the reactor effluent (i.e., distillate and/or brine) may be quenched and de-pressurized (i.e., gas/liquid separation) appropriately for further treatment or discharge. Organic contaminated wastewater pre-heating may be dependent on the specific feed characteristics and may not be required or may require the addition of reagents to facilitate its conveyance, such as pH adjustment reagents to reduce the formation of precipitates. Supplemental fuel may be used during start-up or when needed to maintain temperature and may be dependent on the reactor operating conditions and wastewater characteristics. Depending on reactor operating conditions and wastewater characteristics, the reactor quench may include reagent(s) addition prior to depressurization. Depending on reactor operating conditions and wastewater characteristics, during the gas/liquid separation phase, the gas released shall be scrubbed, monitored, and released. Depending on the wastewater feed characteristics, salts may be recovered at various stages of the reactor and/or process. The general system equipment includes a feed system, injectors, pumps, reactor, solids treatment, quench, pressure letdown, gas/liquid separation, and heat exchanger.

The reactors of the present invention may include at least two regions: a central reaction zone and at least one filming zone, also referred to herein as “concentric protection zone(s)” or “protective fluid barrier”, as illustrated in FIGS. 13A and 13B. In some embodiments, there may be a protective liner positioned between the two zones. In other embodiments, there may be a plurality of filming zones that are positioned circumferentially around a central reaction zone and one or more liners may be positioned between each of the zones as illustrated in FIG. 13B. The liners may be porous or solid and are selected based on the operating conditions of the adjacent zones and the operating conditions of the reactor.

In some embodiments, protective fluid injection ports are operable to develop one or more filming zones, also referred to herein as “falling film” and/or “concentric protection zone(s)” and/or “protective fluid barrier(s)”, to protect the pressure vessel via a concentration and/or thermal gradient. The specific concentric protection zone(s) reagent(s) and operating conditions selected will depend on the characteristics of the organic wastewater feed. In embodiments where a protective liner is inserted, injection ports may be located on both sides of the liner such that a first filming zone is provided on the outer diameter (e.g., between the liner and pressure vessel) and a second filming zone is provided on the interior diameter of the liner (e.g., between the liner and reaction zone). See, e.g., FIG. 13B. If a protective liner is present, the first filming zone (zone 1) may provide insulation to maintain reactor temperatures, maintain system pressure, and provide protection of the outer pressure vessel. In some embodiments, the filming zone is operable using a pressure differential across the liner and drive flow inward towards the second filming zone (zone 2) to provide supplemental thermal/deposit/corrosion protection, diffuse reactants from filming zone 1 into filming zone 2, provide a purge to prevent backflow or corrosive or organic contaminants into the outer annulus region, and allow for transition to system lay-up during shutdown with a blanket. If a protective liner is present, filming zone 2 may flush salts/deposits away from the liner, provide thermal/corrosion protection of the liner, and protect the outer pressure vessel. In some embodiments, contaminants and/or reactant(s) and/or reaction byproduct(s) may diffuse into any of the filming zones. In some embodiments, protective fluid ejection ports are operable to bleed the filming zone(s) (i.e., concentric protection zone(s)) from the reactor to purge organic and/or inorganic compounds that diffuse into the zone, treat organic and/or inorganic compounds, and regenerate the protective fluid barrier.

In some embodiments, primary reactant injectors are operable to inject reactants into a central reaction zone, where a chemical reaction is carried out. The reactor may be configured with primary reactant injectors that consist of longitudinal reactant injector(s) as illustrated in FIG. 14A surrounded by protective fluid injection ports. In some embodiments, the reactors may be further configured with primary injectors that consist of radial injectors(s) via a modular filming injection and bleeding ring incorporated between each section as illustrated in FIG. 14B. The modular ring may also be configured with ejection ports that enable the bleeding of the filming zone. In such embodiments as illustrated in FIG. 14B, the modular injection ring forms a protective filming zone and promotes the reaction in the reaction zone. The modular ring is also configured with ejection ports that enable the bleeding of the protecting filming zone. The injection rings are operable to enhance performance of the reactor and may be operable to provide corrosion protection and a thermal barrier.

As illustrated in FIGS. 14B and 11, the film may flow from a first injection ring Nx to a second injection ring Nx+1 and may be operable to flush away salts/deposits from the pressure vessel or liner, incorporate reactants to facilitate mineralization of organic compounds or other chemical reactions, support passivation of the pressure vessel, provide cooling, transition to system layup, and/or can alternate to a CIP mode.

In some embodiments, the top layer of the injection ring Nx may be operable to collect spent film that was injected from injection ring Nx−1 and ensure that there are no by-products from incomplete mineralization of the organics or other reactions, recover salts, among other things. In some embodiments, a portion of the spent film is pulled off from each modular section and may be recycled back to the reactor influent for processing and/or may be regenerated for reuse. As illustrated in FIG. 14C, the spent film may be pulled off from each modular section and conveyed to a common treatment module for fluid recovery (e.g., such as illustrated in FIG. 14D).

Along the length of the reactor, injection rings may be configured to operate at different conditions and may receive a supply of filming and catalyzing reagent(s). Depending on reactor operating conditions, reagents may be pre-heated and pressurized prior to being injected. A example of a modular filming injection ring is shown in FIGS. 1-3.

Embodiments of the reactors of the present invention may include a primary longitudinal reactant injector (discussed in more detail below), bleeding and injection rings (discussed in more detail below), a tubular shell (e.g., pressure vessel), a protective liner (if necessary), solids treatment, and a neutralization/quench section. The reactors may or may not include a primary longitudinal reactant injector, as contaminated wastewater may simply be pumped through the reactor, and the injection rings may be used to facilitate the reaction and form protective films. The reactor may also include a primary longitudinal reactant injector, but no injection rings (e.g., a single injection point) such that a filming zone is formed with protective fluid injection ports surrounding the longitudinal reactant injector. In some implementations, the reactor may include a primary longitudinal reactant injector with a plurality of modular sections containing injection/bleed rings. The primary longitudinal reactant injector may be connected to the reactor's first modular section by a flange or other means, as illustrated in FIG. 3G or other similar type of connector suitable for a pressure vessel, and each modular reactor section and injection ring may be similarly connected by flanges. A sacrificial liner may be used for aggressive feeds to provide additional corrosion/thermal protection. Each section may be self-contained with its own supply of filming reagents, catalyst reagents, etc.

FIGS. 13A-13B provide a simplified bird's eye view looking down from the top of exemplary rings onto the filming zones for embodiments with (FIG. 13B) and without (FIG. 13A) a protective liner. For aggressive feeds, a liner is preferred to isolate the reaction zone from the pressure vessel. The liner can consist of either a solid or porous concentric material that is replaceable. The liner is placed within the pressure vessel and may be secured into place with the injection ring, which may include one or more grooves to receive the liner(s).

In some embodiments, the reactor configuration and modular sections may depend on the reactor operating conditions and wastewater characteristics. For example and without limitation, a tubular reactor may include a plurality of bleed/injection rings or attemperators incorporated at strategic locations in the process to improve system safety, reduce salt deposition/plugging/fouling, and control the release of heat or improve heat distribution

The injection and bleeding rings may be incorporated into the same body and may include a radial injection channel for reactant(s), at least one tangential injection channel for the protective fluid barrier positioned near (e.g., below) the radial injection channel, and a tangential collection channel (e.g., bleed collector) positioned near (e.g., above) the radial injection channel and configured for receiving the protective fluid barrier corresponding to the protective fluid barrier injection from a separate injection/bleed ring device (e.g. positioned directly above).

In vertical embodiments having one filming zone and one reaction zone, a radial reactant injection channel may include a primary reactant injection manifold that is positioned at a mid-plane of the body and is in communication with a plurality of primary reactant injection nozzles that are circumferentially positioned around the interior of a ring and are operable to radially inject reactants into the reaction zone. Below the primary reactant injection manifold in these embodiments, a primary protective fluid injection manifold having a circumferential channel that is in communication with a plurality of longitudinal injectors is provided and is operable to axially inject a fluid into the primary concentric protection zone. Similarly, in these embodiments above the primary reactant injection manifold, a primary protective fluid barrier collection manifold is provided that is in communication with a plurality of collection conduits that are aligned with the longitudinal injectors of the primary protective fluid barrier injection manifold and are operable to collect spent film (e.g., reagent(s), reaction byproduct(s) such as salts or residue) from the injection/bleed ring device and modular section above. For each zone in the reactor system, there may be a plurality of injectors in communication with a manifold and a plurality of collectors in communication with a separate manifold. The injectors and collectors may be aligned such that falling film (e.g., protective reagents, reaction byproducts, salts, or residue) resulting from the previous stage is collected by the plurality of collectors.

In embodiments having more than one filming zone, a secondary protective fluid injection manifold and a corresponding collection manifold may be provided and may include a plurality of injectors adjacent to the longitudinal injectors of the primary protective fluid injection manifold. Between the primary protective fluid injectors and the secondary protective fluid injectors, one or more groves may be provided on both the top and bottom surfaces that are operable to secure the one or more liners which separate the zones. Between the primary protective fluid collectors and the secondary protective fluid collectors, one or more grooves may be provided on both the top and bottom surfaces that are operable to secure the one or more liners which separate the zones.

In some vertical embodiments, multiple reactor sections may be provided with multiple filming injection and bleeding rings positioned between each section of the reactor. These may extend along the length of the reactor, as shown in the exemplary embodiment of FIGS. 4, 5, and 6. In such embodiments, the number of injection rings and the spacing between the rings may be defined by the reactor operating conditions, wastewater characteristics, materials, and thermal/concentration gradient profiles. The injection rings may include a stack of supply lines (e.g., manifold) that are operable to transport the reactant(s), filming reagent(s), and any catalyst(s) to a plurality of perforated injection ports (e.g., holes, nozzles, etc.) that are circumferentially positioned around the reactor. The bleeding ring may include a stack of discharge ports corresponding to the position of the supply lines that are operable to collect spent film. One or more grooves may also be incorporated in the ring to hold one or more protective liners in place between the pressure vessel and the reaction zone, depending on reactor operating conditions. The liner(s) may be solid or porous and may be configured based on the reactor operating conditions.

In embodiments of the reactor, perforated injection ports (holes) may be circumferentially positioned around an inner ring and may be operable to direct the reagent flow inward toward the reaction zone to initiate and/or to catalyze the reaction. Around the underbelly of these rings reagent(s) may flow down or along reactor length, thereby producing filming zone(s). On the top surface of an injection ring, spent film and reagent(s) are collected.

In some embodiments, primary reactant injection ports are operable to influence the reaction by injecting reagents to provide a more uniform reaction rate or to enhance DRE of the organic compounds. A mixture of reagents can be injected that facilitates the mineralization of organic compounds to improve DRE, catalyze the reaction, or provide for an on-line CIP (clean-in-place). In such embodiments, the ports inject reagents into the reaction zone in excess stoichiometric conditions with appropriate monitoring and may be operable to alternate between primary reactants to facilitate mineralization of organics and an on-line CIP, depending on the organic contaminated feed characteristics and reactor operating conditions. In an alternative embodiment, scavenger reagents, or reagents that inhibit the reaction can also be injected into the reaction zone to enhance control over the reactor operating conditions.

In some single-injector embodiments, reactors of the present invention may be configured with only a primary longitudinal injector to treat organically contaminated wastewater. In the reaction zone, the organic contaminated wastewater, reactant mixture (for example, oxidant/SCW under supercritical conditions), and co-fuel (if needed) may be directly injected via a primary longitudinal injector and finely dispersed at the top of the reactor with appropriate cooling to protect the injector (as shown in FIG. 17). In such embodiments, a finely dispersed mixture is imperative to improve the reaction surface area and facilitate complete mineralization of the organics. The injector may have an appropriate cooler or liner to protect it from corrosion or thermal shock. A thermal gradient resulting from a single injection point will be produced over the length of the reactor. In the filming zone(s) (e.g., outer edges of the primary injector), one or a combination of reagents may be injected through the injection ports. For example, if the reactor is operating at supercritical conditions and has a solid protective liner in place, filming zone 1 could consist of compressed air, while filming zone 2 could consist of high temperature subcritical water to flush the liner.

### Method 2: Multiple Injection Points (Primary Injector+Injection Rings)

In some multiple injector embodiments, a plurality of injection points may be provided. In these embodiments, primary injection may occur as described above, and then additional injections may occur at multiple points along the length of the reactor. In these embodiments, injection rings provide control over the reaction and enhance thermal/corrosion protection. (See in FIGS. 18 and 19.) For example, at supercritical operating conditions, the injection ring ID ports could be composed of co-fuel and SCW/oxidant with a dual point injection option to also inject oxygen scavenger at strategic locations in the reactor. In such configurations, the reactor may have a uniform and increased temperature distribution, radially throughout the reaction zone over its length to improve the DRE. The filming injection ports may include high temperature subcritical water to flush the liner. In embodiments having multiple injection points of the reactants, the reactants can be operated under different reactant conditions (e.g., such as different reagents facilitating mineralization, alternating between CIP cycles, various reagents catalyzing the reaction, etc.). Each modular section may have its own separate line(s) for reactants injected.

### Aspects of Embodiments of the Invention

In one aspect of the present invention methods for controlling a chemical reaction and protecting the inner walls of a chemical reactor is provided utilizing an array of discrete devices to initiate, sustain, and transition the chemical reaction through the radial injection of reagents towards a central axis of the reactor, forming a central reaction zone. These methods include the generation of a protective fluid barrier surrounding the reaction zone through tangential injection of reagents, forming at least one concentric protection zone that shields the inner walls of the reactor from the reaction conditions. The fluid barrier is regenerated by bleeding off reagents and/or reaction byproducts, modifying the barrier as needed, and recirculating it into the reactor. These methods operate in fluid communication with chemical reactor monitoring systems, which allow modulation of reactor conditions through feedback-controlled flow rates of reagents and byproducts. The methods are applicable to various chemical reactions, including autocatalytic, oxidation, and reducing reactions, with operating conditions ranging from high to low pH and exceeding solubility limits of certain constituents.

In some of these embodiments, a central reaction zone, which may involve catalysts, operates at temperatures of at least 100° C. and pressures ranging from 50 psi to 2,400 psi or higher. Such a zone may contain organic compounds, including organohalogens or inorganic compounds such as chloride, sulfate, silica, and other constituents. The protective fluid barrier can consist of reactants/reagents that provide thermal, chemical, or corrosion protection, which can be modified through thermal, chemical, or physical treatment processes. Specific applications of these methods include the treatment of PFAS such as PFOA and PFOS under supercritical water conditions, where the reactor operates at temperatures of at least 374° C. and pressures exceeding 22.1 MPa. These methods support supercritical water oxidation (SCWO), using various feedstocks like industrial wastewater, landfill leachate, and aqueous film-forming foam (AFFF), alongside oxidants such as hydrogen peroxide, oxygen, or air.

In another aspect of the present invention methods are provided that allows for supplemental control of the reaction profile through radial injection of dampening agents like carbon dioxide or nitrogen, or enhancement via the introduction of initiators, inhibitors, and overfire oxidants to regulate reaction kinetics. In some configurations, the concentric protective zones surrounding the central reaction zone may consist of subcritical fluids, reaction inhibitors, or thermal regulation reagents, potentially maintained within a segregated fluid chamber. In other embodiments, the concentric protective zones may contain fluid mixtures of supercritical water, nitrogen, or molten salts for thermal and chemical protection. In addition to the control of reaction dynamics, these methods include the use of feedback systems to monitor reactor conditions, such as temperature, pH, oxidation-reduction potential (ORP), and pressure, which adjust fluid injection and bleeding rates to maintain optimal operation. The bleeding of the central reaction zone and protective zones allows for heat recovery, byproduct recovery, or cleaning of reactor components. The methods may employ solid or porous liners to separate the protective zones from the central reaction zone, with materials having low thermal conductivity (e.g., less than 1 W/(m*K)).

It is a further aspect of the present invention to provide modular hydrothermal reactors that may include a cylindrical pressure vessel with injection/bleed ring devices for radial and tangential fluid injection and bleeding, supporting real-time monitoring and feedback systems to control reactor conditions. These modular reactors can operate in continuous flow or batch mode and support the treatment of a wide range of industrial and municipal waste streams under extreme operating conditions, including SCWO. The systems with these reactors may be integrated with heat exchangers, depressurization devices, and recovery systems for treated effluent and byproducts. The modular reactors are adaptable for both portable and stationary applications, capable of being controlled through programmable logic controllers (PLCs), distributed control systems (DCS), SCADA systems, and even machine learning or Al-based control schemes.

Further aspects and embodiments will be apparent to those having skill in the art from the description and disclosure provided herein.

It is, therefore, an object of the present invention to provide an advanced solution for handling aggressive chemical reactions in a modular reactor system, offering flexibility in operation and scalability for a plurality of applications.

It is also an object of the present invention to isolate the chemical reaction from the reactor walls to improve system safety, reaction efficacy, system control, and enable the use of more readily available, cost-effective materials.

It is also an object of the present invention to provide a modular reactor system utilizing SCWO to remove and/or destroy organic contaminants such as PFAS from contaminated waste and/or wastewater.

It is also an object of the present invention to provide modular reactor systems for removing and/or destroying organic contaminants such as PFAS from waste and/or wastewater that may be constructed from cost-effective, commercially available materials such as stainless steel.

It is also an object of the present invention to provide modular reactor systems to reduce corrosion of reactant injectors, liners, and/or reactor walls.

It is also an object of the present invention to provide modular reactor systems to reduce thermal damage of reactant injectors, liners, and/or reactor walls.

It is also an object of the present invention to provide modular reactor systems with improved control over the reaction and/or reaction neutralization.

It is also an object of the present invention to provide modular reactor systems that reduce reaction heat loss.

It is another object of the present invention to provide modular reactor systems that reduce accumulated inorganics and/or reaction byproducts.

It is another object of the present invention to provide modular reactor systems that reduce reactor sensitivity to waste feed characteristics.

It is another object of the present invention to provide modular reactor systems that have a simple design to improve scalability of production, product delivery, and manufacturing consistency.

It is also an object of the present invention to provide modular reactor systems that have multiple layers of redundancy in the event of a potential failure.

The above-described objects, advantages, and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIG. 1 provides a perspective view of the injection/bleed ring, according to an embodiment of the present invention.

FIG. 2 provides a top view of the injection/bleed ring, according to an embodiment of the present invention.

FIG. 3 provides a side view of an injection/bleed ring, according to an embodiment of the present invention.

FIG. 3A provides a longitudinal cross-sectional side view along line FIG. 3A-FIG. 3A of FIG. 3, according to an embodiment of the present invention.

FIG. 3B provides a cross-sectional top view along line FIG. 3B-FIG. 3B of FIG. 3, according to an embodiment of the present invention.

FIG. 3C provides a side view of an alternative embodiment of an injection/bleed ring, according to an embodiment of the present invention.

FIG. 3D provides a cross-sectional side view along line FIG. 3D-FIG. 3D of FIG. 3C, according to an embodiment of the present invention.

FIG. 3E provides a top view along line FIG. 3E-FIG. 3E of FIG. 3C, according to an embodiment of the present invention.

FIG. 3F provides a top view along line FIG. 3F-FIG. 3F of FIG. 3C, according to an embodiment of the present invention.

FIG. 3G provides an exploded view of a clamp and/or flange connection system, according to an embodiment of the present invention.

FIG. 3H provides a side view of another alternative embodiment of an injection/bleed ring, according to an embodiment of the present invention.

FIG. 4 illustrates a close-up cross-sectional view of an injection/bleed ring, according to an embodiment of the present invention.

FIG. 5 provides a cross-section side view of a hydrothermal reactor about the cross-section line of FIG. 8B, according to an embodiment of the present invention.

FIG. 6 provides a cross-section side view of a hydrothermal reactor about the cross-section line of FIG. 8A, according to an embodiment of the present invention.

FIG. 7 illustrates a side view of a hydrothermal reactor, according to an embodiment of the present invention.

FIG. 8A illustrates a top view of a hydrothermal reactor, according to an embodiment of the present invention.

FIG. 8B illustrates a top view of a hydrothermal reactor, according to an embodiment of the present invention.

FIG. 9 shows a schematic diagram of a radial flow of concentric protection zone(s) surrounding a central reaction zone, according to an embodiment of the present invention.

FIG. 10 shows a schematic diagram of a radial and axial flow of concentric protection zone(s) surrounding a central reaction zone from an array of injection/bleed ring devices within a hydrothermal reactor, according to an embodiment of the present invention.

FIG. 11 shows a schematic of the radial and axial flow of concentric protection zone(s) surrounding a central reaction zone from an array of injection/bleed ring through a hydrothermal reactor, according to an embodiment of the present invention.

FIG. 12A shows a simple process flow diagram for an embodiment of a hydrothermal reactor and methods, according to an embodiment of the present invention.

FIG. 12B shows a hydrothermal reactor process flow diagram for an embodiment of the reactor and methods for a subcritical application.

FIG. 12C a shows a hydrothermal reactor process flow diagram for an embodiment of the reactor and methods for a SCWO application.

FIG. 13A is a cross-sectional top view of a hydrothermal reactor reaction zone and concentric protection zone without a protective liner, according to an embodiment of the present invention.

FIG. 13B is a cross-sectional top view of a hydrothermal reactor reaction zone and concentric protection zone with a protective liner, according to an embodiment of the present invention.

FIG. 14A is a hydrothermal reactor process flow diagram, according to an embodiment of the present invention

FIG. 14B is a reactor process flow diagram, according to an embodiment of the present invention.

FIG. 14C is a reactor process flow diagram, according to an embodiment of the present invention

FIG. 14D is a process flow diagram of a salt treatment module, according to an embodiment of the present invention.

FIG. 15 shows a detailed process flow diagram for an embodiment of the hydrothermal reactor and methods for a SCWO application.

FIG. 16 is a diagram of a plurality of hydrothermal reactors in a parallel configuration according to an embodiment of the present invention.

FIG. 17 shows a process flow diagram for an embodiment of the present invention.

FIG. 18 shows a process flow diagram for an embodiment of the present invention.

FIG. 19 shows a graph of the radial temperature profile as a function of reactor position for an embodiment of the invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention. In the following disclosure, specific details are given to provide a thorough understanding of the invention. However, it will be apparent to one skilled in the art that the present invention may be practiced without all of the specific details provided.

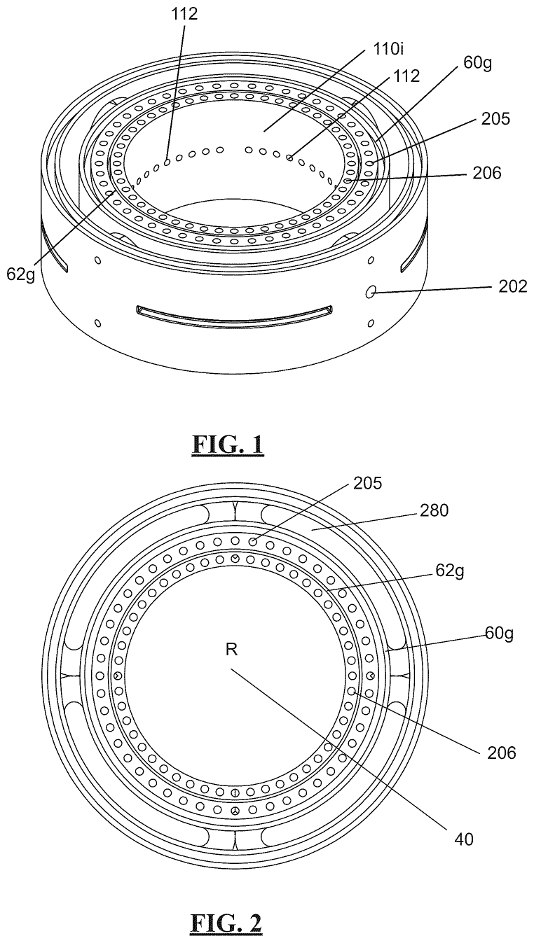

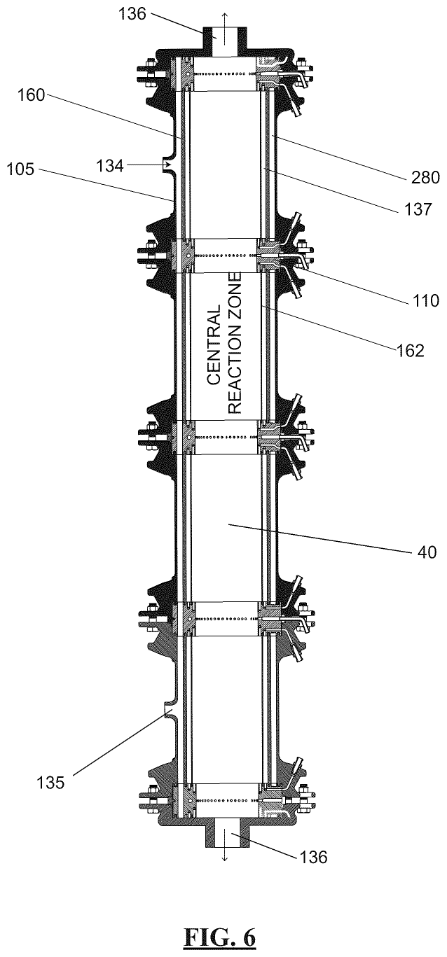

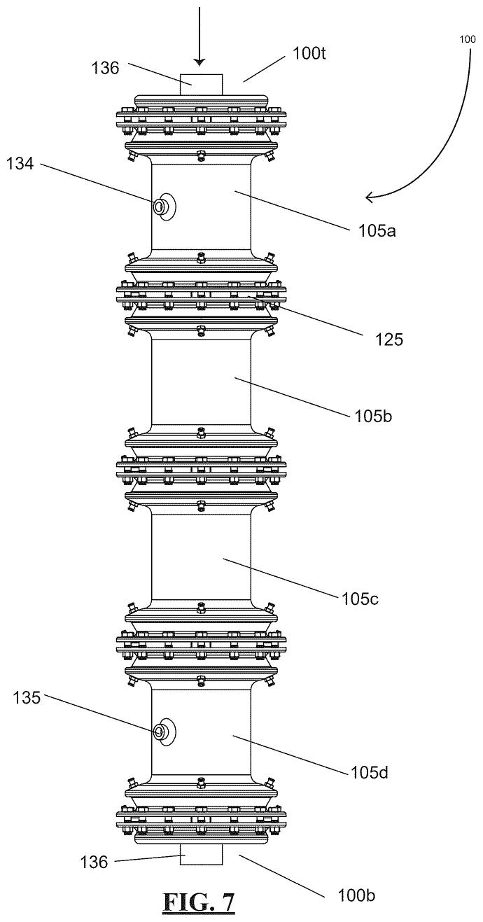

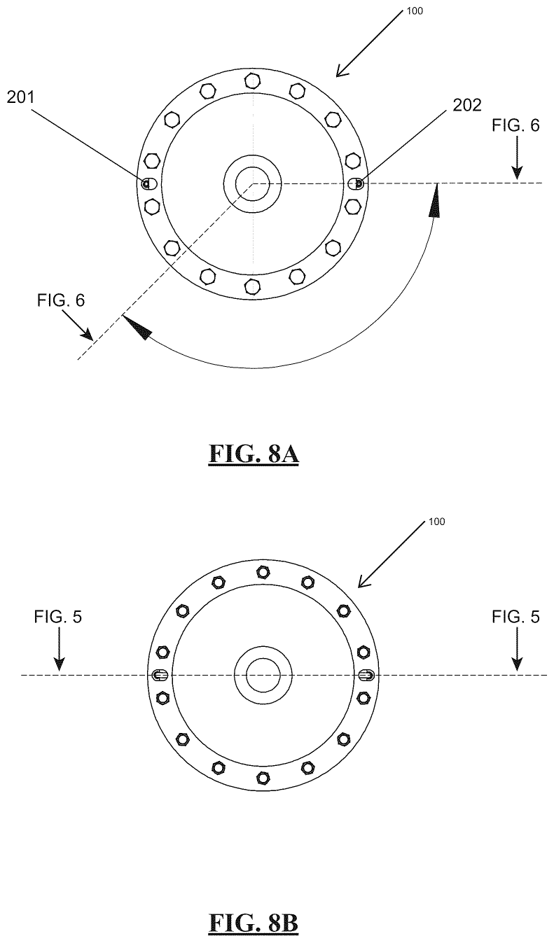

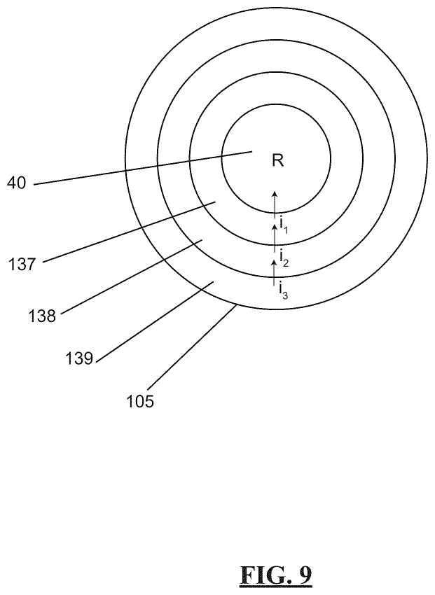

Referring to the drawings, wherein like reference characters designate like or corresponding parts throughout the several views, and referring particularly to the physical and components illustrated in FIGS. 1-8B, it is seen that the present invention comprises modular regenerative hydrothermal reactors that are operable to carry out chemical reactions comprising aggressive operating conditions for applications such as, but not limited to, destroying recalcitrant contaminants from waste and/or wastewater. As seen in FIGS. 5, 6, and 7, the hydrothermal reactors of the present invention may be provided in a plurality of segments using injection/bleed ring device(s) shown in FIGS. 1 through 3E, that are operable to carry out chemical reactions. FIGS. 9-16 provide diagrams of various modular regenerative hydrothermal reactors and methods for carrying out chemical reactions. Sections 1 and 2 below describe exemplary apparatus and methods utilizing aggressive operating conditions, Section 3 provides examples of exemplary embodiments of reactors and methods of the present invention for use with SCWO, and Section 4 provides examples of exemplary embodiments of reactors and methods of the present invention for use with subcritical reactions. Although separate descriptions are provided below, it is to be appreciated that features disclosed in any particular embodiment described below may be incorporated into and used with any of the other embodiments described herein.

### Section 1. Modular Regenerative Hydrothermal Reactor Device

In some embodiments, the hydrothermal reactor 100 may include a tubular shell (e.g., pressure vessel) 105, an array of injection/bleed ring devices 110 configured for the radial injection of reactants, the tangential injection, bleeding, and regeneration of a fluid barrier scheme, and the controlled response and/or transitioning of the chemical reaction resulting from the array of devices operating in fluid communication and the corresponding changes in reactor operating conditions.

### Injection/Bleed Ring Device—Fluid Distribution and Recovery

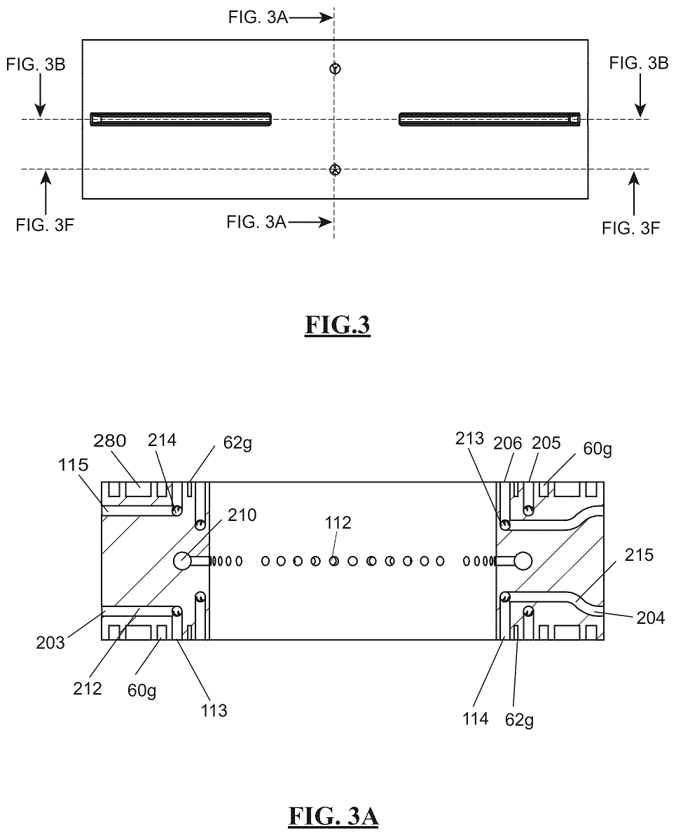

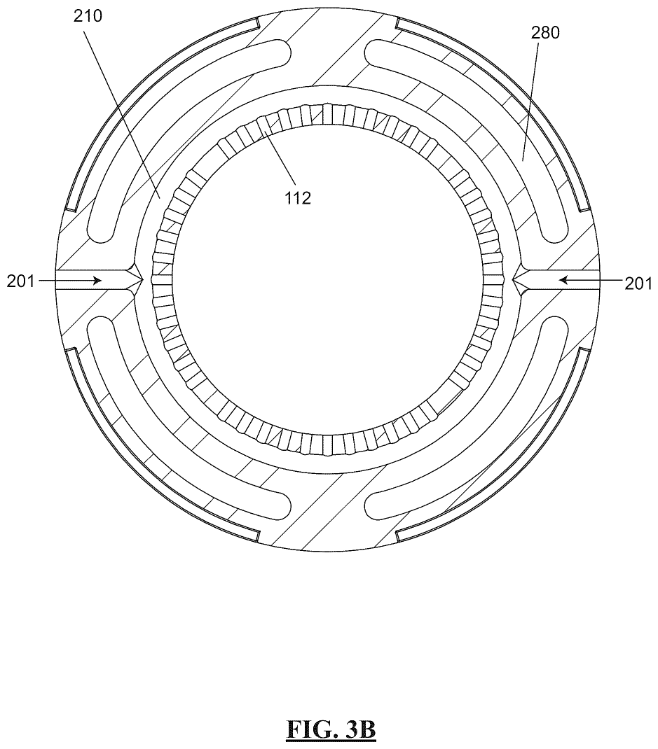

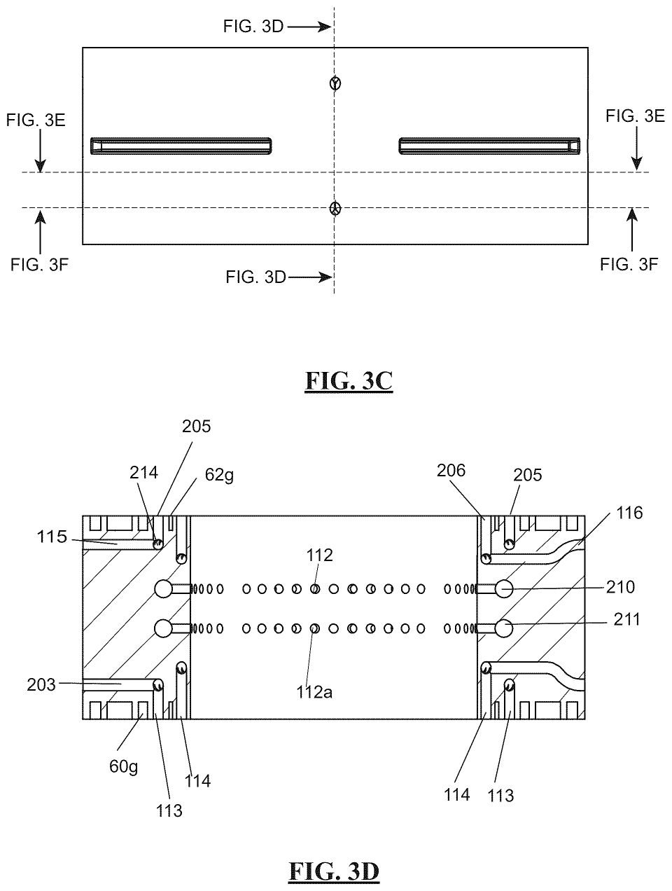

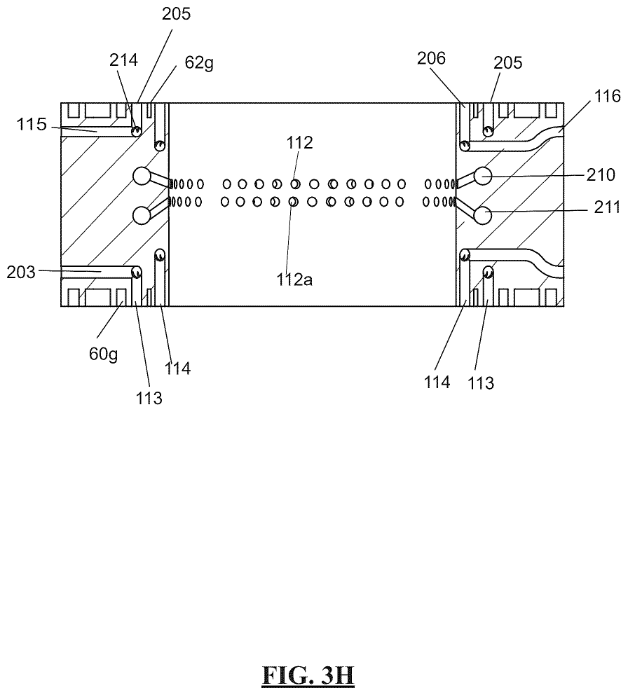

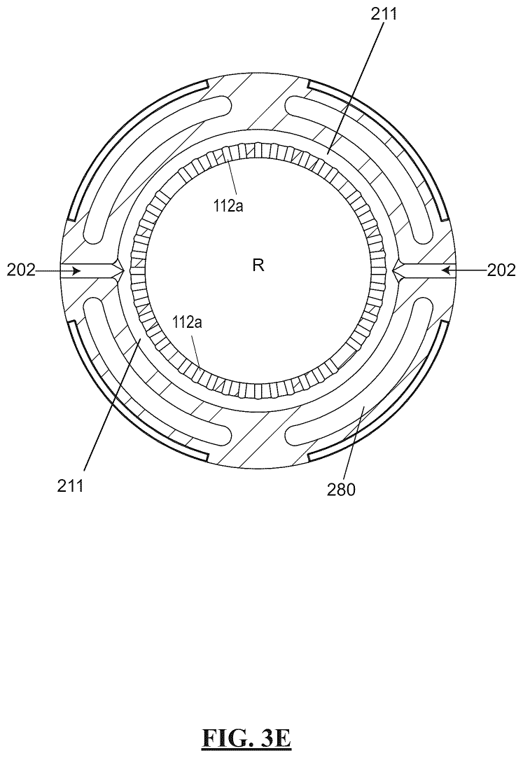

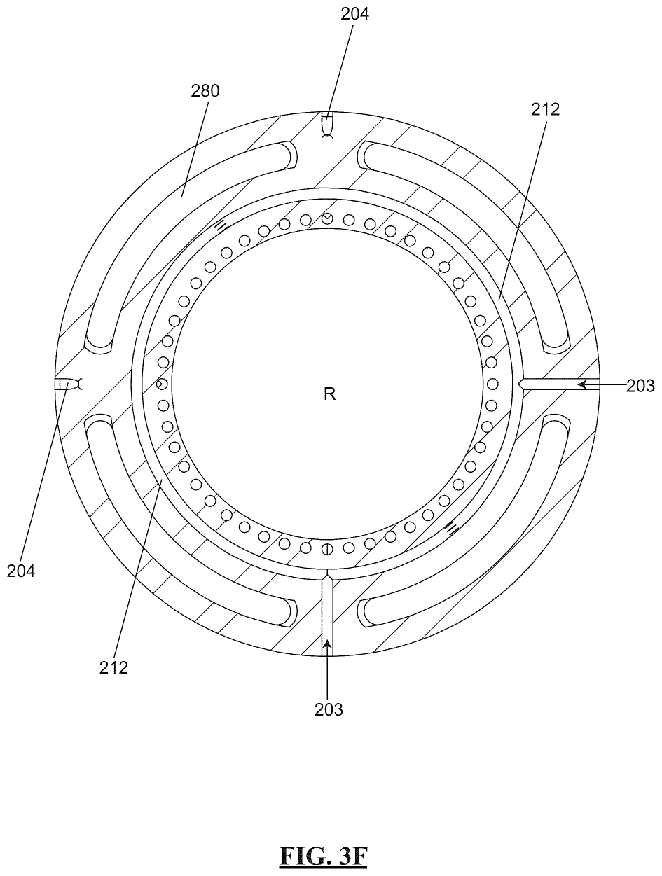

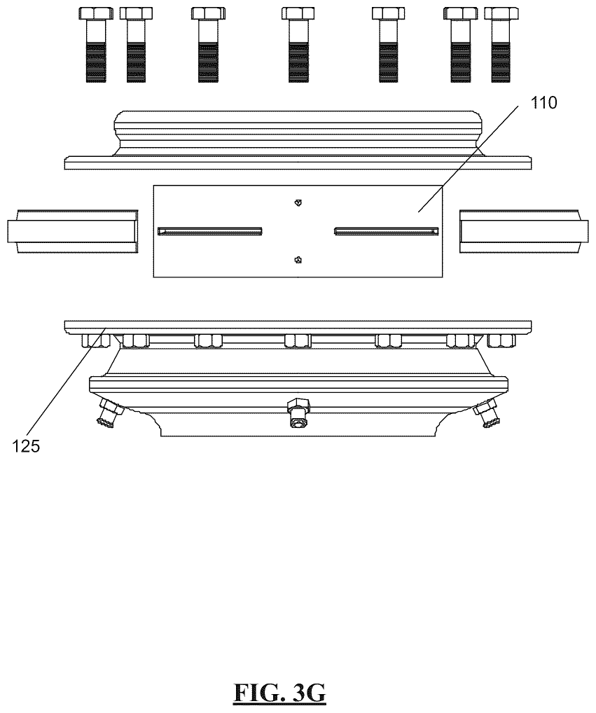

Embodiments of the present invention provide an injection/bleed ring device that is operable to distribute/inject fluid into a section and is operable to recover fluid from a previous section. Several embodiments are illustrated in FIGS. 1, 2, 3, and 3A-3H. FIG. 3A is a cross-sectional view of an injection/bleed ring device embodiment. In some embodiments, as illustrated in FIGS. 2, 3A, 3B, 3D, 3E, 3F, and 3H, the injection/bleed ring device 110 may include various fluid distribution channels and various corresponding liners.

In some embodiments, the injection/bleed ring device 110 may include various fluid distribution manifolds: 1) fluid distribution manifolds that permit radial flow, 2) fluid distribution manifolds that permit circumferential flow tangentially (e.g., along the tubular shell), and 3) fluid distribution manifolds that permit the collection of tangential circumferential flow (e.g., around the tubular shell). A plurality of dimensions for the injection/bleed ring body may include an outside diameter (OD), an inside diameter (ID), and a thickness, and are intended to be within scope of the present invention for any and all embodiments.

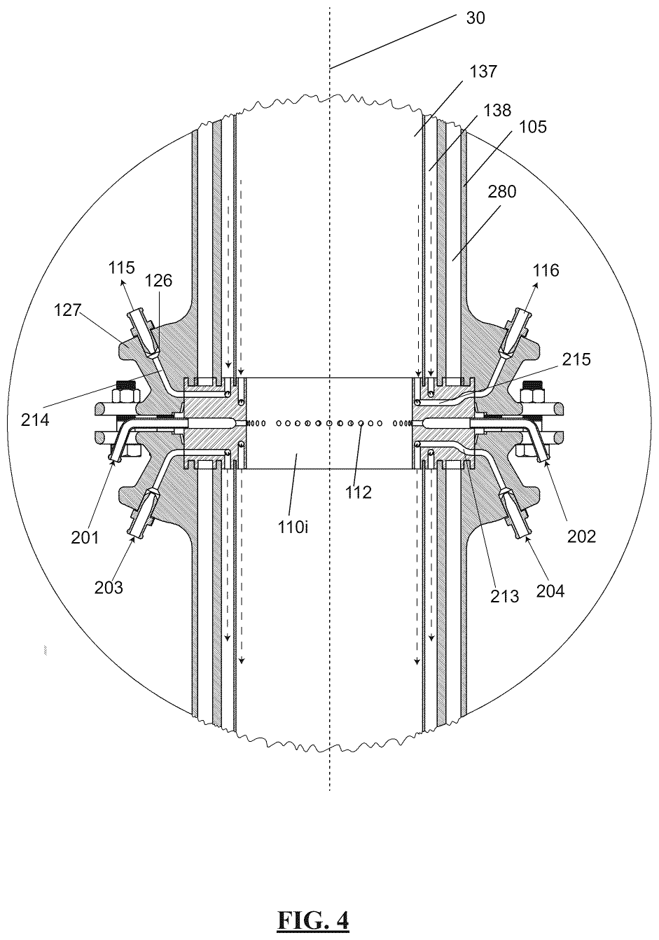

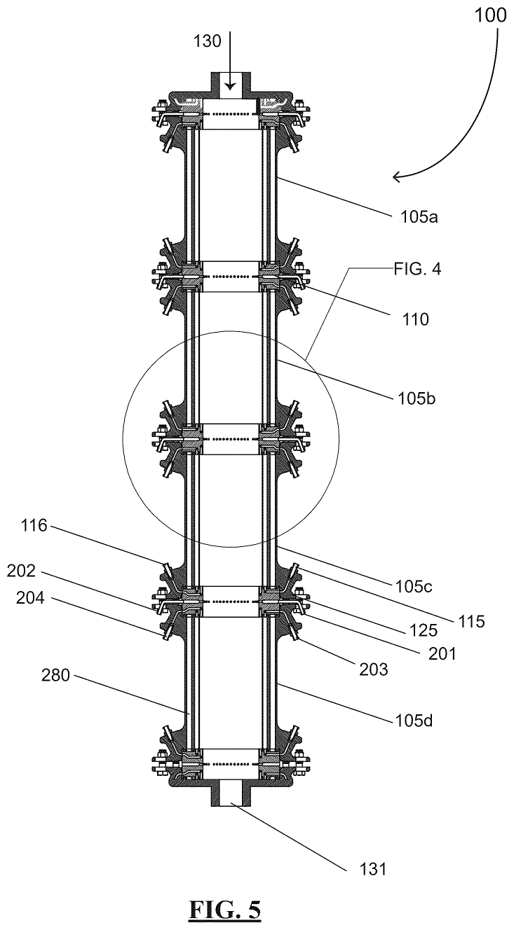

In some embodiments, the injection/bleed ring device 110 may inject reactant(s) radially as shown in FIGS. 1 and 4 along the inner surface 110i of the injection/bleed ring device 110 through a plurality of primary outlets 112 that are positioned circumferentially around the inner surface 110i. The primary outlets 112 may be openings (e.g., nozzles) that are operable to inject a respective fluid radially toward a longitudinal axis 30 of the reactor (i.e., towards the central reaction zone 40). In such embodiments, there may be a plurality of primary outlets 112 that are operable to deliver a first fluid or a second fluid or a combination thereof. In some embodiments, there may be outlets (e.g., also may be referred to as primary radial injectors) for a plurality of unique additional fluids along the inner surface 110i. In such embodiments, the first and second fluid outlets are located around a common outlet plane for radial flow directed towards the central longitudinal axis 30 as illustrated in FIG. 4.

In some embodiments, a plurality of the first and/or second fluid outlets (i.e., any combination of primary radial injectors) may direct fluid flow at a plurality of angles between the respective fluid outlet 112 and the longitudinal axis 30. In some embodiments, additional unique fluids outlets are located circumferentially around the inner surface 110i of the ring, at a plurality of longitudinal positions (i.e., above and/or below the first and/or second fluid outlets) and along the inner surface 110i to inject fluid radially at a plurality of angles between the fluid outlet and the longitudinal axis 30 with the objective to provide supplemental control over the radial and longitudinal fluid profile (e.g., to enhance fluid flow and/or the reaction and/or dilute/suppress fluid flow and/or the reaction such as to function as a fluid dampener) (e.g., may be referred to as supplemental radial injectors). In some embodiments, the first and second fluids may be combined into a plurality of singular outlets for both fluids (e.g., such as a co-axial injector). In some embodiments, the first, second (i.e., primary radial injectors), and/or supplemental fluid injector fluid outlets may have an alternating pattern. A plurality of first, second (i.e., primary radial injectors), and/or supplemental fluid injector fluid outlet diameters are intended to be within scope of the invention. In some embodiments, the diameter of the first, second (i.e., primary radial injectors), and/or supplemental fluid injector fluid outlets may be different.

As shown in FIGS. 3, 3A and 3B, a plurality of first fluid outlets 112 are coupled to a first fluid distribution manifold 210 extending circumferentially around the ring structure and coupled to the first fluid inlet 201. In some embodiments, there may be more than one first fluid inlet 201. Similarly, for a second fluid, as shown in FIGS. 3C, 3D and 3E, a plurality of second fluid outlets 112a may be coupled to a second fluid distribution manifold 211 extending circumferentially around the ring structure and coupled to the second fluid inlet 202. In some embodiments, there may be more than one second fluid inlet 202. In some embodiments, additional primary radial injectors and/or supplemental radial injectors may be included, wherein each unique fluid is coupled similarly to a respective fluid distribution manifold and respective fluid inlet. In some embodiments, a wall separates fluid distribution manifolds. For some embodiments, an outlet duct may connect the fluid outlet to the fluid distribution manifold for each respective fluid. The outlet duct allows fluid to travel from the distribution manifold to the outlet. In some embodiments, the first fluid distribution manifold 210 and second fluid distribution manifold 211 may be present as a dual fluid distribution manifold.

A dual fuel manifold for gas turbine engine (such as that shown in U.S. Pat. No. 7,654,088) can be applied in alternative embodiments for the radial injection of reactants through a dual fluid manifold. In some embodiments, spray tip feed nozzles may be used with outlets 112, 112a to facilitate the injection of reactants towards the longitudinal axis 30. In alternative embodiments, other injectors for radial injection of reactants can also be included such as without limitation coaxial injectors, post expansion coaxial injectors, impinging injectors, shear tri-coaxial injectors, concentric tube types of injectors, and/or other injectors that would atomize/disperse reactants towards the longitudinal axis 30.

Each fluid flow for radial injection is controlled independently. Factors that influence fluid flow include the injection pressure, diameter of the fluid distribution manifold, the fluid outlet diameter, and other factors. In some embodiments, the fluid pressure in each respective fluid manifold may be different; in other embodiments the pressures may be the same. In some embodiments, some or all of the fluids may be pre-heated prior to injection.

### Circumferential Protective Reactant(s)/Reagent(s) Injection

As shown in FIGS. 3A, 3D, 3F, and 3H, along the bottom surface of the injection/bleed ring device 110 there may be one or more injection rings concentric to the primary injector manifolds (210, 211). These injection rings may include outlets 113 for a third fluid and outlets 114 a fourth fluid. The third fluid and fourth fluid flow may be injected from a first ring device (110) Nx and flow along the longitudinal length of the tubular shell to a second ring device Nx+1. In such embodiments, a plurality of outlets 113 and 114 may be located circumferentially around the bottom surface of the first ring device Nx. Corresponding exit outlets 205 and 206 may be located circumferentially around the upper surface of the next ring device NX+1. The outlets 113, 114 are openings through the surface of the device for each of the respective fluids to flow coaxially to the tubular shell until they reach exit outlets 205 and 206, creating fluid filming zones or concentric protection zones, discussed elsewhere herein. In some embodiments, there may be additional pluralities of outlets for a plurality of unique fluids in separate zones.

The third 113 and fourth 114 fluid outlets are located around a common outlet plane for coaxial flow directed along the longitudinal axis 30 and adjacent to the tubular shell. The third fluid outlets 113 and corresponding exits 205 are positioned circumferentially adjacent to the tubular shell and the third fluid flow forms a third fluid concentric protection zone. The fourth fluid outlets 114 and corresponding exits 206 are positioned circumferentially adjacent to the third fluid outlets 113, and the fourth fluid flow forms a fourth fluid concentric protection zone. The third and fourth fluids flow from ring device Nx to ring device Nx+1.

A range of different diameters for the third 113 and fourth 114 fluid outlets, and the corresponding exits 205, 206 are intended to be within scope of the invention. In some embodiments, the diameter of the third 113 and fourth 114 fluid outlets, and the corresponding exits 205, 206, are the same; in other embodiments they may be different. A range of different radial positions on the surface of the injection/bleed ring device 110 for the plurality of third 113 and fourth 114 fluid outlets and the corresponding exits 205, 206 are intended to be within scope of the invention. In some embodiments, the third 113 and fourth 114 fluid outlets located around the bottom exterior of the ring device 100 are channels as shown in FIG. 2. In some embodiments, the channels may comprise milled channels, corrugated outer wall channels, z-shaped channels, tubular cooling jacket channels, or other channels.

Referring to FIGS. 3A, 3D, 3F, and 3H, for the third fluid, the plurality of third fluid outlets 113 are coupled to a third fluid distribution manifold 212 extending circumferentially around the ring structure and coupled to the third fluid inlet 203. Similarly, for the fourth fluid, the plurality of fourth fluid outlets 114 are coupled to a fourth fluid distribution manifold 213 extending circumferentially around the ring structure and coupled to the fourth fluid inlet 204. Each of the respective fluid distribution manifolds may be operable to distribute fluid to the respective fluid outlets. In some embodiments, additional unique fluids and corresponding fluid outlet(s) may be included, wherein each unique fluid outlet is coupled similarly to a respective fluid distribution manifold and respective fluid inlet. For some embodiments, an outlet duct may connect the fluid outlet to the fluid distribution manifold for each respective fluid. The outlet duct allows fluid to travel from the distribution manifold to the outlet. In some embodiments, a wall may separate fluid distribution manifolds. Each fluid flow may be controlled independently. In some embodiments, the fluid pressure in each respective fluid manifold may differ. In some embodiments, reactant(s)/reagent(s) will be pre-heated prior to being injected.

Referring to FIGS. 2, and 13B, in some embodiments, a cylindrical liner 162 may be positioned in between the third fluid outlets 113 and the fourth fluid outlets 114 (i.e., between the central reaction zone and the tubular shell). The liner 162 may be solid or porous. The liner may be secured on the surface of the injection/bleed ring device with placement within a groove 62g capable of supporting thermal expansion of the liner, as shown in FIG. 2. In different embodiments, additional liners 162 may be provided between different concentric protection zones. The liner(s) 162 may be secured on the surface of the injection/bleed ring device with placement within a groove 60g capable of supporting thermal expansion of the liner, as shown in FIG. 2. The liners 162 may be secured between and coupled to injection/bleed ring devices 110. The placement of liners 162 at any location along the longitudinal length of the tubular shell is intended to be within scope of the invention.

In some embodiments, more than one cylindrical liner 162 may be positioned on the surface of the injection/bleed ring device 110. Any radial position(s) of the liner(s) are intended to be within scope of the invention. Each end of the liner(s) secured between injection/bleed ring devices 110 may be positioned at a plurality of radial positions on the surfaces of 110, such that the liner can be positioned at a plurality of angles. Any combination of porous and/or solid liner(s) are intended to be within scope of the invention. In some embodiments, any combination of liners may separate a plurality of concentric protection zone(s). For aggressive chemical reactions, a liner is preferred to isolate the central reaction zone from the tubular shell. In some embodiments, a pressure differential across the liner can drive fluid flow radially inward through a porous liner from the third fluid concentric protection zone to the fourth fluid concentric protection zone. In some embodiments, this pressure differential may be used to provide supplemental thermal/deposit/corrosion protection, diffuse reactants from third fluid concentric protection zone to fourth fluid concentric protection zone), provide a purge to prevent backflow of reaction byproducts, and/or permit transition to reactor lay-up.

### Circumferential Protective Reactant(s)/Reagent(s) Bleed

As shown in FIGS. 2, 3A, 3D and 3H, in some embodiments, along the top surface of the injection/bleed ring device 110, collection inlets 205 and 206 are included to collect a fifth fluid and a sixth fluid. The fifth fluid and sixth fluid flows were injected from ring device 100 Nx-1 (i.e., ring device Nx-1 is above ring device Nx in vertical embodiments) and flowed along the axial length of the tubular shell to ring device Nx for collection. In such embodiments, there may be a plurality of inlets 205 and 206 located circumferentially around the top exterior of the device 110. The inlets 205 and 206 are openings through the surface of the device for each of the respective fluids to flow into circumferentially to the tubular shell. In some embodiments, there may be inlets for a plurality of unique fluids. In some embodiments, the inlets located around the top exterior of the device may include channels as shown in FIG. 2. In some embodiments, the channels may comprise milled channels, corrugated outer wall channels, z-shaped channels, tubular cooling jacket channels, or other channels.

The fifth 205 and sixth 206 fluid inlets are located around a common inlet plane for coaxial flow directed along the longitudinal axis 30 and adjacent to the tubular shell. The fifth 205 fluid inlets are positioned circumferentially adjacent to the tubular shell, and the fifth fluid flow forms a fifth fluid concentric protection zone. The sixth 206 fluid inlets are positioned circumferentially adjacent to the fifth fluid inlets 205, and the sixth fluid flow forms a sixth fluid concentric protection zone. Different diameters for the fifth 205 and sixth 206 fluid inlets are intended to be within scope of the invention. In some embodiments, the diameter of the fifth 205 and sixth 206 fluid inlets are different; in other embodiments they may be the same. Different radial positions for the fifth 205 and sixth 206 fluid inlets on the surface of the injection/bleed ring device 110 are intended to be within scope of the invention. In some embodiments, the fifth 205 and sixth 206 fluid inlets may be located around the top exterior of the device are channels as shown in FIG. 2.

As shown in the exemplary embodiments of FIGS. 3A, 3D, and 3H, for the fifth fluid, the plurality of fifth fluid inlets 205 are coupled to a fifth fluid distribution manifold 214 extending from and coupled to the fifth fluid outlet 115. Similarly, for the sixth fluid, the plurality of sixth fluid inlets 206 are coupled to a sixth fluid distribution manifold 215 extending from and coupled to the sixth fluid outlet 116. Each of the respective fluid distribution manifolds distributes fluid to the respective fluid outlets. In some embodiments, additional unique fluids and corresponding fluid inlets(s) may be included, wherein each unique fluid inlet is coupled similarly to a respective fluid distribution manifold and respective fluid outlet. For some embodiments, an outlet duct may connect the fluid outlet to the fluid distribution manifold for each respective fluid. The outlet duct allows fluid to travel from the distribution manifold to the outlet. In some embodiments, a wall may separate fluid distribution manifolds. Each fluid flow may be controlled independently. In some embodiments, the fluid pressure in each respective fluid manifold may differ. The fluid from each respective fluid manifold is drawn from the inlets, through the distribution manifold, and ejected from the injection/bleed ring device for regeneration. In some embodiments, the fluid is regenerated through treatment which may comprise chemical, thermal, and/or physical means known to those skilled in the art as a means to return the fluid to its condition prior to injection into the reactor.

Referring to FIGS. 2 and 13B, in some embodiments, a cylindrical liner 162 may be positioned in between the fifth fluid inlets 205 and the sixth fluid inlets 206. The liner may be solid or porous. The liner may be secured on the surface of the injection/bleed ring device with placement within a groove 62g capable of supporting thermal expansion of the liner. In some embodiments, more than one liner may be positioned on the surface of the injection/bleed ring device 110 to separate different fluid inlets. Any radial position(s) of the liner(s) are intended to be within scope of the invention. Any combination of porous and/or solid liner(s) are intended to be within scope of the invention. In some embodiments, any combination of liners may separate a plurality of concentric protection zone(s). The liners are secured between and coupled to injection/bleed ring devices 110. Each end of the liner(s) secured between injection/bleed ring devices 110 may be positioned at a plurality of radial positions on the surfaces of 110, such that the liner can be positioned at a plurality of angles. The placement of liners at any location along the longitudinal length of the tubular shell is intended to be within scope of the invention. For aggressive chemical reactions, a liner is preferred to isolate the central reaction zone from the tubular shell.

In some embodiments, as shown in FIGS. 2, 3A, 3D, 3H, 4, and/or 5, a unique fluid may be present in a segregated annulus chamber 280 that is uniform along the entire length of the longitudinal axis 30 of the tubular shell (i.e., forming a uniform concentric protection zone along the length of the longitudinal axis). The fluid is segregated from exposure to the other unique fluids through the means of a solid liner that is supported on the exterior surface of 110. As illustrated in FIGS. 4 and 5, the segregated annulus chamber 280 may be positioned between the tubular shell 105 and the third fluid concentric protection zone/fifth fluid concentric protection zone(s) 138. An inlet 134 and outlet 135, each of which may be perforated, for the segregated annulus chamber 280 may be made through the injection ring device (Nx) 110 as shown in FIG. 7, eliminating the need for a circumferential fluid distribution manifold. The inlet 134 may be coupled to a duct that is coupled to an outlet, extending in parallel to the longitudinal axis 30 and is isolated from any fluid distribution manifolds present in the device 110. The segregated annulus chamber 280 is such that fluid flows seamlessly along the length of the longitudinal axis (e.g., through Nx−1 to Nx to Nx+1). The fluid for this segregated annulus chamber may be injected and ejected at any location along the axial length of the shell through a perforated injection/ejection port.

The injection/bleed ring device material can be any suitable material compatible with chemical reaction and/or operating conditions. In some embodiments, the exterior surface of 110 may have a protective coating for thermal and/or corrosion. In some embodiments, the thermal and/or corrosion protective coating comprises a ceramic layer. In some embodiments, the ceramic layer comprises zirconia such as yttria stabilized zirconia (YSZ), and/or metal oxide species. In some embodiments, any part of the exterior surface of 110 may comprise a film cooling layer. In some embodiments, the film cooling layer comprises a porous or nonporous liner covering any part of the inner surface of 110 and containing a continuous flow of fluid that transfers heat away from any part of the surface and that further isolates the surface of 110 from the longitudinal axis 30 while also providing a means to isolate all outlets 112, 112a, 113, 114, and/or inlets 205, 206 from the cooling layer. In some embodiments, a heat shield may be present on any part of the inner surface of 110.

In some embodiments, the injection/bleed ring device 110 is assembled/constructed from a plurality of individual injection and/or bleed ring segments, each comprising at least one fluid distribution manifold and/or a dual fluid distribution manifold, wherein all of the injection ring device segments are coupled together with means that allow the ability for the individual injection and/or bleed ring(s) of the device 110 to be de-coupled for ease of assembly or disassembly. In this aspect, in addition to the reactor as a whole consisting of a modular assembly, the injection/bleed ring device 110 is itself a modular assembly. In the event that one of the fluid distribution manifolds is out of service, instead of replacing the injection/bleed ring device 110 as a whole, the respective fluid distribution manifold injection or bleed ring segment is simply removed and replaced, greatly simplifying reactor maintenance. Alternatively, the injection/bleed ring device 110 may be constructed as a holistic device that includes each of the fluid distribution manifolds and/or dual fluid distribution manifolds joined together through any means known to those skilled in the art.

### Tubular Shell Assembly

FIGS. 4, 5, 6, 7, and 8A/8B illustrate a different views of an embodiment of a tubular shell supporting a plurality of injection/bleed ring device(s) 110 of the present invention. Although it is not the intention of the invention to be limited to any particular embodiment (or a particular operating condition and/or chemical reaction), for convenience, this illustrated embodiment will be described.

In the illustrated embodiment of FIGS. 4-7, the elements that comprise the tubular shell assembly comprise the injection/bleed ring devices, inlet(s), and outlet(s). The tubular shell construction materials can be any suitable material compatible with the chemical reaction and operating conditions. In some embodiments, the tubular shell comprises a tubular pressure vessel. In some embodiments, the inner surface of the tubular shell may have a smooth surface. In some embodiments, the inner surface of the tubular shell may have a ribbed surface. The size and thickness of the tubular shell may be adequate for the operating conditions and must be in accordance with all relevant codes for compliance (e.g., ASME Pressure Vessel codes such as ASME Section VIII, Div 1 and/or ASME Power Piping Code B31.1).

The injection/bleed ring device(s) can be supported within the tubular shell by using various fastening and connecting methods such as those shown in FIG. 3G. In some embodiments, the outer surface of the injection/bleed ring device 110 may have any modifications to support ring placement within the tubular shell for any and all embodiments. For example, in some embodiments, as illustrated in FIGS. 3G and 4, the injection/bleed ring device 110 is supported within a tubular shell 105 between a flange and/or clamp connection 125 (clamp connection such as Grayloc™ as an example with modifications in FIG. 3G).

In embodiments of the invention, chemical injector/ejector devices and taps 126 can be drilled into the hubs 127 and coupled directly to the injection/bleed ring device 110 as shown in FIG. 4 for each of the unique fluid inlets and outlets (e.g., 201, 202, 203, 204, 115, 116). A plurality of circumferential and/or axial positions for the injector/ejector device(s) are intended to be within scope of the invention. In some embodiments, the injection/bleed ring device may be supported between a flange and/or clamp connection of a tubular shell which segregates the tubular shell into a modular section (Nx). The use of a flange and/or clamp connection supporting the injection/bleed ring device may be advantageous as the reactor becomes modular enhancing flexibility, scalability, and/or other factors. In some embodiments, the injection/bleed ring device may be supported directly within a tubular shell (i.e., without a clamp and/or flange connection and with injector/ejector taps directly coupled to the device). In some embodiments, the injection/bleed ring device may be supported directly within a tubular shell (i.e., with injector/ejector taps directly coupled to the ring device) and may also be supported between a flange and/or clamp connection as shown in FIGS. 3G and 4. The tubular shell, injection/bleed ring device(s), liner(s), and/or all relevant connections are designed to accommodate longitudinal and/or radial expansion from temperature and/or other fluctuations through any means (e.g., expansion joints, etc,). In some embodiments, the concentric protection zones(s) are segregated with the support of spacers to support fluid flow through the concentric protection zone(s).

In embodiments of the invention, each injection/bleed ring device (Nx) along the axial length of a tubular shell represents a stage of the reactor. In some embodiments, a plurality of stages may exist for the reactor. FIGS. 5-7 provide illustrations of a reactor assembly with a tubular shell 105 (i.e., segments 105a through 105d) supporting five injection/bleed ring devices 110 coupled to porous liners and/or solid liners 162 along its length with clamp and/or flange connections 125 (representing five modular sections and five stages). The quantity of the injection/bleed ring devices and the spacing between the ring devices along the axial length of the reactor is defined by the reactor operating conditions, chemical reaction, materials, thermal/concentration gradient profiles, and other relevant parameters and a plurality of distances between ring devices is intended to be within scope. In some embodiments, along the axial length of the reactor, injection/bleed ring devices can be operated at plurality of different operating conditions.

In some embodiments, the reactor's tubular shell has an open inlet end and an open outlet end and represents a flow through reactor. Referring to FIG. 5, the illustrated tubular shell 105 (i.e., segments 105a through 105d) has an open inlet 130 and open outlet 131 as an embodiment indicating a simple modification to typical PFRs with the incorporation of injection/bleed ring devices 110 along the axial length. For example, for an existing flow through PFR reactor, at any point along the axial length of the reactor can injection/bleed ring devices be supported to provide the advantages of the present invention. In some embodiments, inlet ports, ejection ports, and/or (clamp and/or flange) connections may be present along the axial length of the tubular shell.

In some embodiments, the tubular shell can be oriented horizontally or vertically. Referring to the exemplary embodiment of FIGS. 4-7, the tubular shell 105 is oriented vertically, and the shell is closed at the top 100t and bottom 100b with blind flange and/or clamp connections. The tubular shell is fluid-tight and may be closed by any means known to those skilled in the art. In some embodiments as shown by FIGS. 4-7, it is assumed that the reactor operates as a downflow reactor such that all entering fluid flows downward. In alternative embodiments, the reactor can operate as an upflow reactor such that all entering fluid flows upward. Or, in other alternative embodiments, the reactor may operate with zones functioning as a combination of both upflow and/or downflow and/or operating counter-currently. It is to be appreciated that different orientations will result in different locations for the injection/ejection points along the length of the reactor, tubular shell, and/or injection/bleed ring device(s) (i.e., including the placement of the inlets and outlets on the injection/bleed ring device(s)). As shown in FIG. 6, a schematic is provided with inlet ports 134, ejection ports 135, and clamp and/or flange connections 125 which may support multiple injection/bleed ring devices 110.

Referring to the embodiment illustrated in FIGS. 4 and 6, a plurality of inlet ports 134 may be coupled to the hubs 127 of the tubular shell 105 wherein chemical injectors such as injection quills 126 or other known means are coupled to the injection/bleed ring devices 110 for radial injection of reagent(s)/reactant(s) through the first fluid inlet 201, second fluid inlet 202, and/or a plurality of other fluid inlets and tangential injection through third fluid inlet 203, fourth fluid inlet 204, and/or a plurality of other fluid inlets. A plurality of other fluids can be injected through inlet injection ports 134 along the tubular shell 105 at a plurality of locations. A plurality of ejection ports 135 may be coupled to the hubs 127 of the tubular shell 105 wherein chemical ejectors 126, are coupled to the injection/bleed ring devices 110 for bleeding of reactant(s)/reagent(s) through the fifth fluid outlet 115, sixth fluid outlet 116, and/or a plurality of other fluid outlets. A plurality of other fluids can be ejected through 135 along the tubular shell 105 at a plurality of locations. Referring to FIGS. 6 and 7, in some embodiments, one or more longitudinal ports 136 may be positioned at both ends of the tubular shell 105 and are operable for the injection or ejection of fluid. In some embodiments, longitudinal port 136 may be positioned at one end of the tubular shell 105. In some embodiments, longitudinal port 136 may comprise an injection port 134. In some embodiments, longitudinal port 136 may comprise an ejection port 135.

Referring to FIG. 7, in some embodiments, the tubular shell assembly may further comprise an injection/bleed ring device 110 at the top of the tubular shell secured between the blind flange and/or clamp connection 100t and the tubular shell 105. This embodiment of an injection/bleed ring device secured at 100t would not comprise circumferential bleed (as described for FIG. 7), but could be configured with circumferential injection and may be configured with a liner as described anywhere herein. Additionally, 110 secured at 100t could be configured for radial injection into a longitudinal port 136 functioning as an injection 134 or ejection port 135. In an alternative embodiment, for 110 secured at 100t, in lieu of radial injection, a series of primary longitudinal injectors could be placed at the centerline of the longitudinal axis 30, such as shown by 136 to inject 134 reactant(s) forming a central reaction zone along the centerline of the longitudinal axis (i.e., directing the reactant(s) to the bottom).

Similarly, referring to FIGS. 6 and 7, in some embodiments, the tubular shell assembly may further comprise an injection/bleed ring device 110 at the bottom of the tubular shell secured between the blind flange and/or clamp connection 100b and the tubular shell 105. This embodiment of an injection/bleed ring device secured at 100b would not comprise circumferential injection (as described for FIGS. 6 and 7), but could be configured with circumferential bleed and may be configured with a liner as described anywhere herein. Additionally, 110 secured at 100b could be configured for radial injection into a longitudinal port 136 functioning as an injection 134 or ejection port 135. In an alternative embodiment, for 110 secured at 100b, in lieu of radial injection, a series of primary longitudinal injectors could be placed at the centerline of the longitudinal axis, such as shown by 136 to inject 134 reactant(s) forming a central reaction zone along the centerline of the longitudinal axis from the bottom of the tubular shell (i.e., directing the reactant(s) to the top).

In some embodiments, the tubular shell and/or injection/bleed ring device(s), the reactor may operate at a plurality of conditions and respond to system changes. For example, at a plurality of positions along the length of the tubular shell, injection/bleed ring device(s) may be configured to operate as neutralization zones, neutralizing and/or transitioning the chemical reaction and the corresponding reactor operating conditions.

In some embodiments, the injection/bleed ring devices operate in fluid communication, wherein each device responds to any potential changes in reaction conditions. In some embodiments, along the axial length of the tubular shell, monitoring devices are internally and/or externally located to monitor relevant chemical reaction parameters. Instrumentation/devices may be included for monitoring parameters such as, but are not limited to pressure, temperature, pH, conductivity, cation conductivity, oxidation-reduction potential (ORP), chemical oxygen demand (COD), total organic carbon (TOC), flow rate, water/fluid level, dissolved oxygen (DO), iron (Fe), sodium (Na+), Ca, Mg, chloride, sulfate, alkalinity, silica, phosphate, ammonia, H2S, CO, NOx, SOx, concentrations for a plurality of constituents, or other sensors. In some embodiments, fluid at a plurality of locations is sampled (i.e., collected) and analyzed for a plurality of parameters.

In such embodiments, the reactor operation and control scheme are automated. Data may be acquired and stored from monitoring devices, and the feedback acquired from monitoring devices is relayed to a control scheme/structure for the reactor and the injection/bleed ring devices, and the control scheme/structure feedback response results in changes to the operation of the reactor and/or injection/bleed ring devices. An example of such scenario may be that the reaction temperature is monitored within the central reaction zone with a thermocouple device, the thermocouple identifies an increase in reaction zone temperature, and the injection/bleed ring device(s) respond to this thermal gradient by decreasing (e.g., through valve actuation) the flow of reactant upstream, downstream, and/or at the injection/bleed ring device in proximity to the thermocouple. The reactor operation and controls are dependent on the chemical reaction and operating conditions and would be known by those skilled in the art.

In some embodiments, a reactor 100 may be operated remotely such that the reactor is physically located within an enclosure and the reactor is controlled at a location external to the reactor enclosure (i.e., with the exception of any potential monitoring devices). Under normal operation, any gases generated from the reaction would be scrubbed (i.e., treated) as appropriate and vented to the atmosphere. In the event of a leak and/or other event, the fluid is contained within the enclosure to ensure the safety of operating personnel. The means to control the reactor(s) may include any means such as a programmable control logic (PLC) controller, Supervisory Control and Data Acquisition (SCADA) system, distributed control system (DCS), and/or other methods. Additionally, the means to control the automated operation of the reactor(s) may include machine learning and/or artificial intelligence control schemes.

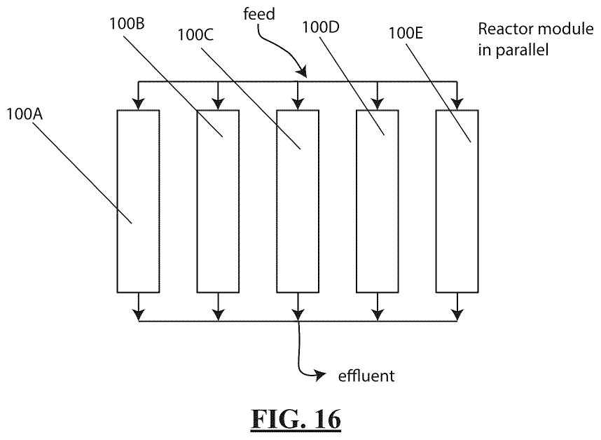

In some embodiments, the reactor 100 may be operated continuously or as a batch process. In some embodiments, multiple reactors are operated in parallel to allow for a range of turndown capabilities and redundancy as shown in FIG. 16. In some embodiments, multiple reactors are operated in series. In some embodiments, wherein multiple reactors are operated in series, each reactor may be operated at different operating conditions. In some embodiments, multiple reactors are operated in parallel, as illustrated in FIG. 16, and may be operable to convey effluent to a common treatment module (e.g., such as for solids treatment).

An aspect of the invention described herein is such that the reactor can be operated at a plurality of conditions such as low pressure/low temperature (<100 deg C., <1 MPa), low pressure/high temperature (>100 deg C., <1 MPa), high pressure compressed water (>20 deg C., >1 MPa), steam (>100 deg C., >0.1 MPa), wet air oxidation (WAO) conditions (120-350 deg C., 0.1-20 MPa), hydrothermal oxidation conditions (HTO) (>100 deg C., >0.1 MPa), SCWO (>374 deg C., >22.1 MPa), SCWG (>374 deg C., 22.1 MPa), hydrothermal liquefaction (250-350 deg C., 4-20 MPa), or other conditions that would be known to those skilled in the art. In some embodiments, the reactor can be operated at multiple operating conditions at a plurality of locations within the reactor, or other parts of the reactor system.

### Section 2. Methods of Operation/Protection

Methods for operating reactors to protect them from aggressive chemical reaction(s) may include the radial and/or axial flow of a fluid barrier scheme that may include an initiator, inhibitor, and/or insulator chemical species to isolate the chemical reaction from the reactor, and the corresponding bleeding and regeneration of the fluid barrier through an array of devices in fluid communication to respond rapidly to changes in reactor operating conditions. A general method considering a variety of aggressive chemical reactions that may have characteristics that comprise high temperature and/or pressure operating conditions, the presence of scaling and/or corrosive constituents, high pH or low pH conditions, reactions that may output thermal runaway and/or are autocatalytic, oxidating conditions producing a significant amount of heat, and/or hazardous reactant and/or reaction byproduct constituents and is not intended to limit the aspect of the invention. A more detailed exemplary application for a protection method for SCWO is described in Section 3.

FIG. 9 provides an illustrative diagram of an embodiment having multiple fluid layers (i.e., concentric protection zones) (ix) comprising i1 (137), i2 (138), and i3 (139) that surround the central reaction zone (R, 40) and the corresponding inward radial flow. It is to be appreciated that while three concentric protection zones are illustrated in FIG. 9, in other embodiments more or fewer concentric protection zones may be provided, As shown in FIG. 9, the first concentric protection zone i1 (137) is adjacent to the central reaction zone 40; the next concentric protection zone i2 (138) is adjacent to the first concentric protection zone i1 (137); and the third concentric protection zone i3 (139) is adjacent to the second concentric protection zone i2 (138). The radial flow for 137, 138, and/or 139 inward is illustrated by solid or dashed arrows towards the central reaction zone (R) 40. The solid arrows indicate that an inward radial flow is present whereas dashed arrows indicate an optional inward radial flow. Optional inward radial flow indicates the presence of a solid liner or that there is simply no fluid layer present for a given zone (ix).

In some embodiments, such as that shown in FIG. 13A, there is only one filming zone 137 with no liner separating this filming zone 137 from the central reaction zone 40. In other embodiments, for a given chemical reaction, there should be at least two layers of fluid (e.g., such as i1 (137) and i2 (138)-concentric protection zones) between the central reaction zone 40 and the reactor wall 105, as illustrated in FIG. 13B. In some embodiments, a porous liner 162 may separate i1 (137) and i2 (138). In other embodiments, a solid liner 162a may separate i1 (137) and i2 (138). In other embodiments, there may be no liners present between i1 (137) and i2 (138. In some embodiments, there may be inherent fluid mixing between i1 (137) and i2 (138). In some embodiments, a porous liner 160 may separate i2 (138) and i3 (139). In some embodiments, a solid liner 160 may separate i2 (138) and i3 (139). In some embodiments, there may be no liners present between i2 (138) and i3 (139). In some embodiments, there may be inherent fluid mixing between i2 (138) and i3 (139).

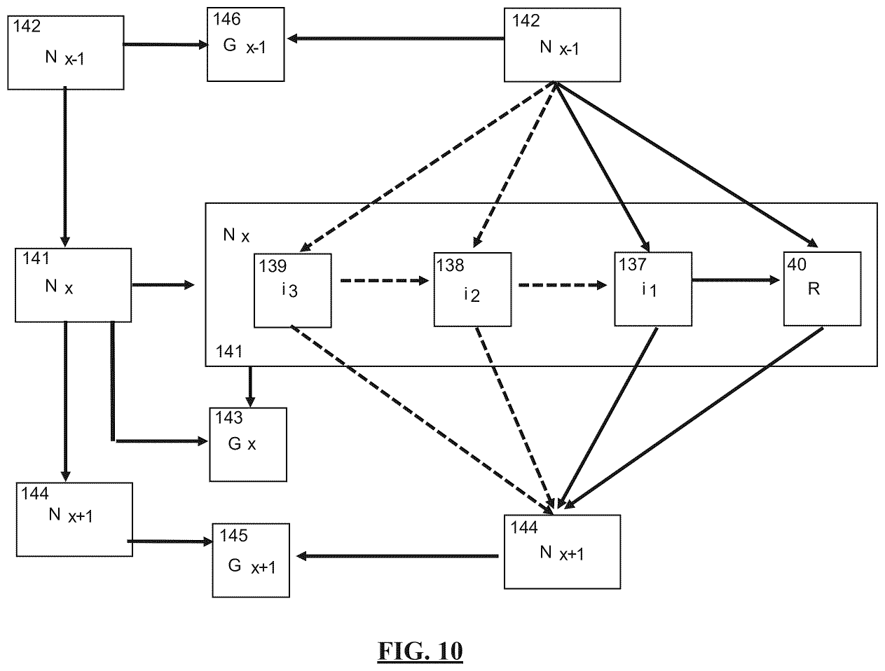

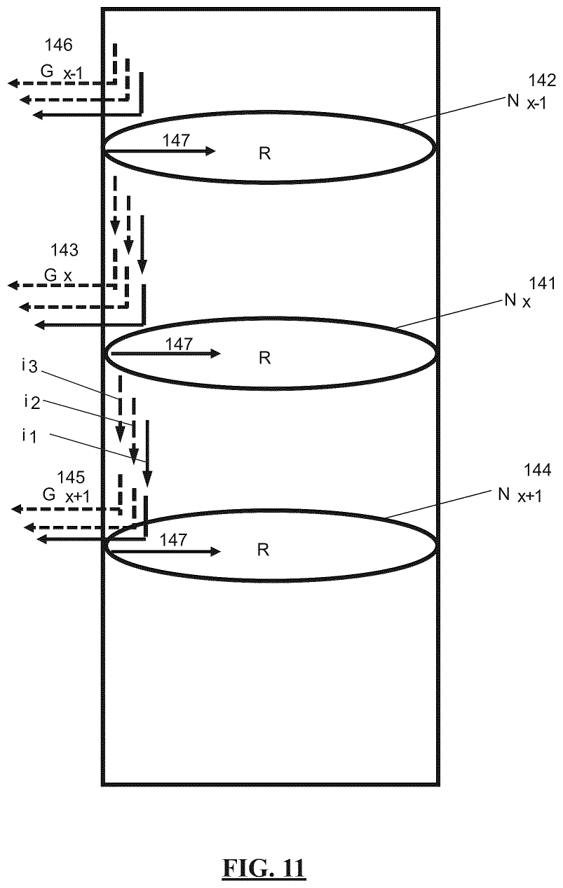

FIG. 10 provides an illustrative embodiment of multiple fluid layers (i.e., the concentric protection zones) (ix), i1 (137), i2 (138), and i3 (139) that surround the central reaction zone (R) 40 and the corresponding radial flow and axial flow for a given reactor section (Nx) 141. FIG. 10 provides an illustrative embodiment for a reactor operating with both ix and R as downflow, wherein the axial flow of ix comprises downward flow from Nx−1 (142) to Nx (141), wherein fluid is bled for regeneration (Gx) 143. Additionally, in FIG. 10, the axial flow of ix comprises downward flow from Nx (141) to Nx+1 (144), wherein fluid is bled for regeneration (Gx+1) (145) at Nx+1 (144). Similarly, in FIG. 10, Nx−1 is bled for regeneration (Gx−1) (146), after receiving the fluid flow of ix from Nx−2 (not shown). In some embodiments, R and ix may be upflow. In some embodiments, R may be either upflow or downflow and any combination of ix can be either upflow and/or downflow. In some embodiments, any ix present can be any combination of upflow and/or downflow. The radial flow inward is illustrated by solid or dashed arrows towards the central reaction zone. The solid arrows indicate that an inward radial flow is present whereas dashed arrows indicate an optional inward radial flow. Optional inward radial flow indicates the presence of a solid liner or that there is simply no fluid layer present for ix. Axial flow is illustrated by solid or dashed arrows between Nx−1, Nx, and Nx+1. The solid arrows indicate that an axial flow is present for a given ix whereas dashed arrows indicate an optional axial flow for ix. Optional axial flow indicates that there may simply be no fluid layer present for ix. It is to be appreciated that the solid and dashed arrows of FIG. 10 leading to 137, 138, 139 and 40 are illustrative of a particular embodiment, and that in other embodiments different combinations of solid or dashed arrows (representing different flows) may be provided.

FIG. 11 illustrates an embodiment of a flow-through reactor. In some embodiments, as illustrated in FIG. 11, a reactant feed 147 is radially injected into the reactor where it flows radially and axially through the reactor's central reaction zone 40, the ix (i.e., i1 (137), 12 (138), and/or i3 (139)) are injected circumferentially along the reactor's walls from Nx (141), and then the ix (i.e., i1 (137), i2 (138), and/or i3 (139)) are bled 145 from Nx+1 (144). Similarly, the ix injected from Nx−1 (142) are bled (143) from Nx (141). The bleed of ix collected from each Nx is treated and then recirculated back to Nx. In some embodiments, each Nx reactant feed and/or ix feed may be operated at a plurality of conditions.

In embodiments of the invention, each ix present falls into at least one of the zone categories from the following list: initiator (i), inhibitor (i), and/or insulator (i). For example, the presence of an initiator ix may represent a fluid that continues to sustain the reaction in R, but at a more controlled rate and/or at a reduced rate. For example, the presence of an inhibitor ix may represent a fluid that scavenges reactants to prevent the reaction in R from occurring. For example, the presence of an insulator ix may represent a fluid that insulates the reactor.

The combination of all zones present in the reactor consists of a iii scheme. The combination of two zones present in the reactor consists of an ii scheme. In some embodiments, ii may be present, but fluid thermal, chemical, and/or physical properties may extend the ii's reach into an additional i category without an additional fluid layer present. For example, there may be only two distinct fluid layers present with the primary properties falling into ii, but the fluid properties may comprise additional characteristics that extend to iii. For example, a fluid that initiates the reaction with catalytic properties (initiator category), but also has characteristics that reduce the heat flow from R (insulator category). Another example would be a fluid that suppresses the reaction (inhibitor category), but also reduces the heat flow from R (insulator category). In different embodiments, different combinations of initiator(s) and/or inhibitor(s) and/or insulator(s) may be used to accomplish different results. For purposes of accomplishing the objectives of different methods, it is beneficial to incorporate more than one category (e.g., initiator, inhibitor, and/or insulator) for a given concentric protection zone to enhance reaction efficacy and safety, while also reducing cost/complexity.

### Section 3. Hydrothermal Reactor and Methods of Protection for SCWO

It is not the intention of the invention to be limited to a particular operating condition and/or chemical reaction. By way of example and for illustrative purposes only, and without limitation, an embodiment of the present invention device (which may comprise any disclosures within Section 1) and method of protection (which may comprise any disclosures within Section 2) will be described in this Section 3 in accordance with a central reaction zone 40 at SCWO conditions (i.e., >374 deg C., >22.1 MPa) for the mineralization of organic compounds in the presence of inorganic compounds.

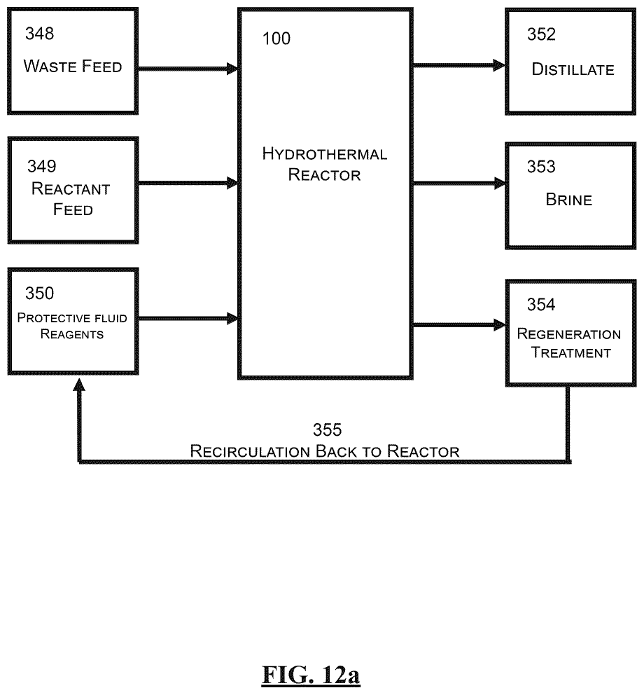

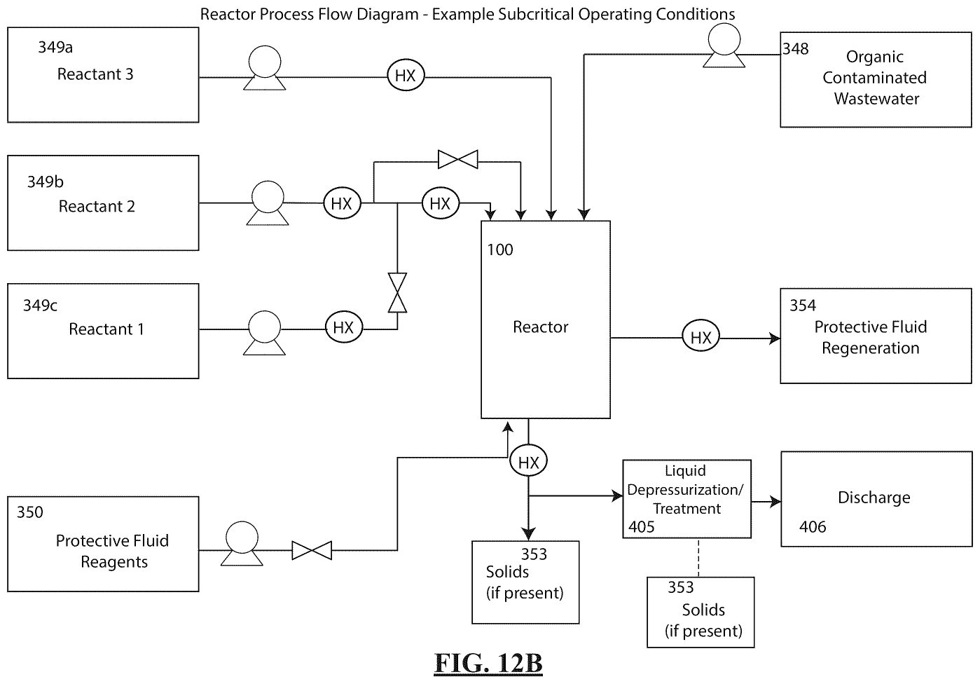

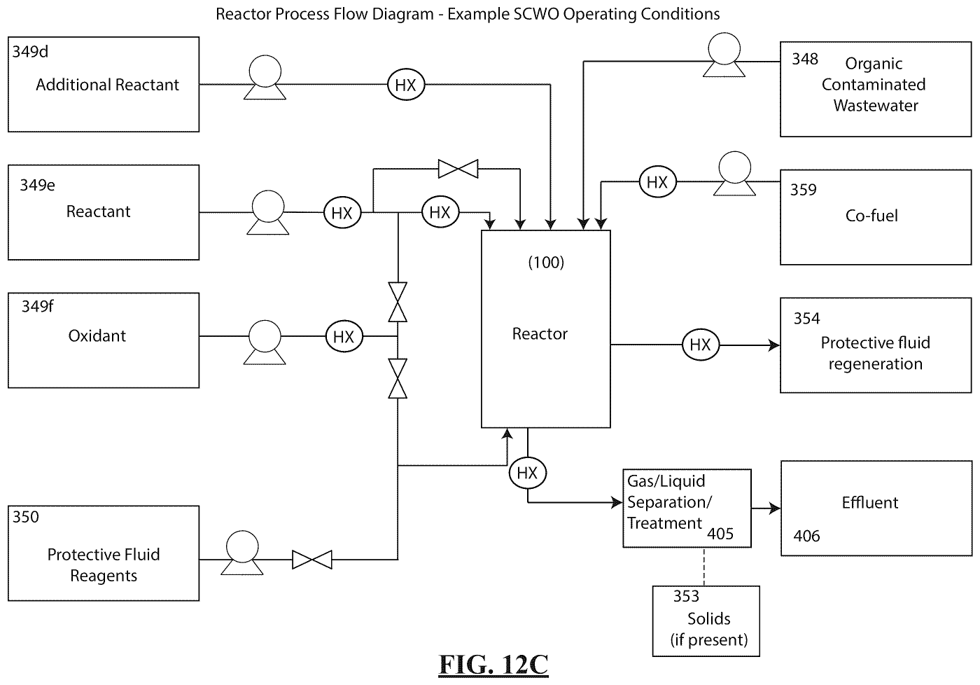

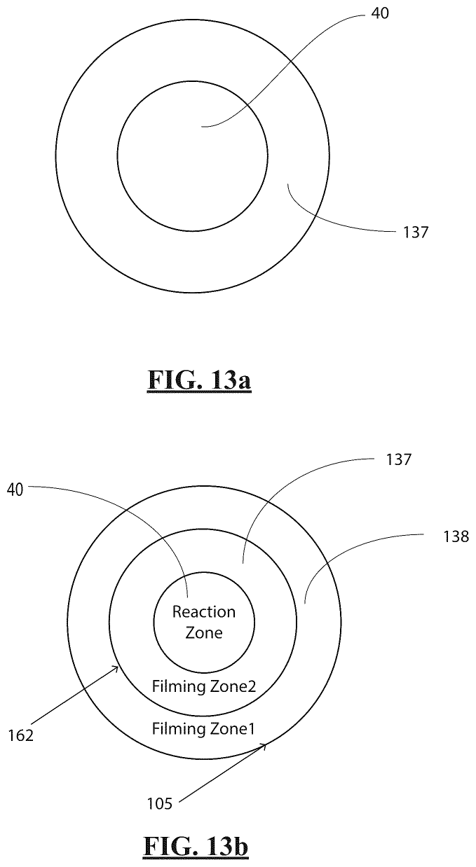

In this exemplary embodiment, FIGS. 12A and 12C provide a general process flow diagram for the mineralization of an organic compound in the presence of inorganic compounds within a waste (e.g., wastewater for purposes of discussion) with the reaction occurring at SCWO conditions (i.e., >374 deg C., >22.1 MPa). The general process flow for the reactor device and method may be such that the wastewater 348, reactant(s) (e.g., oxidant) 349, and protective fluid reagent(s) 350 are pressurized and fed to the reactor 100. The wastewater and oxidant are maintained for an appropriate residence time at operating condition for the reaction, and the treated distillate 352 and brine 353 are quenched, treated further, and de-pressurized (i.e. gas/liquid separation) prior to further treatment and/or discharge. The protective fluid reagent(s) 350 may be pressurized and injected into the reactor 100 to form concentric protection zone(s), maintained for an appropriate residence time to provide a protective fluid barrier, bled from the protection zone(s) and treated 354 (i.e., regenerated), and then recirculated back 355 into the reactor 100.

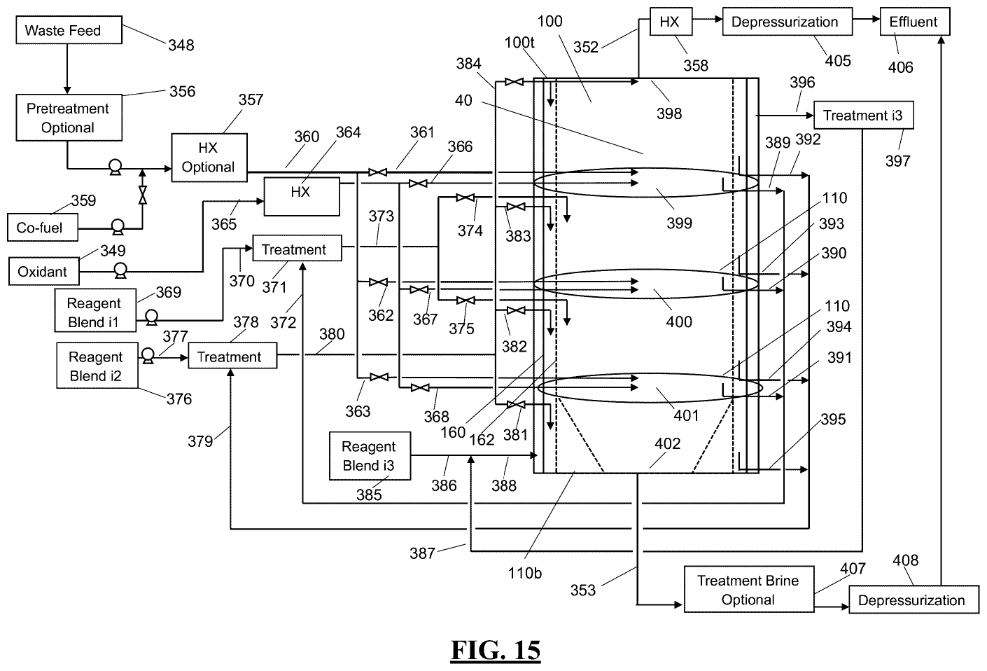

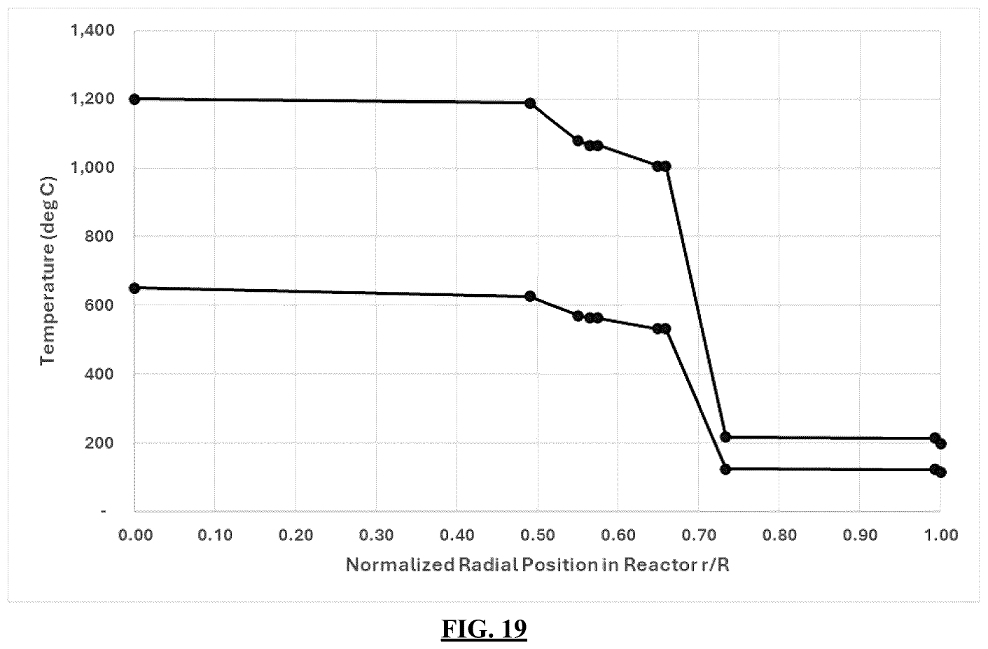

FIG. 15 illustrates a more detailed process flow diagram of FIG. 12A for the mineralization of an organic compound in the presence of inorganic compounds within a waste (e.g., wastewater) with the reaction occurring at SCWO conditions (i.e., >374 deg C., >22.1 MPa). In some embodiments, inorganic compounds may not be present with a waste for a SCWO application. FIG. 18 also illustrates an alternative embodiment for a detailed process flow diagram.

### Organic/Inorganic Compound Reactor Feed Supply (348)

The waste/wastewater 348 can be any source containing organic and/or

inorganic compounds. Any organic compound can be oxidized in the presence of (typically excess) stoichiometric conditions with adequate temperature and residence time. There are hundreds of thousands of organic compounds and this disclosure does not intend to limit compounds. In some embodiments, organics compounds of interest would be hazardous, toxic, and/or carcinogenic. Organic compounds such as organic halogens (organohalogens), polychlorinated biphenyls, pesticides, solvents, disinfection byproducts, pharmaceutical compounds, sewage sludge, chemical warfare agents, ethylbenzene, toluene, xylene, carbon tetrachloride, phenols, 1,4-dioxane, diethyl ether, furans, dioxins, acrylonitrile, alkyl phenol ethoxylates, acrolein, 2,4-dinitrophenol, 2-methyl-4,6-dinitrophenol, dichlorobenzenes, ethylene dichloride, vinylidene chloride, 1,2-dichloroethylenes, methylene chloride, perchloroethylene, methyl chloroform, trichloroethene, monochloroethene, methyl-tert-butyl-ether, gasoline oxygenates, lindane, chlordane, DDT, triazines, acetanilides, chlordane, dieldrin, aldicarbs, endocrine disruptors, personal care product chemicals, microplastics, acrylamide, epichlorohydrin, VOCs, surfactants, formaldehyde, trichloroacetic acid, phthalates, anilines, polynuclear aromatic hydrocarbons, trihalomethanes, bromodichloromethane, dibromochloromethane, haloacetic acids, dichloroacetic acids, nitrosamines, and/or others that would be known by those skilled in the art could be considered. In some embodiments, the hydrothermal reactor carries out a chemical reaction to defluorinate (i.e., break at least one carbon fluorine bond) and/or mineralize PFAS (i.e., compound contains at least one carbon fluorine bond). PFAS compounds may comprise the following list: PFOA, PFOS, PFNA, PFH×S, PFBS, HFPO-DA, TFA, TFMS, 2233-TFPA, PFBA, PFPeA, PFH×A, PFHpA, PFDA, PFUnA, PFDoA, PFTrDA, PFTeDA, NMeFOSE, PFPeS, PFHpS, PFNS, PFDS, PFDOS, 4:2FTS, 6:2FTS, 7:3 FTCA, 8:2FTS, PFOSA, NMeFOSA, NEtFOSA, NMeFOSAA, NEtFOSAA, NEtFOSE, ADONA, PFMPA, PFMBA, NFDHA, 9CI-PF3ONS, 11CI-PF3OUdS, PFEESA, 3:3FTCA, 5:3FTCA, 7:3FTCA, 13C4-PFBA, 13C5-PFPeA, 13C5-PFH×A, 13C4-PFHpA, 13C8-PFOA, 13C9-PFNA, 13C6-PFDA, 13C7-PFUnA, 13C2-PFDoA, 13C2-PFTeDA, 13CC3-PFBS, 13C3-PFH×S, 13C8-PFOS, D3-NMeFOSAA, PFO2H×A, PFO3OA, PFO4DA, PFO5DA, PEPA, PFECA_B, PFECA_G, D5-NEFOSAA, 13C2-4:2FTS, 13C2-6:2FTS, 13C2-8:2FTS, 13C3-HFPO-DA, D7-NMeFOSE, D9-NEtFOSE, D5-NEtFOSA, D3-NMeFOSA, 13C3-PFBA, 13C4-PFOA, 13C2-PFDA, 13C4-PFOS, 13C5-PFNA, 13C2-PFH×A, 1802-PFH×S, PEPA, PFECA-G, PFMOAA, PFO2H×A, PFO3OA, PFO4DA, PMPA, Hydro-EVE Acid, PFECA B, R-EVE, PFPrA, FHSAA, 6:2 FTA, (2,2,3,3,5,5,6,6-octafluoro-4-[1,2,2-trifluoro-2-(2,2,2-trifluoroethoxy)ethyl]morpholine, TBBP, TBMOPP, 2-FPDA, N-TamP-FhxSA, 3,5-Bis(heptafluoropropyl)-1H-1,2,4,4-triazole, C10H3F18NO2, C13H3F18N304, C15H2F13N2O2S, C7H3F12NO2, MeFBSEA, PFO5DA, NVHOS, PES, PFDoA, PFHpA, PFTeA, PFTriA, PFUnA, PFPeS, 10:2 FTS, NEtFOSAA, NEtPFOSA, NEtPFOSAE, NMeFOSAA, NMePFOSA, NMePFOSA, NMePFOSAE, PFDOS, PFOSA, PFODA, or a combination thereof. As would be known to those skilled in the art, there are thousands of PFAS compounds, and this list does not intend to limit the compound(s) that comprise the organic compound feed. In some embodiments, the total concentration of PFAS (e.g., as per EPA Method 1633) in the waste feed comprises>1,000 ppm, <1,000 ppm, <100 ppm, <50 ppm, <10 ppm, <1 ppm, <100 ppb, <10 ppb, <1 ppb, <700 ppt, <500 ppt, <250 ppt, or <100 ppt. In some embodiments, the organic feed source to be treated is selected from the following list: industrial wastewater, leachate, landfill leachate, aqueous film forming foam (AFFF), municipal wastewater, primary wastewater, secondary wastewater, tertiary wastewater, foam fractionation residuals, brine, resin regenerant byproduct streams or brine, activated carbon regenerant byproduct streams, novel sorbent regenerant byproduct streams, groundwater, drinking water, drinking water residuals, stormwater, semiconductor wastewater, chemical manufacturing wastewater (primary and secondary manufacturing), metal finishing and plating wastewater, textile wastewater, paper products wastewater, petroleum industry wastewater, steel industry wastewater, aluminum industry wastewater, food and beverage wastewater, wash water, biosolids, membrane concentrates, thermal desorption condensate, scrubber wastewater, stack emission wastewater, soil wash water, aqueous based solid slurries such as activated carbon, ion-exchange resin, soils, and precipitated solids from chemical reactions, or a combination thereof. In any of these organic feed sources, a plurality of inorganic species may be present in any form and in combination such as sulfate, bicarbonate/carbonate, chloride, silica, magnesium, calcium, iron, mercury, cadmium, zinc, aluminum, copper, cobalt, sodium, arsenic, barium, borate, bromide, fluoride, lead, lithium, manganese, nitrate, nitrite, phosphate, selenium, potassium, strontium, suspended matter, hydrogen sulfide, and/or ammonia.

Referring to FIG. 15, in some embodiments, the wastewater 348 in order to undergo the chemical reaction, is optionally pre-treated 356 prior to entering the hydrothermal reactor 100. In some embodiments, the wastewater to undergo chemical reaction is optionally fed to the hydrothermal reactor without any pretreatment. The pretreatment option is dependent on the wastewater characteristics as would be known and appreciated by those skilled in the art. Various pretreatment options could comprise, but are not limited to coagulation, flocculation, filtration, adsorption (e.g., activated carbon, ion-exchange, etc), membrane separation (e.g., reverse osmosis, nanofiltration, ultrafiltration, electrodeionization, etc), deaeration, chemical precipitation, disinfection, aeration, pH adjustment (i.e., increase or decrease), temperature adjustment (i.e., heating or cooling), foam fractionation, clarification, dilution, gravity sedimentation or settling, centrifugal sedimentation, dissolved air flotation, thickening, wet scrubbing, mechanical dewatering, absorption processes, electrochemical processes, liquid/liquid extraction processes, solid/liquid extraction processes, chemical catalyst regeneration, crystallization, magnetic fields, chemical oxidation, chemical reduction, oxidant/oxygen scavenging, natural treatment systems, UV treatment, distillation, stripping, humidity/gas drying control, moisture removal, activated alumina processes, metal recovery, or a combination thereof.

Referring to FIG. 15, in some embodiments, the wastewater 348 is optionally pre-heated 357 prior to entering the reactor 100. The selected option for pre-heating is dependent on the heat sources available. In some embodiments, the waste feed is not preheated. In some embodiments, the waste feed is preheated by recovering heat from the reactor effluent 358. In some embodiments, the feed is preheated through a heat exchanger recovering heat from the reactor effluent (i.e., combining 357 and 358). In a different embodiment, the feed is preheated through a heat exchanger recovering heat from the reactor effluent (i.e., combining 357 and 358), and the waste feed 348 comprises a very high organic compound concentration and comprises a very low concentration of inorganics. In another embodiment, the feed is preheated through a heat exchanger recovering heat from the reactor effluent (i.e., combining 357 and 358), and the waste feed 348 comprises a very high organic compound concentration and comprises no inorganic constituents.

In some embodiments, during startup and/or shutdown of the reactor, the influent may be preheated through the use of electrical surface heaters or through other means. In some embodiments, supplemental organic fuel (co-fuel) 359 may be used to increase the heating value of the wastewater 348 and/or during reactor start-up. In some embodiments, a co-fuel is used for reactor startup and then once at temperature, the co-fuel may not be required. In some embodiments, the co-fuel may comprise alcohols such as ethanol, methanol, or IPA, diesel, methane, gasoline, kerosene, biogas, or other fuels. In some embodiments, an actuating valve may be used to adjust the blend of co-fuel 359 with the wastewater. In some embodiments, the wastewater and co-fuel may be injected into the reactor separately at a plurality of locations. Referring to FIGS. 15, 6, and 4, the waste feed 348 supply is coupled to pressurized feed lines 360, 361, 362, and 363 and to the reactor's 100 tubular shell 105 inlet injection ports 134 (i.e., via 126) coupled to the radial injection inlets 201 of the injection/bleed ring 110.

### Oxidant Feed Supply (349)

In embodiments of the invention, oxidant feed may comprise compressed air, oxygen, hydrogen peroxide, ozone, permanganates, persulfates, or other reactants. In some embodiments, the oxidant may be blended with deionized water. In some embodiments, the oxidant is preheated 364 prior to injection into the reactor. In some embodiments, the oxidant is preheated through a heat exchanger recovering heat from the reactor effluent (i.e., combining 358 and 364). In some embodiments, the oxidant is preheated to >100 deg C., >200 deg C., >300 deg C., >350 deg C., >370 deg C., or >390 deg C. In some embodiments, the oxidant is electrochemically generated in-situ. In some embodiments, a high oxidant concentration shall be maintained in the reaction zone. In some embodiments, the oxidant concentration is <1 wt %, >1 wt %, >5 wt %, >10 wt %, >15 wt %, >20 wt %, >25 wt %, >30 wt %, >35 wt %, >140 wt %, >50 wt %, >60 wt %, or >70 wt %. In some embodiments, a high oxidant concentration is maintained in the reaction zone, but at some locations in the reaction zone it is less than the COD requirement and/or stoichiometric requirements for oxidizing the organic compounds. Referring to FIGS. 15, 6, and 4, the oxidant feed 349 is coupled to pressurized feed lines 365, 366, 367, and 368 and to the reactor's 100 inlet injection ports 134 (i.e., via (126)) coupled to the radial injection inlets 202 of the injection/bleed ring 110.

### Protective Reagent(s)/Reactant(s) Feed Supply (350) (369) (376) (385)

In some embodiments), one and/or more of the following reactant(s)/reagent(s) are used upstream of, downstream of, and/or within the reactor for the reaction (R) (140) and/or any combination of concentric protection zones ix (137) (138) (139): oxidants (air, oxygen, hydrogen peroxide, ozone, permanganates, persulfates, and/or others), pH adjustment reagents (citric acid, acetic acid, sodium hydroxide, calcium hydroxide, potassium hydroxide, ammonium hydroxide, hydrochloric acid, magnesium hydroxide, sodium carbonate, lithium carbonate, potassium carbonate, sulfuric acid, nitric acid, and/or others), alcohols (ethanol, methanol, isopropyl alcohol, and/or others), subcritical and/or supercritical water, supercritical carbon dioxide, carbon dioxide, steam, hydrogen, biogas, biodiesel, helium, argon, hydrogen, nitrogen, ammonia, methane, urea, surfactants (amphoteric, anionic, cationic, nonionic, zwitterionic, gemini), morpholine, cyclohexylamine, diethylaminoethanol, ethanolamines, monoethanolamine, methylamines, ethylamines, 3-methoxypropylamine, 2-aminoethyoxyethanol, sodium sulfite, sodium bisulfite, sodium bisulfate, potassium ferrate, calcium sulfate, glycol, glycolic acid, diethylhydroxylamine (hydroxylamines), oleyl propylenediamine, orthophosphates, polyphosphates, zero valent iron, aluminum hydroxide, aluminum sulfate, lithium aluminum hydride, sodium nitrite, sodium nitrate, ferric chloride, ferric sulfate, ferrous sulfate, sodium aluminate, activated carbon, aerogels, TFA, erythorbate, tetraacetylethylenediamine, urea peroxide, potassium pyrophosphate, sodium tripolyphosphate, sodium hexametaphosphate, ammonium bifluoride, hydroxyacetic-formic, superoxide, phosphoric acid, Non-FFPs, potassium sulfite, peracetic acid, phenol, zinc and zinc-based compounds, refrigerants, triazole based compounds, dihydrogen phosphate or trisodium phosphates, sodium borohydride, dichloromethane, permanganate, potassium ferrate, hydrazine, carbohydrazide, sodium dithionite, sodium perborate, sodium percarbonate, sodium perphosphate, sodium phosphates, calcium polyphosphate, methylethylketoxime, phosphino-carboxylic acid, propylene glycol, phosphonates, aminotris-methylenephosphonic acid, 1-hydroxyethylidene-1,1,-diphosphnoic acid, phosphonobutane-1,2,4-tricarboxylic acid, polyamino polyether methylene phosphonate, acrylic acid and allyl-hydroxy-propyl sulfonate ether, polyepoxysuccinic acid, ammonium peroxydisulfate, terpolymer of acrylic acid, 2-acrylamido-2-methylpropylsulfonic acid, t-butylacrylamide, ammonium acetate, fluorous solvents, ionic salts, metal catalysts that comprise iron, nickel, cobalt, palladium, aluminum, tin, titanium, and/or layered double hydroxides, nanofluid mixtures (i.e., carrier fluid with nanoparticles), eutectic mixtures and/or molten salt mixtures, molybdenum based compounds, ferric based compounds, oxygen scavenger compounds, common clean-in-place reagents, or other compounds that would facilitate oxidative reactions for organic compounds, passivation protection reactions, extraction reactions, reactions to inhibit byproduct formation, electrochemical reactions, or combinations thereof.

Referring to FIGS. 15, 9, 10 and 4, it is seen that in these illustrated embodiments, the i1 reagent blend 137 makeup supply 369 is coupled to pressurized feed line 370, which is coupled to i1 regeneration treatment 371. The regeneration treatment 371 also receives i1 recycle 372 as an influent. The regenerated i1 effluent from 371 is coupled to feed lines 373, 374, and 375 and to the reactor's 100 inlet injection ports 134 (i.e., via 126) coupled to the injection/bleed ring's 110 tangential injection inlets 204. In some embodiments, the reagent blend 138 makeup supply 376 is coupled to a pressurized feed line 377, which is coupled to i2 regeneration treatment 378. The regeneration treatment 378 also receives i2 recycle 379 as an influent. The regenerated i2 effluent from 378 is coupled to feed lines 380, 381, 382, 383, and 384 and to the reactor's 100 inlet injection ports 134 (i.e., via 126) coupled to the injection/bleed ring's 110 tangential injection inlets 203. Referring to FIG. 15, the i3 reagent blend 139 makeup supply 385 is coupled to feed line 386 and combines with treated i3 reagent blend from line 387 to line 388, which is coupled to the reactor's 100 inlet injection ports 134. The i3 reagent blend 139 may not be directly coupled to an injection/bleed ring device 110, as discussed in Section 1, wherein a segregated uniform annulus chamber 280 may be formed along the tubular shell 105 and is isolated from i1 (137), i2 (138), and R 40. The injection/bleed ring device 110 supports the formation of protective fluid barrier i3 (139) by providing means 60g that secures a solid liner 162, isolating i3 (139) from i2 (138) and/or i1 (137). The i3 blend 139 may be coupled to 134 wherein it is injected at a plurality of locations along the axial length of the tubular shell into the segregated uniform annulus chamber.

In some embodiments, all reactor 100 injection and ejection lines are pressurized to meet the reactor operating conditions (i.e., above critical pressure). In some embodiments, more than one means to pressurize the lines may be used (e.g., such as a low-pressure pump followed by a high-pressure pump functioning as a booster pump for a plurality of the feed lines). In some embodiments, equipment to induce oscillatory flow may be used for a plurality of the injection and/or ejection lines.

In other embodiments, oscillations can be generated using devices such as piston, bellow, diaphragm, syringe, or peristaltic pumps or other devices. In such embodiments, oscillations can be generated with a hydraulic controlled piston at each end of the tubular reactor running in reverse phase, or with the use of a pulsator pump, and/or a hydraulic accumulator. A pulsation damper and back pressure regulator may be used at the reactor outlet to prevent cavitation or vaporization. The frequency and amplitude of the oscillations may improve solid suspension and transport. In some embodiments, the tubular reactor may be operable to alternate between subcritical and supercritical zones based on pressure fluctuations with the incorporation of equipment such as flash tanks and/or steam traps. The tubular reactors may be converted to an oscillatory flow reactors for subcritical and supercritical water applications to improve mixing, heat transfer, increase residence time, increase mass transfer, and reduce solid/salt deposition.

In addition to the reagents 350 discussed above, air or nitrogen may be injected so the reactor may be operable in gas-liquid segmented flow mode to improve particle transport as done commonly for pharmaceutical applications or plug flow crystallizers; or oscillations can be superimposed to the net flow of the reactor to reduce the risk of plugging and de-couple reactor volume and residence time.

### Hydrothermal Reactor (100)

Embodiments of the hydrothermal reactor 100 may comprise an array of injection/bleed rings 110 (as described in Section 1 and shown in FIGS. 1, 2, 3, and 3A-3H) supported within and along the axial length of the tubular shell 105 (as described in Section 1 and shown in FIGS. 4-8B). As described in Section 2 and shown in FIGS. 9-11, embodiments of the injection/bleed rings 110 may initiate, sustain, and/or transition the reaction 40 via radial injection 147 of reactant(s) 348 and 349, form a barrier comprising i1 (137), i2 (138), and/or i3 (139) via tangential injection thereby isolating the tubular shell 105 from the reaction 40, and permit the bleeding/removal of fluid from either the chemical reaction 40 and/or protective fluid barrier(s) barrier comprising i1 (137), i2 (138), and/or i3 (139) (as described in Section 1 and Section 2). In some embodiments, at least two injection/bleed ring devices 110 may be supported within the tubular shell 105. In some embodiments, at least one injection/bleed ring device 110 is configured to initiate and/or sustain the reaction 40 and at least one injection/bleed ring device 110 is configured to transition and/or neutralize the reaction 40. Each injection/bleed ring device 110 may define a stage of the reactor 100. The reactor (100) may have a plurality of stages and each stage may operate at a plurality of conditions. In some embodiments, each injection/bleed ring device 110 is supported within the tubular shell 105 with a clamp and/or flange connection 125 (i.e., forming modular reactor body). Each stage and/or modular section may be defined as Nx. Additional details for the reactor device and methods are described elsewhere herein.

### Hydrothermal Reactor (100)/Injection/Bleed Rings 110—Radial Injection (348) (349) (140) (Burners)

In embodiments of the invention, fluid may be injected radially from the primary radial injectors (i.e., fluid outlets 112 and/or 112a) around inner surface of the injection/bleed ring 110i (Nx) towards the central reaction zone (R) 40 to initiate/sustain/transition/control the reaction with the organic compound in the wastewater feed 348. Furthermore, in some embodiments, fluid from the central reaction (R) 40 may be radially bled from the reaction zone (not shown in Figures).

Embodiments of the radial injection 147 may comprise wastewater feed 348 and oxidant feed 349. In some embodiments, the wastewater feed 348 may be blended with co-fuel 359 to increase its heating value. In some embodiments, the radial injection lines may switch to a CIP mode to clean the reactor 100 internals. In some embodiments, the radial injection surface of the injection/bleed ring device comprises a coating layer comprising a ceramic and/or metal oxide. In some embodiments, the coating layer comprises inorganic deposits resulting from constituents present in the waste feed. Constituents present in the feed may coat the radial burners after injection and the coating layer may comprise insulative properties resulting in subsequent protection/isolation of the device from thermal gradients. In some embodiments, the coating layer on the burners comprises a thickness of 0.002 in. to 0.015 in.

In some embodiments, R 40 is maintained at excess stoichiometric conditions, >600 deg C., and >22.1 MPa. In some embodiments, R 40 operates at >600 deg C. through the means of controlled heating mechanisms such as direct injection of high temperature SCW to heat up the central reaction zone 40 or other methods that would be known to those skilled in the art. In some embodiments, a finely dispersed mixture is imperative to improve the reaction surface area and facilitate complete mineralization of the organics. In some embodiments, R 40 operates with the use of a hydrothermal flame. The hydrothermal flame may exhibit a higher bulk temperature of the central reaction zone 40. A hydrothermal flame can be generated and maintained at SCWO conditions due to the enhanced heat/mass transfer properties of SCW. The ignition temperature of a hydrothermal flame is approximately >400 deg C. In some embodiments, an ignitor may be used to support transition of reactor operation from transient operation to steady state operation and coupled to the injection/bleed ring device. In some embodiments, a flame safety system such as a flame safeguard or similar means to support flame stability and operation control may be used at/coupled to a plurality of locations along the reactor. In some embodiments, a plurality of temperatures are maintained along the axial length of R (140) such as >374 deg C., >500 deg C., >600 deg C., >650 deg C., >800 deg C., >1,000 deg C., or >1,200 deg C. In some embodiments, the reactor 100 has a modular section (Nx) that transitions the temperature of R 40 using 110 to <200 deg C., <300 deg C., <350 deg C., or <420 deg C. In some embodiments, the reactor's 100 pressure is maintained at >3,200 psig, >3,300 psig, >3,400 psig>3,500 psig, >3,600 psig, or >4,000 psig through means known to those skilled in the art. In some embodiments, inorganics/salts/solids may be recovered at various stages of the reactor and/or process. In some embodiments, the reactor 100 reaction zone 40 residence time is <5 seconds, <10 seconds, <30 seconds, <1 minutes, or <5 minutes. In some embodiments, the reactor has a residence time<10 sec, <30 sec, or <60 sec.

Referring to Section 1, in an embodiment, the reactor's 100 injection/bleed ring devices 110 comprise supplemental radial injectors for additional unique fluids located circumferentially around the inner surface of the device 110, at a plurality of longitudinal positions along the inner surface of 110 to inject fluid radially at a plurality of angles between the fluid outlet and the longitudinal axis 30 with the objective to provide supplemental control over the radial and longitudinal fluid profile in R 40 (e.g., to enhance fluid flow and/or the reaction and/or dilute/suppress fluid flow and/or the reaction such as to function as a fluid dampener).

In some embodiments for the supplemental radial injectors, additional fluid outlets are located above and/or below the waste feed and oxidant outlets along the inner surface of 110 with the objective to dampen the reaction and/or provide supplemental control over the reaction in the central reaction zone 40. The fluids to dampen the radial and/or longitudinal fluid profile 280 and/or reaction can include, but are not limited to, CO2, air, nitrogen, and/or chemical inhibitors. In some embodiments, CO2 is recycled from the depressurization stage 405 and injected to dampen the reaction. In some embodiments, in addition to dampeners for a given modular section, the principle of dampening can be applied to the reactor 100 as a whole, wherein a plurality of radial injection points along the axial length of the reactor 100 may comprise dampener fluid, wherein waste feed and/or oxidant are not injected.

In some embodiments for the supplemental radial injectors, additional fluid outlets are located above and/or below the waste feed and oxidant outlets along the inner surface of 110 with the objective to enhance the reaction and/or provide supplemental control over the reaction in the central reaction zone 40. The applied principle is such that oxidant is injected in an “overfire” method. In some embodiments, the application of overfire oxidant comprise 80-95% of the stoichiometric COD requirement injected from the primary radial injectors and 5-20% of the stoichiometric COD requirement injected from the supplemental radial injectors. In some embodiments, the application of overfire oxidant comprises at least 95% of the stoichiometric COD requirement injected from the primary radial injectors and 5-30% of the stoichiometric COD requirement injected from the supplemental radial injectors. In some embodiments, in addition to overfire oxidant for a given modular section, the principle of overfire oxidant can be applied to the reactor 100 as a whole, wherein a plurality of radial injection points along the axial length of the reactor 100 may comprise overfire oxidant fluid, wherein the waste feed is not injected. The fluids to enhance the radial and/or longitudinal profile through the overfire method can include, but is not limited to, hydrogen peroxide, oxygen, air, chemical initiator(s), and/or chemical activator(s).

### Hydrothermal Reactor (100)/Injection/Bleed Rings 110—Tangential Injection and Bleed (350) (137) (138) (139)

In embodiments of the invention, the i1 (137) and/or i2 (138) fluid may be injected tangentially from fluid outlets 113 and 114 circumferentially around the injection/bleed ring 110 Nx towards Nx+1. The i3 fluid (139) may be coupled to 134 wherein it is injected at a plurality of locations along the axial length of the tubular shell 105 into the segregated uniform annulus chamber 280 and isolated from i1 (137) and/or i2 (138). Referring to Section 2 and FIGS. 9-11, in some embodiments, the concentric protection zone combination 350 includes ii. In some embodiments, ii may be present, but fluid thermal, chemical, and/or physical fluid properties may extend the ii's reach into an additional i category without an additional fluid layer present. In some embodiments, the concentric protection zone combination 350 includes iii.

Referring to FIGS. 9-11, in some embodiments, i1 (137) represents an initiator, i2 (138) represents an inhibitor, and i3 (139) represents an insulator. In some embodiments, the order/location of the zones may differ, and any combination may be present. In some embodiments, a liner may separate any of the ix. In some embodiments, the liner may be porous. In some embodiments, the liner may be solid. In some embodiments, the liner is non-pressure bearing. In some embodiments, the pressure vessel 105 is pressure bearing and surrounds ix and R 40. In some embodiments, one or more of i1 (137), i2 (138), and/or i3 (139) may not be present in the reactor. In some embodiments, i1 (137), i2 (138), and/or i3 (139) may have thermal, chemical, and/or physical fluid properties that fall into one or more of the concentric zone categories iii.

In some embodiments, R 40 may be surrounded by i1 (137), which comprises a mixture 350 with at least SCW at a temperature that is different than R 40. In some embodiments, i1 (137) comprises additional reactant(s)/reagent(s) selected from the protective reagent(s)/reactant(s) feed supply (350). In some embodiments, i1 (137) includes an oxidant. In some embodiments, i1 (137) includes a pH adjustment reagent. In some embodiments, a reagent is added to i1 (137) to adjust pH to >7, >8, >8.5, >9, >10, or >11. In some embodiments, the ORP of i1 (137) is >0 mV, >50 mV, >100 mV, >150 mV, >200 mV, >300 mV, >400 mV, or >500 mV. In some embodiments, i1 (137) is maintained at a temperature<650 deg C., <420 deg C., or <374 deg C. In some embodiments, i1's (137) oxidant concentration is maintained at <30 wt %, <20 wt %, <10 wt %, <5 wt %, <2 wt %, or <1 wt %. In some embodiments, reactant(s)/reagent(s) 350 may be added to i1 (137) to precipitate salts that diffuse into the region for collection and/or treatment. In some embodiments, i1 (137) comprises a molten salt mixture using hydroxides, carbonates, nitrates, and/or eutectic mixtures of reactant(s)/reagent(s) 350. In some embodiments, i1 (137) comprises a molten salt mixture using hydroxides, carbonates, nitrates, and/or eutectic mixtures with an oxidant (i.e., molten salt oxidation). While R 40 is maintained at (excess) stoichiometric conditions and elevated temperature (>600-650 deg C.), i1 (137) is a lower temperature, continues to enhance reaction kinetics while also providing insulative properties, and can serve as a buffer. Although most of the oxidation reactions will occur within the central reaction zone (140), a mild oxidant concentration can be maintained in i1 (137) to ensure that all organics are completely mineralized if they diffuse into the region (137). Depending on the waste feed characteristics, i1 (137) may comprise a mixture that catalyzes the reaction while also retaining inorganic constituents in solution by influencing solubility. The central reaction zone (140) axial fluid flow typically comprises upflow, and i1 (137) axial fluid flow is typically downflow, thereby creating a countercurrent fluid flow profile. Referring to FIGS. 15, 4, 3A, and 6, i1 (137) may be collected from injection/bleed ring 110 fluid inlets 206 and coupled to the reactor's (100) ejection ports 135 (via 126, 215, 116), which are coupled to bleed lines 389, 390, 391, and 372.

In some embodiments, i1 (137) may be surrounded by i2 (138), which comprises a mixture 350 with at least subcritical water. In some embodiments, i2 (138) comprises additional reactant(s)/reagent(s) selected from the protective reagent(s)/reactant(s) feed supply 350. In some embodiments, an oxidant reagent is added to i2 (138) to maintain a low oxygen residual. In some embodiments, the oxygen residual comprises<1 ppm, <500 ppb, <250 ppb, <100 ppb, <10 ppb, or <7 ppb. In some embodiments, the ORP of i2 (138) is <0 mV, <−50 mV, <−100 mV, <−150 mV, <˜200 mV, <˜300 mV, <−400 mV, or <−500 mV. In some embodiments, i2 (138) includes a pH adjustment reagent. In some embodiments, i2 (138) includes a reactant(s)/reagent(s) that decomposes to a pH adjustment reagent. In some embodiments, i2 (138) includes a reagent producing no dissolved solids that functions to inhibit the oxidation reaction in 40. In some embodiments, i2 (138) includes a reagent producing dissolved solids that functions to inhibit the oxidating reaction in 40. In some embodiments, i2 (138) comprises a pH adjustment reagent elevating its pH to >8, >9, >10, >11, or >12 within i2 (138). In some embodiments, a porous liner separates i1 (137) and i2 (138). In some embodiments, i2 (138) is maintained at a temperature<374 deg C., <350 deg C., <300 deg C., <250 deg C., or <200 deg C. The i2 protection zone may contain reagent(s) that introduces a scavenger to inhibit exothermic reactions from occurring along the porous liner, increases the pH to protect against corrosion of the porous liner and pressure vessel, improves heat transfer, and/or reverses the solubility of the inorganic compounds if they diffuse through i1 (137). Referring to FIGS. 15, 4, 3A, and 6, 12 (138) may be collected from injection/bleed ring 110 fluid inlets 205 and coupled to the reactor's 100 ejection ports 135 (via 126, 214, 115), which are coupled to bleed lines 392, 393, 394, 395, and 379.

In some embodiments, i2 (138) may be surrounded by i3 (139), which comprises a fluid with a low thermal conductivity. In some embodiments, i3 (139) comprises reactant(s)/reagent(s) selected from the protective reagent(s)/reactant(s) feed supply 350. In some embodiments, the thermal conductivity of i3 (139) is <1 W/(m*K), <0.75 W/(m*K), <0.5 W/(m*K), <0.25 W/(m*K), <0.15 W/(m*K), <0.10 W/(m*K), <0.075 W/(m*K), or <0.05 W/(m*K). In some embodiments, the thermal conductivity of i3 (139) is <0.05 W/(m*K). In some embodiments, a solid liner separates i2 (138) and i3 (139). In some embodiments, i3 (139) is maintained at a temperature<374 deg C., <350 deg C., <300 deg C., <250 deg C., <200 deg C., <150 deg C., <100 deg C., or <50 deg C. In some embodiments, i3 is maintained at a temperature<200 deg C. In some embodiments, a solid material comprising a thermal conductivity of <0.5 W/(m*K), <0.25 W/(m*K), <0.15 W/(m*K), <0.10 W/(m*K), <0.075 W/(m*K), or <0.05 W/(m*K) may line the pressure vessel 105. In some embodiments, i3 (139) is present in a segregated chamber 280 that is uniform along the entire length of the longitudinal axis of 105. In lieu of this fluid being injected or bled from each Nx, the fluid may flow seamlessly along the length of the longitudinal axis (e.g., through Nx−1 to Nx to Nx+1). This fluid may be injected and collected at any point along the axial length of the shell through a perforated injection/ejection port 134 135. This protective zone should be preferably segregated from the other protective zones using a solid liner. Referring to FIGS. 15 and 6, i3 (139) is ejected from the reactor's 100 ejection port 135, which is coupled to bleed lines 396. Bleed line 396 is coupled to i3 treatment 397, and the i3 treatment effluent is coupled to line 387.

In some embodiments, one or more of the reactor's protective fluid reagent(s) ix (137) (138) (139) are maintained at a temperature<800 deg C., <650 deg C., <420 deg C., <374 deg C., <350 deg C., <300 deg C., <250 deg C., <200 deg C., <150 deg C., and/or <100 deg C. In some embodiments, one or more of the reactor's protective fluid reagent(s) ix (137) (138) (139) are maintained for a residence time>2 sec, >10 sec, >30 sec, >60 sec, >2 min, >5 min, >7 min, >10 min, >15 min, >20 min, >25 min, >30 min, >35 min, >45 min, >60 mins, >120 mins, >180 mins, >300 mins, >600 mins, >1,200 mins, >1,800 mins, or >2,400 mins. Care should be taken in the design and/or assembly of the reactor to accommodate appropriately for the temperature differentials of the reaction zone and protective fluid barriers to prevent under-condensation or over-condensation and reduce/eliminate corresponding pressure fluctuations (i.e., temperature differentials can result in changes in the fluid properties and should be accommodated for in the design of the pressure vessel).

It is to be appreciated that each concentric protection zone's (ix) (137) (138) (139) regeneration treatment option is dependent on its thermal, physical, and/or chemical characteristics upon exiting the reactor. Various treatment options could comprise, but are not limited to coagulation, filtration, adsorption (e.g., activated carbon, ion-exchange, etc), membrane separation (e.g., reverse osmosis, nanofiltration, ultrafiltration, electrodeionization), deaeration, chemical precipitation, disinfection, aeration, pH adjustment (i.e., increase or decrease), temperature adjustment (i.e., heating or cooling), foam fractionation, clarification, dilution, pressure swing adsorption, ultraviolet radiation, gravity sedimentation or settling, centrifugal sedimentation, dissolved air flotation, thickening, wet scrubbing, mechanical dewatering, absorption processes, electrochemical processes, liquid/liquid extraction processes, solid/liquid extraction processes, chemical catalyst regeneration, crystallization, magnetic fields, chemical oxidation, chemical reduction, oxidant/oxygen scavenging, natural treatment systems, UV treatment, distillation, stripping, humidity/gas drying control, moisture removal, metal recovery, or a combination thereof.

In some embodiments, one or more of the concentric protection zone's (ix) (137) (138) (139) recycle ratio(s) (as a percentage of total volumetric flow required for the respective protective barriers in the reactor) comprise>99%, >95%, >90%, >80%, >70%, >60%, >50%, and/or >140% of flow back to the respective concentric protection zone in the reactor. In some embodiments, upon changes in reactor operating conditions, at least one of the concentric zone's recirculation and/or makeup supply may mix with a different concentric protection zone to enhance protection. In some embodiments, one or more of the concentric protection zones (ix) (137) (138) (139) may be recirculated in part or in whole to a plurality of locations within the system such as to the wastewater influent, brine, distillate, and/or gas/liquid discharge and/or further processing.

For a given concentric protection zone combination as described herein, FIG. 19 illustrates the radial temperature as a function of normalized radial position with the reactor for a hypothetical sudden rise in reaction zone temperature and the corresponding pressure vessel temperature. The steady state reaction temperature is set as an independent variable for this scenario based on the temperature and residence time requirements for a given recalcitrant organic contaminant. For the purposes of discussion, a reaction zone temperature in excess of >600 deg C. with appropriate stoichiometric conditions can ensure effective mineralization of recalcitrant organic compounds such as sulfonated PFAS compounds or other species. For the purposes of discussion, a concentric protection zone combination comprises chemical species such as supercritical water, oxidant, subcritical water, nitrogen, a pH adjustment reagent, and a common reagent that decomposes into an inhibitor.

### Hydrothermal Reactor (100)/Tubular Shell Assembly

In some embodiments, the elements that comprise the tubular shell assembly may include the injection/bleed ring devices 110, inlet(s) 134, and outlet(s) 135. It is an aspect of the invention described herein for an application with SCWO for the tubular shell is such that it comprises the elements discussed in Section 1 and will be discussed in reference to Section 1 and FIG. 15 for convenience.

In some embodiments, the tubular shell may include a hollow tubular pressure vessel. The size and thickness of the tubular shell must be adequate for the operating conditions and must be in accordance with all relevant codes for compliance (e.g., ASME Pressure Vessel codes such as ASME Section VIII, Div 1 and/or ASME Power Piping Code B31.1). In some embodiments, the tubular shell comprises materials such as Alloy 625, Hastelloy C-276, austenitic stainless steels, ferritic-martensitic, titanium, and/or other materials known to those skilled in the art. In some embodiments, the pressure vessel exterior is maintained at a temperature<400 deg C., <350 deg C., <300 deg C., <250 deg C., <200 deg C., <150 deg C., <100 deg C., or <50 deg C. In some embodiments, the pressure vessel exterior is maintained at a temperature<200 deg C. Liners positioned along the length of the reactor may comprise materials such as stainless steels, titanium, ceramics, Alloy 625, or other materials. In some embodiments, the pressure vessel and/or associated materials comprise Alloy 625. In some embodiments, the pressure vessel and/or associated materials comprise 316 stainless steel (TP316). In some embodiments, the pressure vessel thickness is defined by ASME pressure vessel codes. In some embodiments, the pressure vessel nominal vessel diameter size is >1″, >2″, >3″, >4″, >6″, >8″, >12″, >16″, >20″, or >24″. In some embodiments, insulation may be secured atop the pressure vessel exterior.

In some embodiments, the modular reactors are installed in a protective container (e.g., such as a shipping container). In some embodiments, the reactor(s) are installed in (typical) shipping containers (e.g., sized 20 ft×8 ft×8 ft). In some embodiments, the reactor(s) are enclosed by depressurization relief panels such as those that comprise Lexan™ or other similar panels that would be known to those skilled in the art. In some embodiments, all enclosures comprise venting and/or pressure relief devices for the protective container enclosure(s) for the reactor(s). In some embodiments, the pressure vessel length is <8 ft, <6 ft, <5 ft, <4 ft, <3 ft, <2 ft, or <1 ft. In some embodiments, the pressure vessel length<6 ft. In some embodiments, the modular reactors are portable and are transferred from location to location. In some embodiments, the modular reactors are stationary with long term operation at a given location. In some embodiments, the pressure vessel length>6 ft, >8 ft, >10 ft, >12 ft, >16 ft, >20 ft, <24 ft, or >30 ft.

Referring to FIG. 15, in an embodiment, the injection/bleed ring devices 110 are supported within a tubular shell 105 between a clamp and/or flange connection (125) (Grayloc™ as an example) as discussed in Section 1. In some embodiments, the reactor's tubular shell 105 has an open inlet end and an open outlet end and represents a flow through embodiment of the reactor with injection/bleed ring devices 110 secured along the tubular shell 105 axial length (not shown in FIG. 15). In some embodiments, the tubular shell can be oriented horizontally. In some embodiments, the tubular shell is oriented vertically (as shown in FIG. 15).

Referring to FIGS. 15 and 6, the illustrated embodiment shows the tubular shell 105 oriented vertically, and the tubular shell closed at the top 100t and bottom 100b (e.g., with blind flange or other connection means) with the exception for any inlets 134 and/or outlets 135 (e.g., 136). Referring to FIG. 15, the reactor (100) is broken down into stages based on injection/bleed ring device 110 placement. Stage 0 is located at the reactor top 110t and shown as 398, Stage 1 is 399, Stage 2 is 400, Stage 3 is 401, and Stage 4 is located at the bottom 110b as 402. Although five Stages are shown in FIG. 15, in some embodiments, a plurality of stages operating at different conditions may be present. Ejection ports 135 (e.g., 136) are located at Stage 0 (398) for ejecting the distillate (352) and Stage 4 (402) for ejecting the brine (353). Stage 0 (398) operates with an injection ring device 110 placement at the top with an ejection port 135 at the longitudinal axis as discussed in Section 1. Stage 0 (398) is configured with circumferential injection of ix (138). Stage 1 (399) is configured with circumferential bleed and injection of ix (137) (138) and radial injection of reactants. Stage 1 radial injection of reactant may form a central reaction zone 40 at a lower temperature than Stage 2 (400) and function as a temperature transition zone. Stage 2 (400) radial injection may occur as described with central reaction 40 temperature>600-650 deg C. Stage 3 (401) is configured with both radial injection of reactants and circumferential bleed and injection of ix (138) (e.g., to function as a neutralization zone and/or quench/cooling zone). Stage 3 (401) radial injection of reactants may form a central reaction zone 40 at a lower temperature than Stage 2 (400) and function as a temperature transition zone. Stage 4 (402) is configured with circumferential bleed of ix (138) (e.g., to treat the quench and/or blowdown the brine). A solid liner 162 may be secured on the injection/bleed ring devices 110 along the length of the tubular shell 105 and separates i3 (139) from i2 (138). A porous liner 162a may be secured on the injection/bleed ring devices 110 along the length of the tubular shell 105 and placed between i1 (137) and i2 (138). The porous liner 162a secured at Stage 3 (401) and Stage 4 (402) may be positioned on an angle such that the flow is directed towards the ejection port 135 (e.g., 136) for the brine 353.

In an alternative embodiment, for 110 secured at (398), in lieu of radial injection, a plurality of primary longitudinal injectors could be placed at the top of the reactor 100 and at the centerline of the longitudinal axis, such as shown by 136 in FIG. 6 to inject wastewater 348, 359 and oxidant 349, forming a central reaction zone along the centerline of the longitudinal axis. In this embodiment, the injectors at 398 comprise co-axial injectors or a plurality of other injectors. In some embodiments a cooling liner is secured and/or coating layer is applied on the surface of 110 to reduce the thermal gradients in proximity to the injectors and/or injection/bleed ring device 110. Consequently, in lieu of ejection at 398, the distillate may be ejected from a plurality of locations along the axial length of the reactor 100.

In an alternative embodiment for 110 secured at 402, in lieu of a neutralization zone and radial injection, a plurality of primary longitudinal injectors could be placed at the bottom of the reactor 100 and at the centerline of the longitudinal axis, such as such by 136 in FIG. 6 to inject wastewater 348, 359 and oxidant 349, forming a central reaction zone along the centerline of the longitudinal axis. In this embodiment, the injectors at 402 comprise co-axial injectors or a plurality of other injectors. In some embodiments a cooling liner is secured and/or coating layer is applied on the surface of 110 to reduce the thermal gradients in proximity to the injectors and/or injection/bleed ring device 110. In some embodiments, wherein the injectors are placed at the bottom of the reactor the porous liner 162a has a vertical orientation and is not positioned at an angle between 401 and 402. Consequently, in lieu of ejection at 402, the brine 353 may be ejected from a plurality of locations along the axial length of the reactor 100.

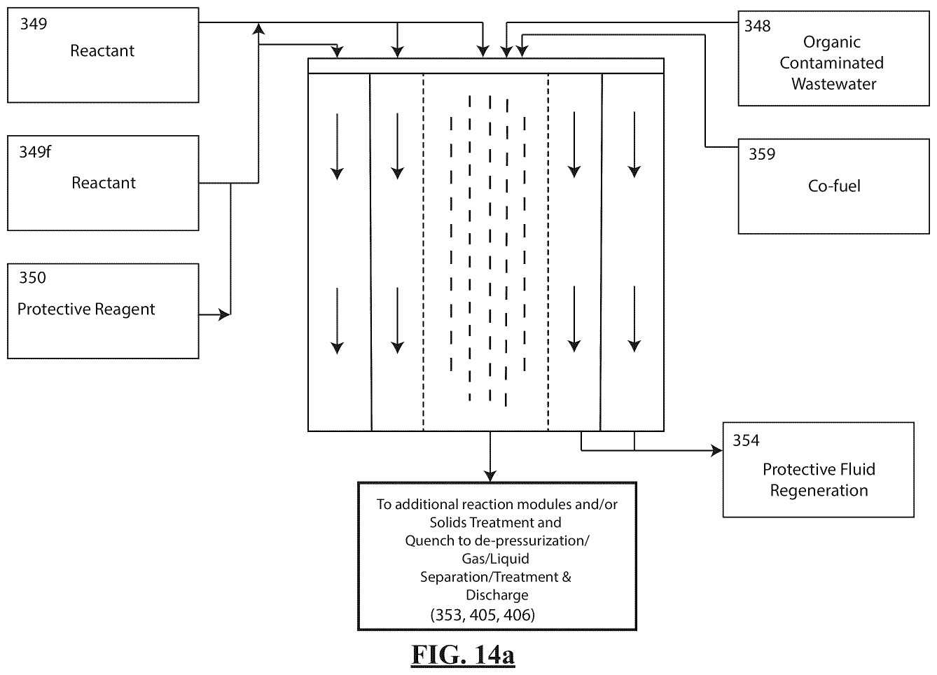

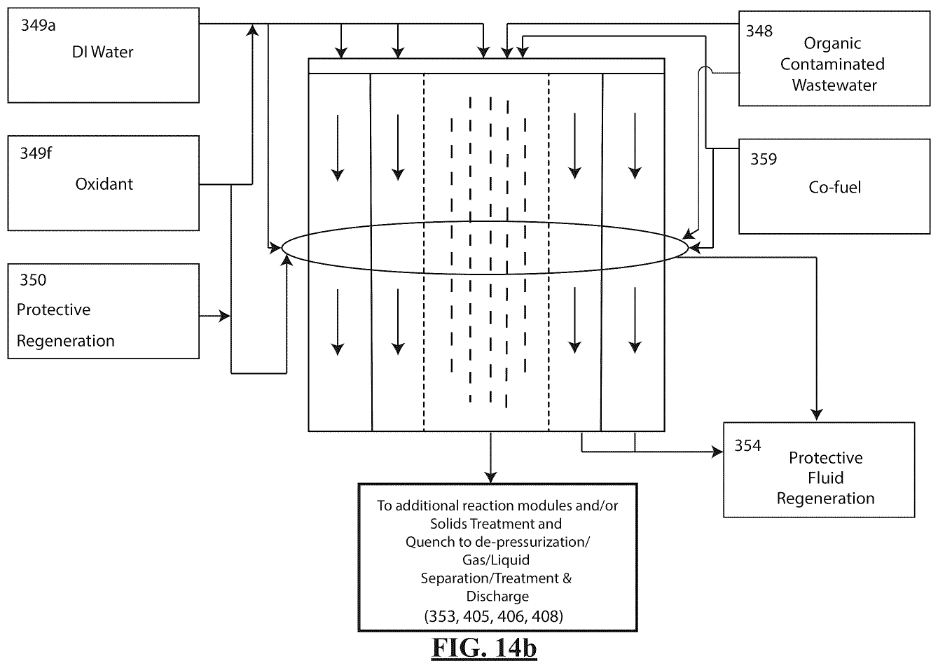

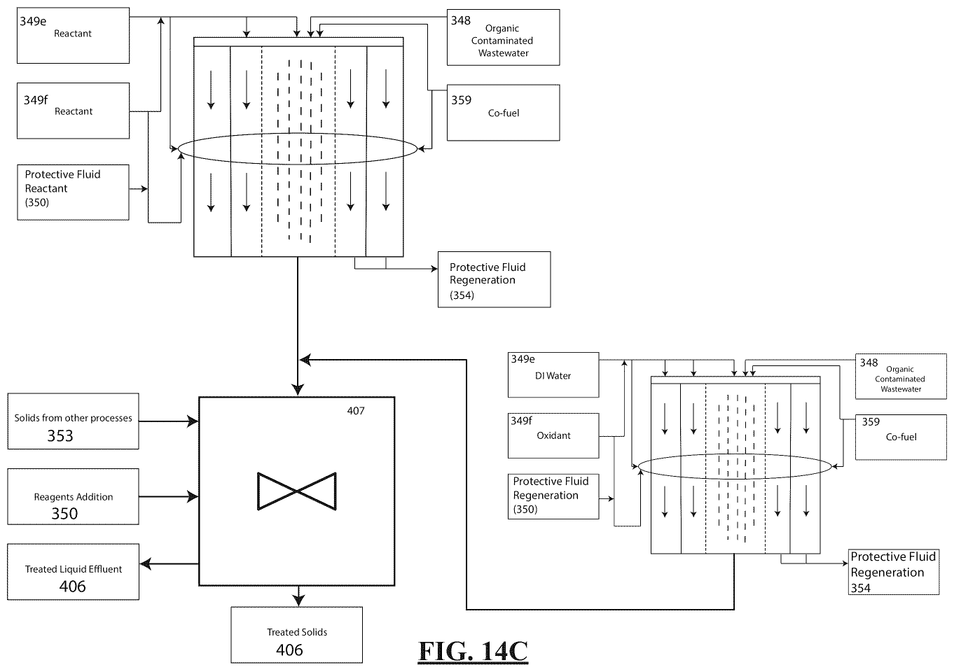

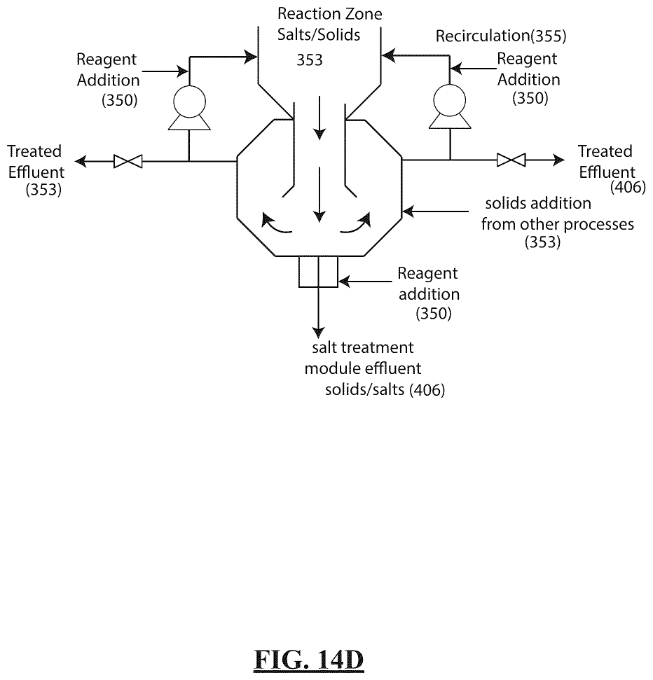

In some embodiments, the hydrothermal reactor(s) are operated continuously. In some embodiments, the hydrothermal reactor(s) are operated as a batch process. In some embodiments, multiple hydrothermal reactors are operated in parallel to allow for a range of turndown capabilities and redundancy as shown in FIG. 16. In some embodiments, multiple hydrothermal reactors are operated in series. In some embodiments, multiple hydrothermal reactors are operated in series with each reactor operating at different thermal and/or reaction conditions. In some embodiments, wherein multiple hydrothermal reactors are operated in series, at least one reactor may be operated at oxidizing conditions and at least one reactor may be operated at reducing conditions over a plurality of temperature conditions. In some embodiments, multiple hydrothermal reactors are operated in parallel and convey effluent to a common treatment module such as for solids treatment, as illustrated in FIGS. 14C and 14D. In some embodiments, the flow through capacity per modular section is <1 gph, >1 gph, >5 gph, >10 gph, >20 gph, >50 gph, >75 gph, >100 gph, >200 gph, >300 gph, >500 gph, >1,000 gph, or >1,250 gph.

Referring to FIG. 15, although perhaps not shown, all lines and the reactor should be configured with appropriate valves, pressure relief devices, or other appurtenances. As appropriate, flash tanks, check valves, solenoid valves, safety valves, block and bleed valves to isolate the system, and/or steam traps should also be considered.

Referring to Section 1, the reactor may comprise monitoring devices for pressure, temperature, pH, conductivity, cation conductivity, oxidation-reduction potential (ORP), chemical oxygen demand (COD), total organic carbon (TOC), flow rate, water/fluid level, dissolved oxygen (DO), iron (Fe), sodium (Na+), Ca, Mg, chloride, sulfate, alkalinity, silica, phosphate, ammonia, moisture, ultrasonic, H2S, CO, NOx, SOx, concentrations for a plurality of constituents, or other sensors known to those skilled in the art.

As data is collected and stored from monitoring devices, feedback is relayed for various control schemes, wherein the reactor 100 injection/bleed ring 110 devices respond to feedback with changes in operating conditions to maintain control. For example, various control schemes can comprise, but are not limited to:
The COD or TOC can be monitored on 352 and/or the CO concentration on the gas effluent from 405 and if there is an increase, the system can respond with an increase in oxidant concentration by actuating valve(s) on feed line (365) and/or decreasing the waste feed flow rate by actuating valve(s) on feed line (360).
The temperature differentials of the ix can be monitored and the system can respond by actuating the flow rates of i1 on feed lines (373) (374) (375), 12 on feed lines (380) (381) (382) (383) (384), and/or i3 on feed line 388 to decrease the temperature of the pressure vessel.
The conductivity or cation conductivity can be monitored on 353 and the system can respond by increasing or decreasing the flow rate (i.e., blowdown) from the ejection port 135 (e.g., 136) at 402 to maintain an appropriate cycle of concentration.
The ORP can be monitored for i1 (137) on feed line 373, and the system can respond by actuating the flow rate of reagent on feed line 370 or recycle line (372).
The pH can be monitored for i2 (138) on feed line 380, and the system can respond by actuating the flow rate of reagent on feed line 377 or recycle line 379.
The presence of various inorganics concentrations and/or cation conductivity can be monitored on bleed lines (389) (390) (391) to determine the extent of inherent mixing and/or diffusing of salts between the central reaction zone 40 and i1 (137), and the system can respond by actuating the flow rate for the bleed of i1 (137) from bleed lines (389) (390) (391).

In some embodiments, the pressure differentials (DP) may be monitored while operating, and if a DP rises to a pre-determined amount, a CIP is initiated. In such embodiments, the filming zone(s) may be converted to a CIP mode which is operable to release an appropriate reactant solution (e.g., a pH adjustment, or a DI water flush at a lower temperature for example) that flushes over the liner or pressure vessel and facilitates the removal deposits/salts from the wall exposed to the reaction zone. During these CIP flushes, the reagent solution may flow by gravity through the reaction zone and may be collected at the bottom of the reactor for further processing, or conveyed to a separate modular pressure vessel, discussed below. After the CIP has concluded, the filming zone reverts to its original state. The bleed/injection equipment/system would consist of all typical equipment, such as control valves, piping, isolation and check valves, and appropriate control indicators.

Many other control strategies can be considered but are not discussed here in extensive detail. In some embodiments, control logic further comprises methods for emergency shutdown, system monitoring and alarms, safety interlock strategy, and parameter specification.

### Reactor Effluent/Distillate

In some embodiments, the treated effluent ejected from the top of the reactor 100 comprises the distillate 352. In some embodiments, the treated effluent ejected may be ejected from a plurality of locations along the axial length of the reactor 100. In some locations the distillate 352 may be ejected from the bottom of the reactor through an ejection port 135 between 401 and 402 and perforated through the solid liner 162 and porous liner 162a. In some embodiments, wherein the distillate 352 is ejected from the bottom of the reactor, or a plurality of locations along the axial length of the reactor 100, Stage 0 (398) comprises a radial and/or longitudinal injection of quench water to reduce the temperature at the top of the reactor.

In some embodiments, heat may be recovered from the distillate through 358 prior to depressurization (i.e., gas/liquid separation) 405, further treatment, and/or discharge 406. In some embodiments, additives may be injected to further neutralize the effluent (e.g., sodium hydroxide or other reagents to neutralize acidic species). In some embodiments, the reactor effluent 352 is depressurized 405 with a back-pressure regulator, series of orifice plates, capillary coils, expansion turbine and/or heat/energy recovery cycle, throttle valves, or other means as would be known by those skilled in the art. Following depressurization, a separation vessel (not shown) separates the liquid and gas phases. In some embodiments, during and/or after the gas/liquid separation phase, the gas released shall be scrubbed, monitored, and then released. In some embodiments, at any point downstream of 352, the treated effluent may be recycled for re-use in the process at a plurality of locations along any of the fluid flow paths. The depressurization, gas/liquid separation, and treated effluent discharge processes are generally well characterized from prior art and are not critical to discuss in extensive detail for this invention disclosure.

### Reactor Effluent/Brine

In some embodiments, the treated effluent ejected from the bottom of the reactor 100 comprises the brine 353. In some embodiments, the brine 353 is optionally treated 407 before and/or after quenching (i.e., cooling). In some embodiments, heat may be recovered from the brine through 407 prior to depressurization (i.e., gas/liquid separation) 408, and/or discharge 406. In some embodiments, the reactor effluent 353 is depressurized 408 with a back-pressure regulator, series of orifice plates, capillary coils, expansion turbine and/or heat/energy recovery cycle, throttle valves, or other means. In some embodiments, the brine 353 is depressurized 408 with a series of orifice plates and/or capillary coils. In some embodiments, during and/or after the gas/liquid separation phase, the gas released shall be scrubbed, monitored, and then released. In some embodiments, heat may be recovered during treatment 407. In some embodiments, the brine 353 does not require treatment 407. In some embodiments, the brine 353 is combined with the distillate 352 at a plurality of locations along the discharge line. In some embodiments, the brine 353 may be recirculated in part or in whole to a plurality of locations along the fluid flow paths (e.g., such as back to the wastewater influent).

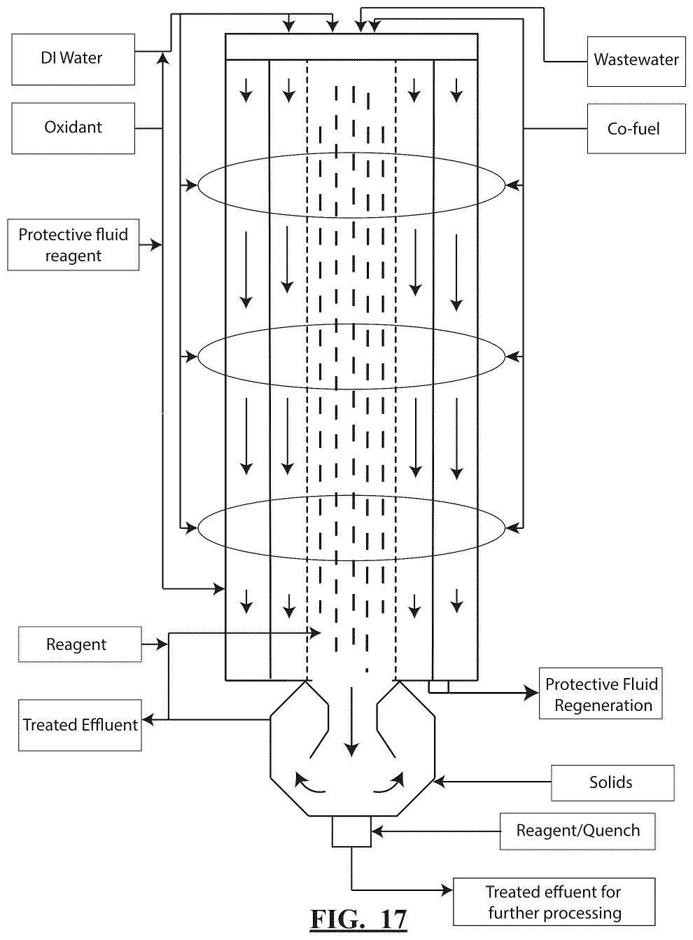

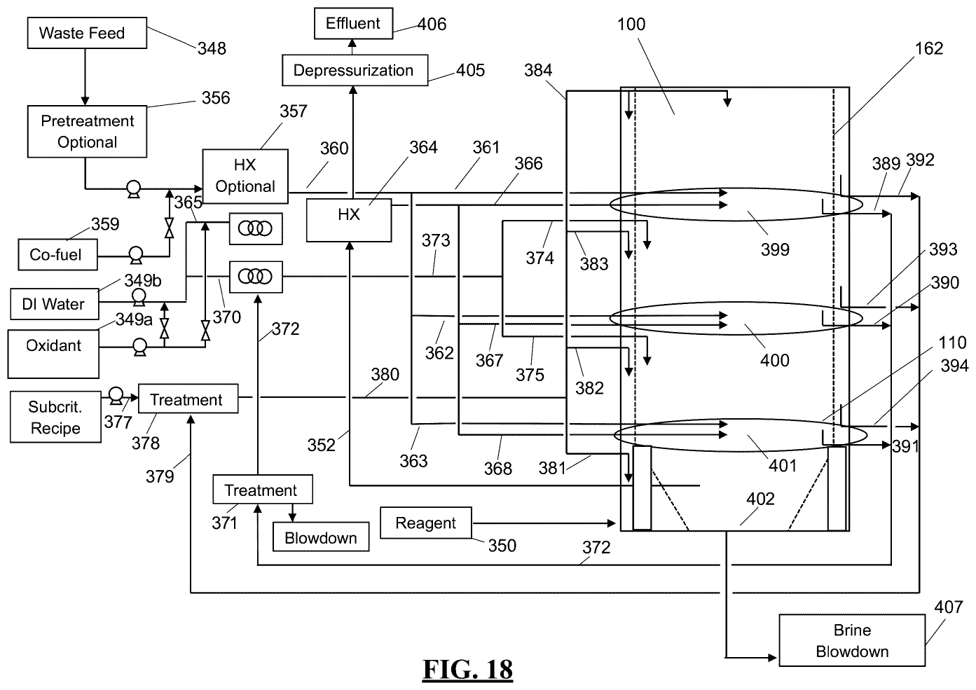

Some recalcitrant organic compounds and/or salts or other solids may require further treatment. Examples of solids may include, but are not limited to salts, deposits, precipitates, activated carbon, ion-exchange resin, or other contaminated solids. Some embodiments of the present invention may include a separate modular section located at the bottom of the reactor as illustrated in FIG. 17, or may include a separate unique modular pressure vessel to allow for the collection and/or addition of organic contaminated solids as illustrated in FIG. 14C (e.g., from CIPs or other processes depending on the reaction and conditions). This separate section or vessel may be maintained at either supercritical or subcritical conditions depending on the reactor operating conditions. The section or vessel may have an enhanced residence time, and function similar to a continuous stirred tank reactor (CSTR) as illustrated in FIG. 14C operating at elevated temperature (>100 deg C.) and pressure (>200 psi) with a reagent addition 350 349 that facilitates the breakdown of the organic compounds from the solids (if needed) or the treatment module may function as a sedimentation process as illustrated in FIG. 14D. Solids may fall from the reaction zone 40 or may be conveyed separately into the solids treatment module during ix regeneration or from other treatment processes. In such embodiments as illustrated in FIG. 14D, a draft tube may be included and may be operable to promote both settling and recirculatory flow characteristics in the vessel. A flow control valve may proportion the effluent/mixture to be recirculated back to the reaction zone 40 or within the treatment module for additional residence time and continuous processing 355, or for further processing 353 to be discharged. Reagents 349 350 may be dosed in the recirculation line to promote mineralization and enhance DRE.

After appropriate residence time in the reactor module, the solids from the separate section or vessel may be recovered and/or appropriately discharged for further processing at the bottom of the module (depending on process effluent/discharge/project goal requirements). For example, if a pH adjustment occurred for either a CIP and/or to enhance DRE to facilitate organic mineralization, a pH adjustment shall occur at the bottom of the module to revert back to a neutral pH prior to system quench and de-pressurization to enhance fluid flow characteristics and/or meet discharge requirements.

Solids reactors of the present invention may also be provided in stages, such that multiple reaction zone based modules may be stacked on top of a solids treatment module (stage 1), with effluent from stage 1 flowing to another stack of modules (stage 2) prior to solids treatment. Additional solids from other processes may be injected into the unique pressure vessel for solids treatment. The pressure vessel may have a cylindrical shape and may function similar to a CSTR, and may or may not include a concentric annulus region with oxidant and/or reactant zone(s). A mixer aligned at the vessel center may be included in the vessel in lieu of recirculation to promote mixing. The vessel may be sized to provide appropriate residence and include all appropriate appurtenances.

In some embodiments, particularly at supercritical water conditions, each modular section may include a permeable liner at the bottom of the section to allow for the recovery of salts based on liner pore size. Modular reactors having multiple sections may potentially have different operating conditions at each section and may have one or more permeable liners with different pore sizes to selectively recover various salts based on size. Salts may be collected on the various liners and may be removed during system maintenance to recover specific salts. In some embodiments, reactant(s) are introduced at a plurality of stages of the reactor to precipitate and recover salts such as nutrients or other compounds.

### Section 4. Hydrothermal Reactor and Methods of Protection for Subcritical Operation

It is not the intention of the invention to be limited to a particular operating condition and/or chemical reaction. By way of example and for illustrative purposes only, and without limitation, an embodiment of the present invention device (which may comprise any disclosures within Section 1), method of protection (which may comprise any disclosures within Section 2), and high pressure/temperature hydrothermal treatment application (which may comprise any disclosures within Section 3) will be described in this Section 4 in accordance with a central reaction zone 40 at subcritical conditions for the mineralization of organic compounds in the presence of inorganic compounds.

In this exemplary embodiment, FIG. 12B provides a general process flow diagram for the mineralization of an organic compound in the presence of inorganic compounds within a waste (e.g., wastewater for purposes of discussion) with the reaction occurring at subcritical conditions. The general process flow for the reactor device and method may be such that the wastewater 348, reactant(s) 349, and protective fluid reagent(s) 350 are pressurized and fed to the reactor 100. The wastewater and reactants are maintained for an appropriate residence time at operating condition for the reaction, and the treated reaction byproducts are quenched, treated further, and de-pressurized (i.e. gas/liquid separation) prior to further treatment and/or discharge. The protective fluid reagent(s) 350 may be pressurized and injected into the reactor 100 to form concentric protection zone(s), maintained for an appropriate residence time to provide a protective fluid barrier, bled from the protection zone(s) and treated 354 (i.e., regenerated), and then recirculated back 355 into the reactor 100. In some embodiments, solid byproducts may be separated and/or treated before, during, and/or after depressurization.

For purposes of discussion, in this embodiment, FIG. 15 can similarly be used to describe a subcritical hydrothermal treatment application such that the temperature and pressure of the central reaction zone are maintained at subcritical operation conditions.

In some embodiments, multiple reactors may be used in series, wherein at least one reactor may be operated at a particular set of reactor conditions followed by at least one other reactor operating at a different set of operation conditions. In some embodiments, between each reactor in series, reactant(s)/reagent(s) may be injected to transition the reactor operating conditions. In some embodiments, injection/bleed ring devices may operate at different reaction conditions within a reactor device. In some embodiments, the reactor effluent maintains pressure before entering any reactors operating in series. In some embodiments, the reactor effluent may be depressurized and then re-pressurized prior to entering any reactors operating in series.

Similar to Section 3, the waste/wastewater 348 can be any source containing organic and/or inorganic compounds. In some embodiments, the hydrothermal reactor carries out a chemical reaction to defluorinate (i.e., break at least one carbon fluorine bond) and/or mineralize PFAS (i.e., compound contains at least one carbon fluorine bond). In some embodiments, the wastewater 348 in order to undergo the chemical reaction, is optionally pre-treated 356 prior to entering the hydrothermal reactor 100. In some embodiments, the wastewater 348 is optionally pre-heated 357 prior to entering the reactor 100. In some embodiments, equipment to induce oscillatory flow may be used for a plurality of the injection and/or ejection lines. In some embodiments, equipment means to operate with a gas-liquid segmented flow mode can coupled to the reactor and/or any influent and/or effluent lines.

In some embodiments, the reactor's 100 injection/bleed ring devices 110 comprise supplemental radial injectors for additional unique fluids located circumferentially around the inner surface of the device 110, at a plurality of longitudinal positions along the inner surface of 110 to inject fluid radially at a plurality of angles between the fluid outlet and the longitudinal axis 30 with the objective to provide supplemental control over the radial and longitudinal fluid profile in R 40 (e.g., to enhance fluid flow and/or the reaction and/or dilute/suppress fluid flow and/or the reaction such as to function as a fluid dampener).

Referring to FIG. 15, in this embodiment, the central reaction zone R reactant (e.g., oxidant) can include or be substituted with a plurality of other reagent(s)/reactant(s) for radial injection into R. In some embodiments, R is maintained at alkaline conditions. In some embodiments, a reagent is radially injected into R to adjust pH to >7, >8, >8.5, >9, >10, >11, or >12. In some embodiments, R includes a reactant(s)/reagent(s) that decomposes to a pH adjustment reagent. In some embodiments, R includes a reducing reagent in at least one of the reactors and/or injection/bleed ring modular sections. In some embodiments, the reducing agent may include zero valent iron. In some embodiments, R includes an oxidizing reagent in at least one of the reactors and/or injection/bleed ring modular sections. In some embodiments, reducing reaction conditions occur before oxidizing conditions. In some embodiments, oxidizing conditions occur before reducing conditions. In some embodiments, an oxygen scavenger is injected into the waste feed prior to the reactor. In some embodiments, R includes a reagent functioning as an oxygen scavenger that produces no dissolved solids. In some embodiments, R includes a reagent functioning as an oxygen scavenger producing dissolved solids. In some embodiments, the ORP of R is <0 mV, <−50 mV, <−100 mV, <−150 mV, <˜200 mV, <−300 mV, <−400 mV, or <−500 mV. In some embodiments, the reactor 100 reaction zone 140 residence time is <5 seconds, <10 seconds, <30 seconds, <1 minutes, <5 minutes, <30 minutes, <60 minutes, <120 minutes, <180 minutes, <240 minutes, <300 minutes, <360 minutes, <420 minutes, or <600 minutes at an ORP of <0 mV, <−50 mV, <−100 mV, <−150 mV, <˜200 mV, <˜300 mV, <−400 mV, or <−500 mV. Following reducing condition in some embodiments, R may be transitioned to oxidizing conditions using an injection/bleed ring device's radial injection of oxidant. In some embodiments, a high oxidant concentration may be maintained in R. In some embodiments, the oxidant concentration in R is <1 wt %, >1 wt %, >5 wt %, >10 wt %, >15 wt %, or >20 wt %. In some embodiments, the reactor 100 reaction zone 40 residence time at oxidizing conditions is <5 seconds, <10 seconds, <30 seconds, <1 minutes, <5 minutes, <30 minutes, <60 minutes, <120 minutes, <180 minutes, <240 minutes, <300 minutes, <360 minutes, <420 minutes, or <600 minutes In some embodiments, the reactant(s) may be preheated to >100 deg C., >200 deg C., >300 deg C., or >350 deg C. Some recalcitrant organic compounds may be more susceptible to degradation under reducing conditions, rather than oxidizing conditions, therefore both conditions may be considered for R. It is imperative that care and caution be exercised while considering reactions comprising autocatalytic conditions that are exothermic (e.g., such as oxidizing and alkaline conditions) as they may require enhanced thermal regulation and monitoring.

Referring to FIG. 15, in this embodiment, concentric protection zone reagent(s)/reactant(s) can include or be substituted with a plurality of other reagent(s)/reactant(s). In some embodiments, i1 (137) represents an initiator, i2 (138) represents an inhibitor, and i3 (139) represents an insulator. In some embodiments, the order/location of the zones may differ, and any combination may be present. In some embodiments, a liner may separate any of the ix. In some embodiments, the liner may be porous. In some embodiments, the liner may be solid. In some embodiments, the liner is non-pressure bearing. In some embodiments, the pressure vessel 105 is pressure bearing and surrounds ix and R 40. In some embodiments, one or more of i1 (137), i2 (138), and/or i3 (139) may not be present in the reactor. In some embodiments, i1 (137), i2 (138), and/or i3 (139) may have thermal, chemical, and/or physical fluid properties that fall into one or more of the concentric zone categories iii.

In some embodiments, R 40 may be surrounded by i1 (137), which comprises a molten salt mixture using hydroxides, carbonates, nitrites, nitrates, phosphates, and/or other salts. In some embodiments, i1 (137) comprises additional reactant(s)/reagent(s) selected from the protective reagent(s)/reactant(s) feed supply (350). In some embodiments, i1 (137) comprises a mixture of hydroxides, carbonates, nitrites, nitrates, phosphates, and/or other salts, wherein the mixture comprises a eutectic and/or molten salt mixture. In some embodiments, i1 (137) comprises a mixture of hydroxides, carbonates, nitrites, nitrates, phosphates, and/or other salts, wherein the mixture comprises a eutectic and/or molten salt mixture with an oxidant (i.e., molten salt oxidation). In some embodiments, i1 (137) comprises a mixture of hydroxides, carbonates, nitrites, nitrates, phosphates, and/or other salts, wherein the mixture comprises a eutectic and/or molten salt mixture with a redundant (i.e., molten salt reduction). Given a waste feed with a high concentration of inorganic compounds (e.g., type I or type II salts) that may have the potential to exceed equilibrium solubility limits and precipitate under the alkaline conditions of R, i1 (137) may function to influence equilibrium solubility limits to maintain solubility of various inorganic compounds and prevent solid deposition along the length of the reactor. Furthermore, a combination of hydroxides, carbonates, nitrites/nitrates, phosphates, and other salts may produce superoxide radicals to enhance degradation of organic compounds if they diffuse into the concentric protection zone.

In some embodiments, i1 (137) may be surrounded by i2 (138), which comprises a mixture 350 with at least subcritical water. In some embodiments, i2 (138) comprises additional reactant(s)/reagent(s) selected from the protective reagent(s)/reactant(s) feed supply 350. In some embodiments, i2 (138) comprises a pH adjustment reagent elevating its pH to >8, >9, or >10 within i2 (138). In some embodiments, a porous liner separates i1 (137) and i2 (138). In some embodiments, i2 (138) is maintained at a temperature<374 deg C., <350 deg C., <300 deg C., <250 deg C., or <200 deg C.

In some embodiments, i2 (138) may be surrounded by i3 (139), which comprises a fluid with a low thermal conductivity. In some embodiments, i3 (139) comprises reactant(s)/reagent(s) selected from the protective reagent(s)/reactant(s) feed supply 350. In some embodiments, a solid liner separates i2 (138) and i3 (139). In some embodiments, i3 is maintained at a temperature<200 deg C.

In some embodiments, one or more of the reactor's protective fluid reagent(s) ix (137) (138) (139) are maintained at a temperature<374 deg C., <350 deg C., <300 deg C., <250 deg C., <200 deg C., <150 deg C., and/or <100 deg C. In some embodiments, one or more of the reactor's protective fluid reagent(s) ix (137) (138) (139) are maintained for a residence time>2 sec, >10 sec, >30 sec, >60 sec, >2 min, >5 min, >7 min, >10 min, >15 min, >20 min, >25 min, >30 min, >35 min, >45 min, >60 mins, >120 mins, >180 mins, >300 mins, >600 mins, >1,200 mins, >1,800 mins, or >2,400 mins. It is to be appreciated that each concentric protection zone's (ix) (137) (138) (139) regeneration treatment option may be dependent on its thermal, physical, and/or chemical characteristics upon exiting the reactor.

### Section 5. General

The terms “reactor”, “hydrothermal reactor”, “modular reactor”, “modular hydrothermal reactor”, “modular regenerative hydrothermal reactor”, “falling film reactor”, “FFR”, “modular filming reactor”, “MFR”, “MFFR”, “multi-layered filming reactor”, and “modular falling film reactor” may be used interchangeably herein.

The terms “bleed”, “bled”, or “bleeding of fluid” is used to describe the removal and/or transfer of fluid from one location to another and/or part of the regeneration process.

The terms “injection/bleed ring”, “injection ring”, “bleed ring”, “modular filming injection ring”, “bleed/injection ring”, “injection and bleeding rings”, “bleeding and injection rings”, or “ring” may be used interchangeably herein.

The terms “central reaction zone”, “R”, and “reaction zone” may be used interchangeably herein.

The terms “filming zone”, “concentric protection zone”, “protection zone”, “ix”, “iii”, “i1”, “i”, “concentric zone”, “fluid barrier”, “falling film” “protective fluid barrier”, “barrier”, or “fluid barrier” may be used interchangeably herein.

The terms “protective reagent(s)/reactant(s)” or “protective fluid” is used to describe the fluid that is used in whole or part of the “concentric protection zone(s)”.

The terms “primary injectors” is used to describe injectors that inject reactant(s) into the central reaction zone. The term “primary injectors” considers injectors that inject reactant(s) into the central reaction zone “radially” and “longitudinally”.

The term “spent film” refers rto a film that was injected into the reactor, maintained for an appropriate residence time, and then ejected/bled from the reactor. The term “spent” refers to having concluded its goals for the application and is conveyed to a regenerative treatment for reactivation.

The terms “longitudinal” and “axial” may be used interchangeably herein.

The terms “tubular shell” and “pressure vessel’ may be used interchangeably herein.

It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

1. A modular hydrothermal reactor comprising:
a. a cylindrical shell having an open interior and an exterior cylindrical wall;
b. a first injection ring apparatus located at one end of said cylindrical shell, the first injection ring apparatus comprising:
i. a first annular body having a central axis, an open interior region, an annular upper surface, an annular lower surface, and an interior cylindrical wall facing the interior region, the interior cylindrical wall having at least one first plurality openings therein located radially around the central axis;
ii. at least one first fluid input port on an exterior surface of said first body;
iii. at least one first manifold inside said first body providing fluid communication between said at least one first fluid input port and said at least one first plurality of interior openings;
iv. at least one second plurality of openings located circumferentially on the lower annular surface of said first annular body;
v. at least one second fluid input port on an exterior surface of said first body;
vi. at least one second manifold inside said first body providing fluid communication between said at least one second input port and said at least one second plurality of openings on said lower annular surface;
c. a second injection ring apparatus located at an opposite end of said cylindrical shell, the second injection ring apparatus comprising:
i. a second annular body having a second central axis that is aligned with said first axis, a second open interior region, a second annular upper surface, a second annular lower surface, and a second interior cylindrical wall, the second interior cylindrical wall having at least one third plurality openings therein located radially around the central axis;
ii. at least one third fluid input port on an exterior surface of said second body;
iii. at least one third manifold inside said second body providing fluid communication between said at least one third fluid input port and said at least one third plurality of interior openings;
iv. at least one fourth plurality of openings located circumferentially on the upper annular surface of said second annular body;
v. at least one fourth fluid input port on an exterior surface of said second body; and
vi. at least one fourth manifold inside said second body providing fluid communication between said at least one fourth input port and said at least one fourth plurality of openings on the upper annular surface of said second body.

2. The reactor of claim 1 further comprising:
a. at least one seventh plurality openings therein (112a) located radially around the central axis offset from said first plurality of openings;
b. at least one seventh fluid input port on an exterior surface of said first body; and
c. at least one first manifold inside said first body providing fluid communication between said at least one first fluid input port and said at least one first plurality of interior openings.

3. The reactor of claim 1 further comprising:
a. a fifth plurality of openings located circumferentially on the lower annular surface of said annular body and coaxially with said second plurality of openings;
b. a fifth fluid input port on an exterior surface of said body; and
c. a fifth manifold inside said annular body providing fluid communication between said fifth input port and said fifth plurality of openings on said lower annular surface.

4. The reactor of claim 1 further comprising:
a. a sixth plurality of openings located circumferentially on the upper annular surface of said annular body and coaxially with said fourth plurality of openings;
b. a sixth fluid output port on an exterior surface of said body; and
c. a sixth manifold inside said annular body providing fluid communication between said sixth output port and said sixth plurality of openings on said upper annular surface.

5. The reactor of claim 1, wherein said first injection ring and said second injection ring are coupled to at least one liner.

6. The reactor of claim 1 further comprising a pressurized feed supply for supplying fluid to be treated into the interior of said cylindrical shell, and wherein said cylindrical shell has an inlet and an outlet such that fluid flows through said cylindrical shell.

7. The reactor of claim 1 further comprising at least one sensor selected from the group of: temperature, cation conductivity, conductivity, pH, ORP, TOC, DO, COD, flow rate, fluid level, chemical species concentrations, pressure, and combinations thereof.

8. An injection ring apparatus for use with a modular hydrothermal reactor comprising:
a. an annular body having a central axis, an open interior region, an upper annular surface, a lower annular surface, and an interior cylindrical wall facing the interior region, the interior cylindrical wall having at least one first plurality openings therein located radially around the central axis;
b. at least one first fluid input port on an exterior surface of said body;
c. a first fluid manifold inside said body providing fluid communication between said first fluid input port and said first plurality of interior openings;
d. at least one second plurality of openings located circumferentially on the lower annular surface of said annular body;
e. at least one second fluid input port on an exterior surface of said body;
f. at least one second manifold inside said annular body providing fluid communication between said at least one second input port and said at least one second plurality of openings on said lower annular surface;
g. at least one third plurality of openings located circumferentially on the upper annular surface of said annular body;
h. at least one third fluid output port on an exterior surface of said annular body; and
i. at least one third manifold inside said annular body providing fluid communication between said at least one third output port and said at least one third plurality of openings on the upper annular surface of said annular body.

9. The injection ring of claim 8, further comprising:
a. a fourth plurality openings located radially around the central axis, and offset from said at least one first plurality of openings;
b. a fourth fluid input port on an exterior surface of said body; and
c. a fourth manifold inside said body providing fluid communication between said fourth fluid input port and said fourth plurality of interior openings.

10. The injection ring of claim 8, further comprising:
a. a fifth plurality of openings located circumferentially on the lower annular surface of said annular body and coaxially with said second plurality of openings;
b. a fifth fluid input port on an exterior surface of said body; and
c. a fifth manifold inside said annular body providing fluid communication between said fifth input port and said fifth plurality of openings on said lower annular surface.

11. The injection ring of claim 8, further comprising:
a. a sixth plurality of openings located circumferentially on the upper annular surface of said annular body and coaxially with said third plurality of openings;
b. a sixth fluid output port on an exterior surface of said body; and
c. a sixth manifold inside said annular body providing fluid communication between said sixth output port and said sixth plurality of openings on said upper annular surface.

12-33. (canceled)

34. The modular hydrothermal reactor of claim 1, wherein the first injection ring apparatus is coupled with a liner.

35. The modular hydrothermal reactor of claim 1, wherein the first injection ring apparatus comprises segregated ring sections defining a plurality of fluid manifold layers joined together.

36. The modular hydrothermal reactor of claim 1, wherein the first injection ring apparatus is located between two cylindrical shell segments and secured with a clamp or flange connection.

37. The modular hydrothermal reactor of claim 1, wherein the first injection ring apparatus is located between a cylindrical shell segment and a cylindrical shell blind flange and clamp connection.

38. The modular hydrothermal reactor of claim 37, further comprising an injection port for longitudinal injection coupled to the first injection ring apparatus or to the blind flange and clamp connection.

39. An injection ring apparatus for use with a modular hydrothermal reactor comprising:
a. an annular body having a central axis, an open interior region, an upper annular surface, a lower annular surface, and an interior cylindrical wall facing the interior region, the interior cylindrical wall having at least one first plurality openings therein located radially around the central axis;
b. at least one first fluid input port on an exterior surface of said body;
c. a first fluid manifold inside said body providing fluid communication between said first fluid input port and said first plurality of interior openings;
d. at least one second plurality of openings located circumferentially on the lower annular surface of said annular body;
e. at least one second fluid input port on an exterior surface of said body; and
f. at least one second manifold inside said annular body providing fluid communication between said at least one second input port and said at least one second plurality of openings on said lower annular surface.

40. The injection ring of claim 39, further comprising:
a. a third plurality of openings located circumferentially on the lower annular surface of said annular body and coaxially with said second plurality of openings;
b. a third fluid input port on an exterior surface of said body; and
c. a third manifold inside said annular body providing fluid communication between said third input port and said third plurality of openings on said lower annular surface.

41. An injection ring apparatus for use with a modular hydrothermal reactor comprising:
a. an annular body having a central axis, an open interior region, an upper annular surface, a lower annular surface, and an interior cylindrical wall facing the interior region, the interior cylindrical wall having at least one first plurality openings therein located radially around the central axis;
b. at least one first fluid input port on an exterior surface of said body;
c. a first fluid manifold inside said body providing fluid communication between said first fluid input port and said first plurality of interior openings;
j. at least one second plurality of openings located circumferentially on the upper annular surface of said annular body;
k. at least one second fluid output port on an exterior surface of said annular body; and
l. at least one second manifold inside said annular body providing fluid communication between said at least one second output port and said at least one second plurality of openings on the upper annular surface of said annular body.

42. The injection ring of claim 41, further comprising:
a. a third plurality of openings located circumferentially on the upper annular surface of said annular body and coaxially with said second plurality of openings;
b. a third fluid output port on an exterior surface of said body; and
c. a third manifold inside said annular body providing fluid communication between said third output port and said third plurality of openings on said upper annular surface.

43. The reactor of claim 7 wherein the location of the sensor is selected from the group of: physically located inside the reactor, coupled to an input port, coupled to an output port, and combinations thereof.

49.-49. (canceled)
